(19) United States
(12) Patent Application Publication
(10) Pub. No.: US 2026/0329873 A1
(43) Pub. Date: Oct. 22, 2026

(54) SYSTEM

(71) Applicant: SoftBank Group Corp., Tokyo (JP)

(72) Inventor: Kensuke FUKUSHIMA, Tokyo (JP)

(73) Assignee: SoftBank Group Corp., Tokyo (JP)

(21) Appl. No.: 19/649,153

(22) Filed: Apr. 16, 2026

(30) Foreign Application Priority Data
Apr. 22, 2025 (JP) 2025-070936

(51) Int. Cl. G06F 16/2457; G06F 16/28; G06F 40/20; G10L 25/63

(52) U.S. Cl. CPC G06F 16/24578; G06F 16/285; G06F 40/20; G10L 25/63

(57) ABSTRACT

The present invention relates to a contact center system comprising a customer information management unit, an operator information management unit, and a generative AI processing unit, integrally managing diverse information such as an inquiry history and an attribute for each customer and a skill and an operation status of an operator, and performing analysis of an inquiry content, emotion recognition, and automatic generation of an optimal response policy and a response text using generative AI. Furthermore, a customer satisfaction degree and feedback from the operator are utilized for self-learning to continuously optimize model accuracy and a response content, and when a problem occurs, response quality is autonomously maintained by a self-correction function. This simultaneously realizes customer satisfaction improvement, business efficiency improvement, and operator load reduction, and enables a self-evolving contact center operation flexibly adaptable to all industries and business types.

### CROSS-REFERENCE TO RELATED APPLICATION

The present application claims priority to and incorporates by reference the entire contents of Japanese Patent Application No. 2025-070936 filed in Japan on Apr. 22, 2025.

### BACKGROUND OF THE INVENTION

### 1. Field of the Invention

The technology of this disclosure relates to a system.

### 2. Description of the Related Art

Japanese Patent Application Laid-open No. 2022-180282 discloses a persona chatbot control method executed by at least one processor, comprising: receiving a user utterance, adding the user utterance to a prompt containing instructions related to the character of the chatbot, encoding the prompt, inputting the encoded prompt into a language model, and generating a chatbot utterance in response to the user utterance.

The problem to be solved by the present invention is to comprehensively solve multifaceted problems in a company operating a contact center, such as a decrease in a customer satisfaction degree caused by complex and emotional customer responses that were difficult to handle with a conventional rule-based response system, a high-stress environment for operators and an increase in a turnover rate due to monotonous work and emotional labor, a deterioration of cost efficiency such as personnel increase and soaring training costs due to a delay in business efficiency improvement, and a lack of data utilization due to an inability to sufficiently utilize useful information such as customer data and a past inquiry history, and specifically, to integrally manage diverse information such as a past history and attribute information for each customer and a skill and a stress level of an operator, grasp an emotion and needs of the customer with high accuracy in real time using generative AI, and automatically generate an optimal response policy, thereby simultaneously improving business efficiency and the customer satisfaction degree while the operator and the AI collaborate, and further, by providing self-learning and a self-correction function by a feedback loop, to flexibly adapt to customization for each company and a market change, and realize a reduction in customer response cost, customer satisfaction improvement, and operator turnover rate reduction.

### SUMMARY OF THE INVENTION

A means for solving the problem according to the present invention is to configure a contact center system comprising a customer information management unit, an operator information management unit, and a generative AI processing unit, wherein the customer information management unit stores an inquiry history, attribute information, a past response result, a customer preference, and use channel information for each customer on a long-term basis, and is capable of referring to a past history and attribute information of the customer in real time when an inquiry occurs, the operator information management unit manages information such as a skill set, an assignment history, a stress level, and a handleable business range for each operator, and performs dynamic assignment control according to an operation status and an aptitude of the operator, and the generative AI processing unit analyzes an inquiry content from the customer in a natural language using generative AI, recognizes an emotion in an inquiry text in real time, automatically generates an optimal response policy while integrally referring to information such as the past history and the attribute of the customer and the skill and the stress level of the operator, further continuously executes self-learning using a customer satisfaction degree and feedback information acquired after a customer response, autonomously optimizes model accuracy and a response content, is adaptable to a change in an inquiry pattern and a market environment, autonomously readjusts a model parameter by a self-correction function when a problem occurs, and simultaneously realizes customer satisfaction improvement, business efficiency improvement, and operator turnover rate reduction.

### BRIEF DESCRIPTION OF THE DRAWINGS

FIG. 1 is a conceptual diagram showing an example configuration of a data processing system according to the first embodiment;

FIG. 2 is a conceptual diagram showing an example of main functions of a data processing device and a smart device according to the first embodiment;

FIG. 3 is a conceptual diagram showing an example configuration of a data processing system according to the second embodiment;

FIG. 4 is a conceptual diagram showing an example of main functions of a data processing device and smart glasses according to the second embodiment;

FIG. 5 is a conceptual diagram showing an example configuration of a data processing system according to the third embodiment;

FIG. 6 is a conceptual diagram showing an example of main functions of a data processing device and a headset-type terminal according to the third embodiment;

FIG. 7 is a conceptual diagram showing an example configuration of a data processing system according to the fourth embodiment;

FIG. 8 is a conceptual diagram showing an example of main functions of a data processing device and a robot according to the fourth embodiment;

FIG. 9 shows an emotion map where multiple emotions are mapped; and

FIG. 10 shows an emotion map where multiple emotions are mapped.

### DETAILED DESCRIPTION OF THE PREFERRED EMBODIMENTS

Hereinafter, an example of an embodiment of the system related to the technology disclosed herein will be described with reference to the attached drawings.

First, the terminology used in the following description will be explained.

In the following embodiments, a processor indicated by reference numeral (hereinafter simply referred to as "processor") may be a single computing device or a combination of multiple computing devices. The processor may be a single type of computing device or a combination of multiple types of computing devices. Examples of computing devices include a CPU (Central Processing Unit), GPU (Graphics Processing Unit), GPGPU (General-Purpose computing on Graphics Processing Units), APU (Accelerated Processing Unit), among others.

In the following embodiments, a RAM (Random Access Memory) indicated by reference numeral is a memory where information is temporarily stored and used as a work memory by the processor.

In the following embodiments, a storage indicated by reference numeral is one or more non-volatile storage devices for storing various programs and parameters. Examples of non-volatile storage devices include flash memory (SSD (Solid State Drive)), magnetic disks (e.g., hard disks), or magnetic tapes, among others.

In the following embodiments, a communication I/F (Interface) indicated by reference numeral is an interface including a communication processor and an antenna, among others. The communication I/F manages communication between multiple computers. Examples of communication standards applicable to the communication I/F include wireless communication standards such as 5G (5th Generation Mobile Communication System), Wi-Fi (registered trademark), or Bluetooth (registered trademark), among others.

In the following embodiments, "A and/or B" means "at least one of A and B." In other words, "A and/or B" means it may be only A, only B, or a combination of A and B. Moreover, when expressing three or more items connected by "and/or," the same concept as "A and/or B" applies.

### FIRST EMBODIMENT

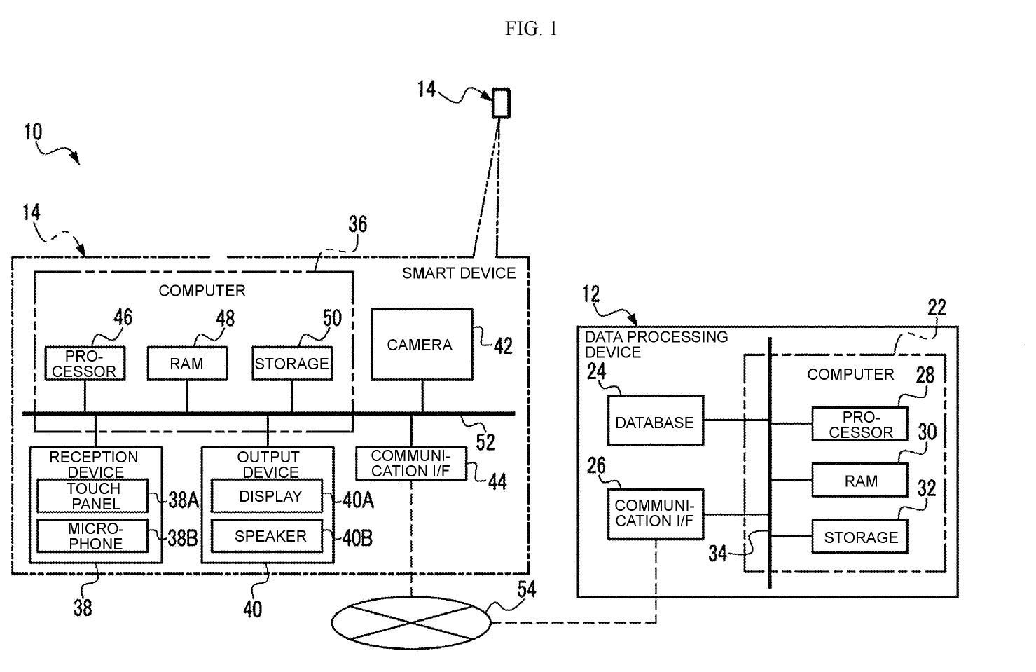

FIG. 1 shows an example configuration of a data processing system 10 according to the first embodiment.

As shown in FIG. 1, the data processing system 10 comprises a data processing device 12 and a smart device 14. An example of the data processing device 12 is a server.

The data processing device 12 comprises a computer 22, a database 24, and a communication I/F 26. The computer 22 is an example of a "computer" related to the technology disclosed herein. The computer 22 comprises a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN (Wide Area Network) and/or a LAN (Local Area Network), among others.

The smart device 14 comprises a computer 36, a reception device 38, an output device 40, a camera 42, and a communication I/F 44. The computer 36 comprises a processor 46, RAM 48, and storage 50. The processor 46, RAM 48, and storage 50 are connected to a bus 52. The reception device 38, output device 40, camera 42, and communication I/F 44 are also connected to the bus 52.

The reception device 38 comprises a touch panel 38A and a microphone 38B, among others, and accepts user input. The touch panel 38A accepts user input by detecting contact from an indicating object (e.g., a pen or finger). The microphone 38B accepts user input by detecting the user's voice. The control unit 46A in the processor 46 sends data indicating user input accepted by the touch panel 38A and microphone 38B to the data processing device 12. In the data processing device 12, the specific processing unit 290 acquires data indicating user input.

The output device 40 comprises a display 40A and a speaker 40B, among others, and presents data to the user 20 by outputting it in a perceptible form (e.g., audio and/or text). The display 40A displays visible information such as text and images according to instructions from the processor 46. The speaker 40B outputs audio according to instructions from the processor 46. The camera 42 is a small digital camera equipped with optical systems such as lenses, apertures, and shutters, as well as imaging elements such as CMOS (Complementary Metal-Oxide-Semiconductor) image sensors or CCD (Charge Coupled Device) image sensors.

The communication I/F 44 is connected to the network 54. The communication I/F 44 and 26 manage the exchange of various information between the processor 46 and the processor 28 via the network 54.

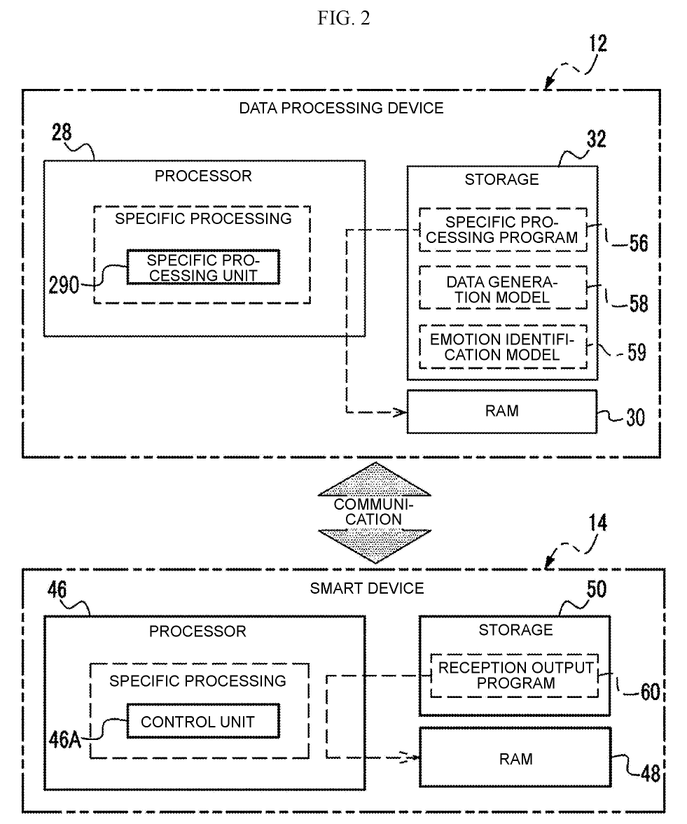

FIG. 2 shows an example of the main functions of the data processing device 12 and the smart device 14.

As shown in FIG. 2, specific processing is performed in the data processing device 12 by the processor 28. The storage 32 stores a specific processing program 56. The specific processing program 56 is an example of a "program" related to the technology disclosed herein. The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290. The specific processing unit 290 can estimate the user's emotions using the emotion identification model 59 and perform specific processing using the user's emotions. The emotion estimation function (emotion identification function) using the emotion identification model 59 includes estimating and predicting the user's emotions, and various estimations and predictions related to the user's emotions are performed, but it is not limited to such examples. Furthermore, emotion estimation and prediction may include, for example, emotion analysis.

In the smart device 14, reception output processing is performed by the processor 46. The storage 50 stores a reception output program 60. The reception output program 60 is used in conjunction with the specific processing program 56 by the data processing system 10. The processor 46 reads the reception output program 60 from the storage 50 and executes it on the RAM 48. The reception output processing is realized by the processor 46 operating as a control unit 46A according to the reception output program 60 executed on the RAM 48. The smart device 14 may also have similar data generation models and emotion identification models as the data generation model 58 and emotion identification model 59, and perform the same processing as the specific processing unit 290 using these models. The reception output processing is realized by the processor 46 operating as the control unit 46A according to the reception output program 60 executed on the RAM 48.

Other devices besides the data processing device 12 may have the data generation model 58.

For example, a server device (e.g., a generation server) may have the data generation model 58.

In this case, the data processing device 12 communicates with the server device having the data generation model 58 to obtain processing results (e.g., prediction results) using the data generation model 58. The data processing device 12 may be a server device or a terminal device owned by the user (e.g., a mobile phone, robot, home appliance, etc.). Next, an example of processing by the data processing system 10 according to the first embodiment will be described.

### Example 1

The flow of the specific processing in Example 1 will be described. Each part of the system described below is realized by the data processing device 12 and the smart device 14. Additionally, the data processing device 12 is referred to as a "server," and the smart device 14 is referred to as a "terminal."

### EMBODIMENT FOR CARRYING OUT THE PRESENT INVENTION

An embodiment of the present invention is a contact center system composed of a server and a terminal, and comprises a customer information management unit, an operator information management unit, and a generative AI processing unit. The server bears core functions of the customer information management unit, the operator information management unit, and the generative AI processing unit, and the terminal comprises a user interface operated by an operator and, if necessary, a lightweight AI inference module. Hereinafter, a configuration and a function of each unit, a utilization method of generative AI, role sharing between the server and the terminal, and a specific operation example will be described extremely in detail and comprehensively. Specifically, the present contact center system adopts an architecture that links a plurality of computing nodes in a distributed computing environment. The present server is composed of a physical server or a virtual server group comprising a multi-core processor and a large-capacity memory. The present server implements the customer information management unit and the operator information management unit as a relational database or a NoSQL database. The present server constructs the generative AI processing unit on a parallel computing cluster using a GPU. The present terminal is a personal computer or a smart device, and executes the lightweight AI inference module using edge computing technology. The present lightweight AI inference module includes a neural network model in which the number of parameters is reduced by quantization or knowledge distillation. The present system dynamically switches between large-scale inference processing on the server side and low-latency inference processing on the terminal side. With this configuration, the present system exhibits a technical effect of dramatically improving a response speed of the entire system while suppressing consumption of a network bandwidth. The present system is particularly useful in application fields requiring real-time performance and high security, such as customer support of a financial institution and a reservation reception center of a medical institution. The present system replaces a conventional manual information search operation by a human with an automatic extraction process based on a similarity calculation in a high-dimensional vector space. Thereby, the present system reduces a calculation time required for an information search to a millisecond unit.

The customer information management unit is realized on the server, and stores and manages an inquiry history and attribute information (such as a name, an age, a gender, a contract content, a used service, a past purchase history, a past complaint history, a past satisfaction score, a use channel, a response history, and a questionnaire result) for each customer on a long-term basis. For example, information necessary for each industry is comprehensively managed, such as a past transaction history and presence/absence of unauthorized use in the financial industry, a medical history and a reservation history in the medical industry, a purchased product and a return history in the retail industry, and a contract plan and a past failure response history in the communication industry. When a customer makes an inquiry, an inquiry content is transmitted from the terminal to the server, and the customer information management unit immediately extracts all histories of the corresponding customer and provides them to the generative AI processing unit. Specifically, the present customer information management unit structures customer information as multidimensional time-series data and stores it in a database. The present customer information management unit converts the attribute information and the history information of each customer into a fixed-length numerical vector using a natural language processing model. The present customer information management unit indexes and stores the converted numerical vector in a vector database. The present customer information management unit similarly encodes text data of the inquiry content received from the terminal into a numerical vector. The present customer information management unit calculates a cosine similarity between the numerical vector of the inquiry content and the numerical vector of the customer information in the database. The present customer information management unit extracts history data having a similarity exceeding a predetermined threshold at high speed. This extraction process is an unconventional method that evaluates semantic relevance as a distance calculation in a high-dimensional space, unlike a conventional search by keyword matching. The present customer information management unit generates a multidimensional tensor in which the extracted history data are rearranged in chronological order. The present customer information management unit provides the generated multidimensional tensor to the generative AI processing unit as input data. With this configuration, the present system exhibits a technical effect of instantly specifying information matching a context from a vast amount of customer data. The present system is applicable to a use case of performing personalized product recommendation based on a past purchase tendency of a customer in a call center for mail order. The present system reduces a calculation amount of a data search and reduces a CPU load of the server.

The operator information management unit is also realized on the server, and centrally manages a skill set (for example, "credit card unauthorized use response", "medical consultation", "delivery arrangement", "contract change", "failure response", etc.), an assignment history (what kind of inquiries were processed and how many in the past), a stress level (the latest number of responses, an evaluation from a customer, a break status, an emotion analysis result by AI, etc.), a handleable business range (for example, "only medical field", "both financial and retail handleable", etc.), and an operation status (whether currently responding or waiting, an overtime status, etc.) for each operator. For example, information such as operator A is strong in the medical field, operator B can handle both finance and retail, and operator C is a newcomer and has a high stress level is grasped in real time. Specifically, the present operator information management unit holds a state of each operator as a dynamically updated state vector. The present operator information management unit expresses the skill set of the operator as a one-hot encoded multidimensional array. The present operator information management unit collects voice data of the operator and a typing speed of keystrokes in real time. The present operator information management unit preprocesses the collected raw data and inputs it to a recurrent neural network. The present recurrent neural network outputs a continuous value score from 0.0 to 1.0 indicating a fatigue degree and a stress level of the operator from the time-series raw data. When the output stress level score exceeds 0.8, the present operator information management unit automatically changes an operation status flag of the corresponding operator to break recommendation. The present operator information management unit integrates the state vector of each operator and generates a resource distribution matrix of the entire operator pool. The present system uses this resource distribution matrix to determine an optimal assignment of an operator in a subsequent routing process. This process is an objective and quantitative algorithm process based on biological information and an operation log, unlike conventional business management in which a human manager makes a visual judgment. With this configuration, the present system brings about a technical effect of preventing an overload of the operator in advance and optimizing a processing throughput of the entire system. The present system is applied to a use case of automatically distributing a highly difficult inquiry to an operator with a high skill score in a large-scale technical support center.

The generative AI processing unit is realized on the server, and uses generative AI as an essential element. The generative AI is configured by combining a plurality of AI technologies such as a large language model, a natural language processing model, an emotion recognition AI, a predictive modeling AI, and a clustering AI, for example. The generative AI analyzes an inquiry content transmitted from the terminal in a natural language, and recognizes an emotion in an inquiry text with high accuracy. For example, it determines "confusion" for an inquiry "I am in trouble because the product has not arrived", and determines "anger" for a case of "Please do not make me say the same thing over and over again". For emotion recognition, an external emotion recognition engine or an originally developed deep learning model is combined, and in the case of voice input, voice emotion analysis is also used together. Specifically, the present generative AI processing unit comprises a large language model based on a transformer architecture as a core. The present generative AI processing unit tokenizes text data received from the terminal and converts it into, for example, a 512-dimensional word embedding vector. The present generative AI processing unit adds positional encoding to the word embedding vector and inputs it to a multi-layer self-attention mechanism. The present generative AI processing unit extracts a semantic representation vector of the entire sentence from an output of the self-attention mechanism. The present generative AI processing unit inputs the semantic representation vector to a fully connected layer and a softmax function. The present generative AI processing unit outputs a probability distribution for each emotion category such as anger, sadness, joy, and neutrality as an output of the softmax function. For example, the present generative AI processing unit outputs a probability of anger as 0.85 and a probability of sadness as 0.10 in response to an input that a product was damaged. In the case of voice input, the present generative AI processing unit converts a voice waveform into an acoustic feature tensor such as a mel-frequency cepstral coefficient. The present generative AI processing unit inputs the acoustic feature tensor to a convolutional neural network, and outputs an emotion score based on a voice tone and intonation. The present generative AI processing unit integrates an emotion probability distribution based on text and an emotion score based on voice using an ensemble learning method. The present generative AI processing unit passes the integrated final emotion label to a subsequent response generation module. With this configuration, the present system exhibits a technical effect of detecting potential dissatisfaction of a customer at an early stage and preventing a complaint from becoming serious. The present system is applicable to a use case of detecting a panic state of a customer and automatically raising a priority in road service reception requiring an emergency response.

The generative AI integrally refers to information such as a past history and an attribute of a customer, and a skill and a stress level of an operator, and automatically generates an optimal response policy. For example, for a customer who has had similar complaints a plurality of times in the past, a quicker solution or a special apology text is generated based on a previous response content. In the medical field, an appropriate medical treatment guide and precautions are automatically generated by referring to a medical history and allergy information of a patient. In the financial field, a quick identity verification procedure and compensation guidance are generated by referring to a past unauthorized use history and identity verification information. In the retail field, automation of a return/exchange procedure, a discount proposal at the time of next purchase, and the like are performed by referring to a past purchased product and a return history. In the communication field, a simultaneous notification and an individual response are combined when a failure occurs, and an individual message such as "A failure is currently occurring. The estimated restoration time is XX:XX. We apologize for the inconvenience" is generated, for example. Specifically, the present generative AI combines a customer history tensor acquired from the customer information management unit, a state vector acquired from the operator information management unit, and a label of an emotion recognition result to generate an integrated context vector. The present generative AI inputs this integrated context vector to a large language model as a part of a prompt. The present large language model autoregressively generates a token based on the input integrated context vector. The present large language model generates a structured data format indicating a response procedure and a natural language response text to be presented to the customer as output data. For example, the present large language model receives 3 past complaints, a current emotion of anger, and a medium operator skill as an input. The present large language model generates text data of an escalation recommendation to a superior as a response policy and "We sincerely apologize for the great inconvenience caused. I will immediately transfer you to a person in charge" as a response text as an output. The present generative AI scores the generated text using a reward model based on reinforcement learning in order to evaluate validity of the generated response policy. When the score falls below a predetermined threshold, the present generative AI regenerates the response text using a different temperature parameter. This process replaces a mental process in which a human operator searches a manual and considers a response with a probabilistic token generation algorithm in a high-dimensional space. With this configuration, the present system exhibits a technical effect of executing determination of a response policy involving complex conditional branching in a millisecond unit and reducing a response delay to the utmost limit. The present system is applied to a use case of automatically generating a proposal of an alternative flight and compensation guidance individually for each customer when a flight cancellation occurs in a reservation center of an airline company.

The generative AI presents the generated response policy, response text, additional proposal, precautions, FAQ link, related manual, and the like to an operator terminal in real time. For example, a specific instruction such as "This customer has made similar inquiries 3 times in the past, and since an apology and a discount coupon were provided for a delivery delay last time, an additional apology and a detailed explanation of a delivery status are recommended this time" is displayed on an operator screen. Furthermore, it is also possible to transmit the response text generated by the AI as it is in a chat, or to automatically respond by voice synthesis. The operator can finely adjust a response content at his/her own discretion as necessary while referring to the proposal of the AI. Specifically, the present generative AI packetizes text data of the generated response policy and response text together with metadata for display, and transmits it to the operator terminal. The present operator terminal analyzes the received packet and dynamically renders it in a predetermined area on a graphical user interface. The present operator terminal automatically applies highlight processing and color coding according to an importance degree to the text data of the response text. The present operator terminal comprises a text-to-speech conversion engine. The present operator terminal converts the generated response text into voice waveform data, and executes an automatic response by voice synthesis. When the operator edits the response text, the present operator terminal calculates a difference between the text before and after editing using an algorithm such as a Levenshtein distance. The present operator terminal asynchronously transmits the calculated difference data to the server as feedback information. This process is not a mere display of information, but a technical process of analyzing an operation log of the operator in real time and realizing a cooperative operation between the system and a human. With this configuration, the present system brings about a technical effect of significantly reducing an input load of the operator and physically preventing a typing error and a guidance mistake. The present system is applicable to a use case in which an operator transmits a translated response text generated by AI with one click in a multilingual help desk. The present system compresses and transmits only the difference data in order to optimize communication traffic.

After a customer response, a customer satisfaction score (for example, a questionnaire result such as "very satisfied" or "somewhat dissatisfied") and feedback from an operator (for example, "AI proposal was accurate", "proposal did not fit the site", etc.) are transmitted from the terminal to the server, and the generative AI processing unit accumulates and analyzes these data. The generative AI continuously executes self-learning using these feedbacks, and optimizes a model parameter and a response generation algorithm. For example, when a satisfaction degree is low in a specific response pattern, a response text and a response procedure of the pattern are automatically corrected and improved. Conversely, a pattern with a high satisfaction degree is actively deployed to other operators. Furthermore, when a stress level of the operator is high, the AI can automatically adjust the number of responses or recommend a break. Specifically, the present server accumulates the received customer satisfaction score and the edit difference data of the operator as training data. The present generative AI processing unit periodically executes fine-tuning of a large language model using the accumulated training data. The present generative AI processing unit adopts a parameter efficiency method such as low-rank adaptation in the fine-tuning. The present generative AI processing unit updates only an additional low-rank matrix by a gradient descent method while fixing a weight matrix of an original model. The present generative AI processing unit uses a cross-entropy error as a loss function, and minimizes an error between the generated response text and the response text actually corrected by the operator. The present generative AI processing unit executes a proximal policy optimization algorithm using the customer satisfaction score as a reward signal. The present generative AI processing unit decreases a generation probability of a response pattern with a low satisfaction degree, and increases a generation probability of a response pattern with a high satisfaction degree. This process clearly defines a learning process of AI, which tends to be a black box, as a specific mathematical operation of error backpropagation and weight updating. With this configuration, the present system exhibits a technical effect of autonomously improving response accuracy as an operation period becomes longer, and preventing obsolescence of the model. The present system is applied to a use case of quickly adapting a model to the latest fashion trend and a change in a customer preference in customer support of the apparel industry with severe seasonal fluctuations. The present system executes a learning process in the background using an empty resource of a GPU cluster, and eliminates an influence on an inference process in a production environment.

When detecting a new inquiry pattern or a change in a market environment, the generative AI autonomously generates a response policy for a new pattern using clustering or a pattern recognition technology, and quickly reflects it in the entire system. For example, when an inquiry "I do not know how to use the new service" rapidly increases immediately after the start of a new service, the AI automatically generates an FAQ and a manual, and immediately reflects them on an operator screen. When a law or regulation is changed, a related inquiry is automatically extracted, and a response text is automatically generated based on the latest legal information. When a disaster occurs, it is also possible to automatically distribute safety confirmation and support information all at once to customers in a disaster-stricken area. Specifically, the present generative AI applies an unsupervised clustering algorithm in real time to an embedding vector group of inquiry texts input daily. When a dense region of a new vector group is formed at a position separated by a certain Euclidean distance or more from an existing cluster in a high-dimensional vector space, the present generative AI detects this as a new inquiry pattern. When detecting the new pattern, the present generative AI extracts a plurality of text data closest to a center point of the corresponding vector group. The present generative AI inputs the extracted text data to a summarization model, and automatically extracts a topic serving as a core of the new pattern. The present generative AI combines the extracted topic and the latest information acquired from an external knowledge base, and automatically generates markup data of a new answer entry. The present generative AI immediately commits the generated markup data to a shared database in the system, invalidates caches of all operator terminals, and updates a display. This process completely replaces a conventional process in which a human manager manually analyzes a trend and creates a manual with a density calculation on a vector space and an automatic text generation algorithm. With this configuration, the present system brings about a technical effect of dramatically shortening an adaptation time of the system to an unknown event from several days to several minutes. The present system is applicable to a use case of instantly detecting a rapid increase in failure reports and automatically distributing a provisional workaround to all operators in an IT service desk where a large-scale system failure has occurred.

From a viewpoint of security and privacy protection, customer information and a response history are strictly managed on the server, and only minimum necessary information is transmitted to the terminal side. For example, a configuration can be adopted in which only a response policy and necessary history information are displayed on the terminal side in a form in which an individual cannot be identified. Furthermore, a part of inference processing of the generative AI and a user interface can be executed on the terminal side, and it can be designed such that minimum response generation and history reference are possible even when offline or when a network delay occurs, for example. Specifically, the present server executes data encryption using an advanced encryption standard on a database of customer information and a response history. Before transmitting data to the terminal, the present server dynamically masks personal information such as a name and a credit card number included in text data using regular expression matching and a named entity recognition model. The present server transmits only the masked text data to the terminal via a secure communication protocol. The present terminal holds a lightweight language model on a local memory. When a communication delay with the server exceeds a predetermined threshold, or when a network connection is disconnected, the present terminal automatically switches to an inference mode using the local lightweight model. The lightweight model of the present terminal generates a provisional response text completed within a local environment from the input text data. When the network connection is recovered, the present terminal collectively synchronizes a response history generated and transmitted locally to the server. This process is not limited to mere data concealment, but is an advanced distributed processing architecture that dynamically allocates computing resources on a cloud side and an edge side according to a network state. With this configuration, the present system exhibits a technical effect of maintaining availability of the system even when a communication failure occurs while mathematically reducing a risk of information leakage. The present system is applied to a use case of continuing uninterrupted customer response in a temporary call center installed in a remote area or a disaster site where a communication infrastructure is unstable.

For example, in the financial field, when a customer inquires "My card has been used unauthorizedly", the generative AI immediately refers to a past use history and identity verification information, automatically generates a response text such as "I will check the latest use history, so please tell me your date of birth and registered phone number for identity verification. Details of a compensation procedure are as follows", and presents it to an operator. In the medical field, when a patient inquires "I want to change my reservation", the generative AI refers to a past reservation history and a medical history, and generates a response text such as "Your current reservation is at XX:XX on XX/XX. If you let me know your desired date and time, I will check availability and guide you to a change of doctor if

necessary". In the retail field, when a customer inquires "I want to return a product", the generative AI refers to a past purchase history and a return history, and generates an individually optimized response such as "The product you purchased has been shipped on XX/XX. A return procedure can be performed by the following procedure. Please note that shipping was free at the time of the previous return, but conditions are different this time". In the communication field, when a customer inquires "I cannot connect to the internet", the generative AI refers to failure information and a contract plan, and provides real-time information such as "A failure is currently occurring in the XX area. The estimated restoration time is XX:XX. We apologize for the inconvenience". Specifically, the present generative AI internally comprises a plurality of expert models that have learned domain knowledge peculiar to each industry. The present generative AI dynamically selects an optimal expert model via a routing network based on a vector representation of the input inquiry text. When the expert model in the financial field is selected, the present generative AI receives a customer identifier, a time-series tensor of a transaction history, and a fraud detection score as input data. The present financial expert model outputs structured data in which an identity verification request flag is true as output data and "I will check the latest use history" as a generated text. When the expert model in the medical field is selected, the present generative AI receives a patient identifier, a text vector of an electronic medical record, and a matrix of a reservation schedule as input data. The present medical expert model outputs data of a list of changeable reservation slots as output data and "Your current reservation is" as a generated text. When the expert model in the retail field is selected, the present generative AI receives an order identifier, a purchase history vector, and a return policy rule set as input data. The present retail expert model outputs data in which a return condition flag is onerous as output data and "The product you purchased is" as a generated text. When the expert model in the communication field is selected, the present generative AI receives a line identifier, an alive monitoring log of a network device, and position information coordinates as input data. The present communication expert model outputs data in which a failure corresponding flag is true as output data and "Currently in the corresponding area" as a generated text. This process is an unconventional architecture that concentrates computing resources on a specific subnetwork according to a task, instead of processing everything with a single huge model. With this configuration, the present system brings about a technical effect of significantly reducing a calculation cost and power consumption while maintaining high inference accuracy for inquiries in various domains. The present system is applicable to a use case of processing inquiries of all businesses with a single system infrastructure in an integrated contact center of a conglomerate company developing a plurality of businesses.

In addition, the generative AI can also be utilized for education and training of operators. For example, when a new operator responds, the generative AI can present past excellent response cases or display advice in real time during the response. Furthermore, a function of automatically evaluating a response content of the operator and presenting feedback and an improvement point can also be implemented. Specifically, the present generative AI comprises a dialogue agent module that behaves as a virtual customer in a simulation environment. The dialogue agent module reads various emotion parameters and utterance patterns extracted from past actual inquiry logs as an initial prompt. The dialogue agent module receives an input text or a voice recognition text of the new operator in real time. The dialogue agent module generates a response in a natural language based on the set emotion parameter for the received input, and executes a simulated dialogue session. During the dialogue session, the present generative AI quantitatively scores a response speed of the operator, a coverage rate of keywords, and the presence or absence of an empathetic expression using a natural language processing algorithm. The present generative AI outputs a multifaceted evaluation matrix in which, for example, a presentation speed of a solution is 85 points and an empathetic expression is 40 points. Regarding an item with a low score, the present generative AI extracts text data having a similar context from a response log of a past highly evaluated operator, and pop-up displays it on a screen as an improvement proposal. This process replaces conventional on-site training constantly accompanied by a human instructor with a data-driven automatic evaluation and feedback loop. With this configuration, the present system exhibits a technical effect of significantly shortening a period required for skill mastery of the operator and reducing an education cost. The present system is applied to a use case of equalizing education quality and raising a service level in a large-scale call center where a turnover rate is high and new hiring is constantly performed.

In this way, the embodiment of the present invention realizes core functions of the customer information management unit, the operator information management unit, and the generative AI processing unit on the server side, and arranges an operator interface and a lightweight AI inference module as necessary on the terminal side, thereby realizing an advanced contact center system that grasps a context and an emotion for each customer in real time, automatically generates and presents an optimal response policy, and continuously executes self-learning, self-correction, and environmental adaptation. The generative AI plays an indispensable role in all processes such as inquiry analysis, emotion recognition, response generation, self-learning, self-correction, environmental adaptation, operator education, trend analysis, FAQ automatic generation, manual automatic update, simultaneous notification in the event of a disaster, and legal regulation change response, and enables highly accurate and flexible customer response that could not be realized by a conventional rule-based system. Specifically, the present system adopts a hybrid architecture that links a cloud computing environment and an edge device. The present system dynamically distributes an inference task between a large-scale neural network model on the server side and a lightweight model on the terminal side. The present system constantly measures complexity of input data and a delay status of a network by a monitoring module. The present system executes a routing algorithm that determines whether to process each inference request on the server or on the terminal based on the measured metrics. The present system minimizes latency of the entire system and maximizes throughput by this dynamic routing. The present system containerizes each module of the generative AI as a microservice, and automatically scales out or scales in according to a load using an orchestration tool. This process is fundamentally different from a static rule-based system, and is an improvement in computer technology that autonomously optimizes resources with respect to fluctuations in data traffic. With this configuration, the present system brings about a technical effect of preventing a system down even against a sudden surge in inquiries and continuing stable service provision. The present system is applicable as a mission-critical customer response platform that operates in an environment where traffic is unpredictable, such as immediately after a television shopping broadcast or when a large-scale disaster occurs. The present system maximizes utilization efficiency of hardware resources and reduces an operation cost.

### SYSTEM CONFIGURATION

The system according to the present embodiment comprises a customer information management unit, an operator information management unit, a generative AI processing unit, a terminal interface unit, a feedback accumulation unit, a security management unit, and an external cooperation unit. The customer information management unit stores and manages an inquiry history, attribute information, a past response result, a purchase history, a complaint history, a questionnaire result, a use channel, a contract content, a past satisfaction score, and the like for each customer on a long-term basis, and comprehensively manages information necessary for each industry, such as a past transaction history and the presence or absence of unauthorized use in the financial field, a medical history and a reservation history in the medical field, a purchased product and a return history in the retail field, and a contract plan and a failure response history in the communication field, for example. When a customer makes an inquiry through various channels such as a chat, a voice call, and an email, the customer information management unit immediately extracts all histories of the corresponding customer and provides them to the generative AI processing unit. For example, if there is an inquiry history such as "suspension of credit card use" or "change of medical reservation" in the past, those histories are immediately referred to. Furthermore, an age, a gender, a residential area, a family structure, a used terminal, a past campaign participation history, and the like are also managed as the attribute information of the customer, and are utilized for an individually optimized response. Specifically, the present system functions as an integrated information processing apparatus in which a plurality of functional modules are coupled via a high-speed internal bus or a virtual network. The present customer information management unit stores customer data using a distributed graph database. The present customer information management unit constructs a graph structure expressing a customer as a node and a purchase history and an inquiry history as edges. When receiving a new inquiry from a customer, the present customer information management unit analyzes a peripheral graph structure of the corresponding customer node using a graph neural network. The present customer information management unit generates a high-dimensional feature vector representing a current situation and a potential need of the customer as an output of the graph neural network. For example, the present customer information management unit receives a customer node identifier, a transaction edge group for the past three months, and the latest complaint edge as input data. The present customer information management unit generates a feature vector including a predicted value in which a cancellation risk score is 0.85 and a recommended response category is a special discount proposal as output data. The present customer information management unit transfers the generated feature vector to the generative AI processing unit. This process is a non-conventional data processing method that replaces a simple query search of a relational database with a deep learning algorithm based on a graph structure. With this configuration, the present system exhibits a technical effect of computationally extracting not only an explicit inquiry content of the customer but also a complex context and relationship behind it, and dramatically improving accuracy of a response. The present system is applied to a use case of early detecting a sign of cancellation and automatically executing a proactive retention measure in a customer success department of a subscription-type service.

The operator information management unit centrally manages a skill set, an assignment history, a stress level, a handleable business range, an operation status, a break status, a past customer evaluation, an education history, qualification information, and the like for each operator. For example, information is grasped in real time, such as operator A is strong in the medical field, operator B can handle both finance and retail, operator C is a newcomer and has a high stress level, operator D has acquired many high evaluations in the past, and operator E can respond at night. When dynamically assigning an optimal operator to an inquiry content and a customer attribute, for example, an operator having a medical skill is preferentially assigned to an inquiry requiring specialized knowledge in the medical field, and automatic adjustment is performed to reduce a load on an operator having a high stress level. Furthermore, by referring to the education history and the qualification information of the operator, it is also possible to perform control such that only a qualification holder can respond to a specific inquiry. Specifically, the present operator information management unit expands profile data of each operator on a memory as a multidimensional capability matrix. The present operator information management unit calculates a matching score using an attention mechanism between a feature vector of an incoming inquiry and a capability matrix of each waiting operator. In calculating the matching score, the present operator information management unit uses a unique evaluation function incorporating a current stress level and a continuous operation time of the operator as a penalty term. The present operator information management unit specifies an operator having the highest comprehensive score calculated by the evaluation function, and transmits a session connection request to a terminal of the corresponding operator. For example, the present operator information management unit receives high inquiry difficulty, required skill medical, and customer emotion anger as input data. The present operator information management unit calculates a score of each operator, and outputs an optimal operator identifier D and a matching score of 0.92 as output data. When a flag requesting a specific qualification is set, the present operator information management unit applies a hard constraint filter that forcibly sets a score of an operator having no qualification information to zero. This process replaces a simple round-robin method or rule-based assignment with a real-time solution of a dynamic multivariable optimization problem. With this configuration, the present system brings about a technical effect of preventing a skill mismatch of an operator, shortening an average processing time, and improving a first contact resolution rate. The present system is applicable to a use case of performing reliable routing compliant with laws and regulations to an operator having a specific financial instrument transaction qualification in a call center of a securities company.

The generative AI processing unit uses generative AI as an essential element, and is configured by combining a plurality of AI technologies such as a natural language processing model, a large language model, an emotion recognition AI, a predictive modeling AI, and a clustering AI. The generative AI processing unit analyzes an inquiry content transmitted from the terminal interface unit in a natural language, and recognizes an emotion in an inquiry text with high accuracy. For example, for an inquiry "I am in trouble because the product has not arrived", it is determined as "confusion", and for a case of "Please do not make me say the same thing over and over again", it is determined as "anger". For emotion recognition, an external emotion recognition engine or a uniquely developed deep learning model is combined, and in the case of voice input, voice emotion analysis is also used together. The generative AI integrally refers to information such as a past history and an attribute of a customer, and a skill and a stress level of an operator, and automatically generates an optimal response policy. For example, for a customer who has had similar complaints a plurality of times in the past, a quicker solution or a special apology text is generated based on a previous response content. In the medical field, an appropriate medical treatment guide and precautions are automatically generated by referring to a medical history and allergy information of a patient. In the financial field, a quick identity verification procedure and a compensation guide are generated by referring to a past unauthorized use history and identity verification information. In the retail field, automation of a return/exchange procedure, a discount proposal at the time of next purchase, and the like are performed by referring to a past purchased product and a return history. In the communication field, a simultaneous notification and an individual response are combined when a failure occurs, and an individual message such as "A failure is currently occurring. The estimated recovery time is XX:00. We apologize for the inconvenience" is generated, for example. The generative AI presents the generated response policy, response text, additional proposal, precautions, FAQ link, related manual, and the like to an operator terminal in real time. For example, a specific instruction is displayed on an operator screen, such as "This customer has made similar inquiries three times in the past, and since an apology and a discount coupon were provided for a delivery delay last time, an additional apology and a detailed explanation of a delivery status are recommended this time". Furthermore, it is also possible to transmit a response text generated by AI as it is in a chat, or to automatically respond by voice synthesis. The operator can finely adjust a response content at his/her own discretion as necessary while referring to the proposal of the AI. Specifically, the present generative AI processing unit executes an inference graph in which a plurality of neural network models are connected in a pipeline shape. The present generative AI processing unit applies a sequence labeling model that extracts a named entity such as a product name, a date and time, and an amount of money from an input text as a first-stage model. The present generative AI processing unit executes a multilayer perceptron that classifies a category of a response policy by using the extracted named entity and a customer history vector as inputs as a second-stage model. The present generative AI processing unit generates a final response text by an autoregressive large language model using the classified category and an emotion label as a conditioning prompt as a third-stage model. For example, the present generative AI processing unit receives a text that a screen of a television bought yesterday is cracked and a customer history of an excellent customer as input data. The present generative AI processing unit extracts product television and state screen crack as a first-stage output. The present generative AI processing unit determines response category free exchange as a second-stage output. The present generative AI processing unit generates a text "We are very sorry. We will immediately arrange to ship a new television" as a third-stage output. The present generative AI processing unit applies an inappropriate term filtering model to the generated text, and automatically eliminates a risk of compliance violation. This process is an advanced information processing method that suppresses a groundless output by coordinating a plurality of models specialized for each task without depending on a single model. With this configuration, the present system exhibits a technical effect of ensuring accuracy and safety of a generated response and protecting a corporate brand. The present system is applied to a use case of automatically generating an accurate and legally safe initial response to a side effect report in a medicine consultation counter of a pharmaceutical company where strict quality standards are required.

The terminal interface unit provides a user interface operated by an operator, and enables inquiry reception through various channels such as a chat, a voice call, an email, and a video call, display of an AI proposal, editing of a response text, reference to customer information, browsing of an FAQ and a manual, feedback input, and the like. For example, a response text generated by AI can be transmitted with one click on a chat screen, an AI can display a response proposal in real time during a voice call, and an FAQ and a manual can be automatically pop-up displayed. Furthermore, an interface is also provided that enables the operator to immediately input feedback such as "this proposal is appropriate" or "this proposal does not fit the site" with respect to the AI proposal. Specifically, the present terminal interface unit establishes a communication channel with a server using a bidirectional real-time communication protocol. The present terminal interface unit is implemented as a single page application, and asynchronously updates a document object model without accompanying a screen transition. In a voice call channel, the present terminal interface unit captures voices of an operator and a customer as separate streams, and transmits them in parallel to a voice recognition engine on the server side. The present terminal interface unit scroll-displays text data and an AI response proposal returned from the server on a timeline on a screen in synchronization with a timestamp of an utterance. The present terminal interface unit dynamically assigns a background color according to a reliability score to each phrase of a response text generated by AI. When the operator corrects the response text, the present terminal interface unit packages a text difference of a corrected portion and a time required for the correction as metadata. The present terminal interface unit transmits this packaged feedback data to the server in a background process. This process functions not as a mere screen display program but as an advanced sensor interface for collecting interaction between a human and a machine as quantitative data. With this configuration, the present system brings about a technical effect of visually reducing a cognitive load of an operator and preventing an operation error. The present system is applicable to a use case of supporting context switching of an operator in an omnichannel support center that simultaneously processes a plurality of chat sessions.

The feedback accumulation unit accumulates and manages various evaluation indexes such as a customer satisfaction score, a questionnaire result, feedback from an operator, an adoption rate of an AI proposal, a response speed, a complaint occurrence rate, and a re-inquiry rate acquired after a customer response. For example, when a customer evaluates as "very satisfied" or when an operator feeds back that "an AI proposal was accurate", these pieces of information are provided to the generative AI processing unit and utilized for self-learning and model optimization. Conversely, when a satisfaction degree is low or when there is an indication from an operator that "a proposal was inappropriate", the generative AI activates a self-correction function, and automatically executes readjustment and relearning of a model parameter. Furthermore, the feedback accumulation unit is also utilized for business improvement and optimization of an education program. Specifically, the present feedback accumulation unit stores the collected various evaluation indexes in a time-series database, and constructs a multidimensional online analytical processing cube. The present feedback accumulation unit integrally analyzes quantitative data such as an adoption rate of an AI proposal and a response speed, and qualitative data such as a free description of a questionnaire. The present feedback accumulation unit extracts a topic and an emotion polarity from a free description text using a natural language processing model, and converts them into a quantified sentiment score. The present feedback accumulation unit constructs a regression model that predicts a customer satisfaction degree using a random forest algorithm with these quantified index groups as input features. The present feedback accumulation unit calculates feature importance of the regression model, and statistically specifies which response process contributes most to the satisfaction degree. The present feedback accumulation unit executes a script that automatically rewrites a prompt template of the generative AI processing unit based on the specified important factor. For example, when determining that the presence or absence of a phrase showing empathy is strongly correlated with the satisfaction degree, the present feedback accumulation unit dynamically adds a constraint condition to a prompt to always show empathy at the beginning. This process replaces a cycle of data analysis and business improvement performed by a human analyst with an autonomous parameter tuning loop by a machine learning algorithm. With this configuration, the present system exhibits a technical effect of continuously optimizing performance of the entire system without human intervention with respect to a change in an external environment and a change in a customer preference. The present system is applied to a use case of always maintaining response quality at the highest level in a support counter of a smartphone application in which a product life cycle is short and a customer reaction changes daily.

The security management unit encrypts confidential data such as customer information, a response history, and operator information, and prevents unauthorized access and information leakage. For example, a communication path is protected using a post-quantum cryptography technology, access to personal information is restricted by finely setting an access authority, and a login history and an operation history are recorded as an audit log. Furthermore, privacy protection is thoroughly performed by adopting a configuration in which only minimum necessary information is transmitted to the terminal side, and only a response policy and necessary history information are displayed in a form in which an individual cannot be specified. Specifically, the present security management unit implements an access control mechanism based on a zero trust architecture. When an operator logs in, the present security management unit requests multi-factor authentication using biometric authentication and a hardware token in addition to password authentication. The present security management unit dynamically evaluates a network address and a physical address of a terminal of the operator and a patch application status of an operating system, and calculates a reliability score. When the reliability score does not satisfy a predetermined threshold, the present security management unit automatically deprives an authority to execute a query to a database. The present security management unit applies format-preserving encryption to a confidential field in the database. The present security management unit introduces a homomorphic encryption technology that enables data search and partial match collation while remaining in an encrypted state. When transmitting data to the terminal, the present security management unit adds intentional noise to the data using a differential privacy algorithm, and makes it mathematically difficult to specify an individual. This process is an improvement in computer technology that replaces a conventional security model depending on boundary defense with a data-centric dynamic and cryptographic protection mechanism. With this configuration, the present system brings about a technical effect of reducing a data leakage risk due to an internal crime or an advanced cyber attack to the utmost limit. The present system is applicable to a use case of utilizing AI while satisfying strict compliance requirements in a citizen consultation counter of a government agency handling extremely highly confidential personal information or a fraud investigation department of a credit card company.

The external cooperation unit cooperates with an external emotion recognition engine, a voice recognition engine, a CRM system, an FAQ database, a manual management system, a questionnaire system, a disaster information system, a legal database, and the like, and acquires and utilizes necessary information in real time. For example, in the case of a voice call, it is converted into text by a voice recognition engine, an emotion is determined by an emotion recognition engine, latest information of a customer is acquired from a CRM system, related information is extracted from an FAQ database, and a latest response procedure is acquired from a manual management system. When a disaster occurs, disaster area information is acquired from a disaster information system, and when a legal regulation is changed, latest information is acquired from a legal database to automatically generate a response text. Specifically, the present external cooperation unit functions as a gateway that asynchronously communicates with a plurality of external systems using an application programming interface. The present external cooperation unit integrates response data from each external system, and converts it into a normalized data object according to a common schema. The present external cooperation unit temporarily stores a text chunk received by streaming from the voice recognition engine in a buffer on a memory, and push-transmits it to the generative AI processing unit at a timing when a sentence break is detected. The present external cooperation unit parses data in a markup language format provided from the disaster information system, and extracts parameters such as an epicenter and a warning level. The present external cooperation unit vectorizes the extracted parameters, and executes a geospatial distance calculation with a residential area coordinate of the customer. The present external cooperation unit specifies a customer whose distance is within a certain range, and dynamically assigns a disaster influence flag to a session of the corresponding customer. The present external cooperation unit detects an update of the legal database via a webhook, automatically scrapes an updated article text, and reconstructs an index of a vector database. This process is an advanced system integration technology that absorbs a difference in data format between siloed heterogeneous systems and constructs a real-time data pipeline. With this configuration, the present system exhibits a technical effect of immediately adapting a behavior of the entire system to a rapid change in an external environment without waiting for a human data input operation. The present system is applied to a use case of taking in weather information of each country and a regulatory change of customs in real time and automatically updating a guide of a delivery delay in a customer center of a logistics company expanding globally.

Specific examples of prompt texts to be read into the generative AI when implementing the present invention include, for example, "Customer ID 12345 has made inquiries about delivery delays twice in the past, and an apology and a discount coupon were provided last time. The inquiry content this time is 'I am in trouble because the product has not arrived'. Generate an optimal apology text and solution based on the past response history and customer attributes", "Customer ID 67890 wishes to change a medical appointment and has diabetes in the medical history. Refer to the appointment history and the medical history, and generate an appropriate medical treatment guide and precautions", "Operator A is strong in the medical field and currently has a high stress level. The inquiry content is 'explanation of test results'. Consider the load on the operator and generate a concise and accurate explanation text", "Inquiries regarding a new service are rapidly increasing. Refer to an FAQ database and the past inquiry history, and automatically generate frequently asked questions and answers thereto", and "A communication failure has occurred, and it is necessary to perform a simultaneous notification to customers in a disaster-stricken area. Acquire the latest information from a disaster information system and generate an individual message". Specifically, the present system inputs the input prompt text into a large language model. The model tokenizes the input text. The model extracts a feature vector from a token sequence. The present system generates an optimal response text based on the extracted feature vector. The present system outputs the generated response text. This process improves the accuracy of response generation.

In this way, the system according to the present embodiment has the customer information management unit, the operator information management unit, the generative AI processing unit, a terminal interface unit, a feedback accumulation unit, a security management unit, and an external cooperation unit, and realizes an advanced contact center system in which each unit cooperates to grasp a context and an emotion for each customer in real time, automatically generate and present an optimal response policy, and continuously execute self-learning, self-correction, and environmental adaptation. The generative AI plays an indispensable role in all processes such as inquiry analysis, emotion recognition, response generation, self-learning, self-correction, environmental adaptation, operator education, trend analysis, FAQ automatic generation, manual automatic update, simultaneous notification in a disaster, and legal regulation change response, and enables highly accurate and flexible customer response that could not be realized by a conventional rule-based system. Specifically, the present system adopts an architecture that links a plurality of computing nodes in a distributed computing environment. The present system containerizes each management unit and processing unit as an independent microservice. The present system dynamically allocates computing resources according to a load of each module using a container orchestration tool. The generative AI processing unit is implemented with a large language model having a self-attention mechanism on a scale of tens of billions of parameters as a core. The generative AI processing unit tokenizes an input natural language text by a subword algorithm. The generative AI processing unit embeds a token sequence into a 1024-dimensional high-dimensional vector space. The generative AI processing unit calculates a context dependency using a multi-layer transformer encoder and decoder. Unlike conventional rule-based keyword matching, the present system quantifies semantic similarity by inner product calculation in a high-dimensional vector space. By this unconventional calculation method, the present system executes highly accurate analysis even for an inquiry including orthographical variants and a complex context. By this process, the present system eliminates a mental process in which a human operator manually searches and collates information. As a result, the present system dramatically improves a processing speed of inquiry response. The present system also supports an edge computing configuration that executes a lightweight inference model on a terminal side in order to reduce a communication load. The present system exhibits an extremely high technical effect in use cases requiring real-time performance, such as unauthorized use detection in the financial field and triage judgment in the medical field. In a self-learning process, the present system continuously updates a weight of the model using a cross-entropy error function. Thereby, the present system imparts an adaptive capability to environmental changes to the computer system itself. The present system expands the updated parameter on a memory and immediately reflects it in subsequent inference processing.

### IMPLEMENTATION STEPS

Step 1: Inquiry Reception and Customer Authentication When a customer makes an inquiry through various channels such as a chat, a voice call, an email, and a video call, the terminal interface unit receives an inquiry content and transmits a customer ID and authentication information to the server. For example, in the financial field, input of a date of birth and a registered telephone number is requested for identity verification, and in the medical field, authentication is performed by a patient registration card number and a date of birth. In the retail field, customer authentication is performed using a purchase history, a member number, and the like, and in the communication field, customer authentication is performed using a contract number, a telephone number, and the like. Specifically, the terminal interface unit receives input streams from a plurality of channels in parallel using an asynchronous communication protocol. The terminal interface unit converts received voice data into a digital signal in a pulse code modulation format with a sampling rate of 16 kHz. The terminal interface unit encodes text data as a byte sequence in a UTF-8 format. The terminal interface unit applies a preprocessing filter that removes a noise component from the received data. The terminal interface unit converts the preprocessed data into a 256-dimensional feature vector. The terminal interface unit generates an authentication token encrypted using the extracted feature vector and a secure hash algorithm. The terminal interface unit transmits this authentication token to the server via a secure socket layer. The server decrypts the received authentication token. The server collates it with a customer ID indexed on a distributed database at high speed. In this collation processing, the server executes a search using a B-tree algorithm. Thereby, the server specifies the corresponding customer from among millions of customer records in milliseconds. The present system minimizes a delay in authentication processing by this data structure and search algorithm optimized for hardware. As a result, the present system brings about a technical effect of improving a response speed of the entire system. The present system is applied to use cases requiring strict security, such as multi-factor authentication in the financial field and collation of biometric authentication data in the medical field. After the authentication is completed, the present system issues a trigger signal for shifting the processing to subsequent Step 2. The present system registers this trigger signal in a messaging queue and continues asynchronous processing.

Step 2: Extraction of Customer Information and Operator Information The customer information management unit on the server immediately extracts an inquiry history, attribute information, a past response result, a purchase history, a complaint history, a questionnaire result, a use channel, a contract content, a past satisfaction score, and the like of the authenticated customer, and at the same time, the operator information management unit extracts a skill set, an assignment history, a stress level, a handleable business range, an operation status, a break status, a past customer evaluation, an education history, qualification information, and the like of all operators. For example, a medical history and an appointment history are extracted in the medical field, a past transaction history and the presence or absence of unauthorized use are extracted in the financial field, a purchased product and a return history are extracted in the retail field, and a contract plan and a failure response history are extracted in the communication field. Specifically, the customer information management unit uses a hybrid storage architecture combining a relational database and an in-memory cache. The customer information management unit receives the trigger signal issued in Step 1. The customer information management unit extracts all related history data from the distributed database by a parallel query using the ID of the corresponding customer as a key. The customer information management unit normalizes the extracted text data, numerical data, and categorical data, respectively. The customer information management unit combines the normalized data to generate a 1024-dimensional multidimensional tensor representing a customer profile. At the same time, the operator information management unit acquires status information of all operating operators in real time. The operator information management unit digitizes a skill level of each operator as a continuous value from 0 to 1. The operator information management unit acquires the stress level as a time-series array calculated from heart rate variability data and the past number of responses. The operator information management unit integrates these pieces of information to generate a 512-dimensional state vector representing a state of each operator. The present system arranges the customer profile tensor and the operator state vector in a shared memory space. Thereby, the present system enables the subsequent generative AI processing unit to read data at high speed without going through disk IO. By this optimization of memory access, the present system exhibits a technical effect of dramatically reducing latency required for transition from data extraction to analysis. The present system provides an indispensable fundamental technology in use cases requiring instantaneous processing of a huge amount of data, such as real-time recommendation generation in the retail field and rapid personnel arrangement at the time of a large-scale failure in the communication field. The present system serializes the extracted tensor data in accordance with an input format of subsequent Step 3.

Step 3: Inquiry Analysis and Emotion Recognition by Generative AI The generative AI processing unit analyzes an inquiry content transmitted from the terminal interface unit in a natural language, and recognizes an emotion in an inquiry text with high accuracy. For example, in the case of voice input, it is converted into text by a voice recognition engine, and "anger", "confusion", "gratitude", "anxiety", and the like are determined by an emotion recognition engine. Specific examples of prompt texts to be read into the generative AI include "Customer ID 12345 has made inquiries about delivery delays twice in the past, and an apology and a discount coupon were provided last time. The inquiry content this time is 'I am in trouble because the product has not arrived'. Generate an optimal apology text and solution based on the past response history and customer attributes", "Customer ID 67890 wishes to change a medical appointment and has diabetes in the medical history. Refer to the appointment history and the medical history, and generate an appropriate medical treatment guide and precautions", and the like. Specifically, the generative AI processing unit drives a multimodal deep neural network in order to process the input inquiry text and voice feature amount. The generative AI processing unit converts the text data into an integer token ID array by a subword tokenizer. The generative AI processing unit converts the voice data into a two-dimensional image tensor composed of Mel-frequency cepstral coefficients. The generative AI processing unit executes a transformer encoder for text and a convolutional neural network for voice in parallel. The generative AI processing unit inputs 768-dimensional hidden state vectors output from both networks to a coupling layer. The generative AI processing unit applies a self-attention mechanism to the coupled vector to generate a multimodal feature vector. The generative AI processing unit inputs this feature vector to a fully connected layer for emotion classification. The generative AI processing unit applies a softmax function to output a probability distribution score from 0.0 to 1.0 for each emotion class such as "anger", "confusion", "gratitude", and "anxiety". For example, the generative AI processing unit outputs a probability score of 0.85 for the "confusion" class and a probability score of 0.12 for the "anger" class for a combination of the input text "I am in trouble because the product has not arrived" and a voice pitch indicating frustration. The generative AI processing unit determines the emotion class having the highest probability score as a final emotion label. By this non-linear calculation in a high-dimensional space, the present system realizes objective and highly accurate emotion recognition independent of human subjectivity. By this processing, the present system brings about a technical effect of extracting an implicit emotion that cannot be detected by conventional keyword matching. The present system writes the output emotion label and probability score into a memory as input parameters for subsequent optimal operator assignment processing and response generation processing. The present system is applied to use cases in which accurate grasping of an emotion is indispensable, such as early detection of a complaint in the financial field and triage according to an anxiety level of a patient in the medical field.

Step 4: Assignment of Optimal Operator The generative AI processing unit comprehensively judges an inquiry content and a customer attribute, a skill set and a stress level of an operator, an operation status, qualification information, and the like, and automatically assigns an optimal operator. For example, an operator having a medical skill is preferentially assigned to an inquiry requiring specialized knowledge in the medical field, and automatic adjustment is performed to reduce a load on an operator having a high stress level. Specifically, the generative AI processing unit receives the emotion label and the probability score output in Step 3, and the customer profile tensor generated in Step 2 as inputs. The generative AI processing unit executes a reinforcement learning-based routing algorithm. The generative AI processing unit acquires a state vector of each currently operating operator. The generative AI processing unit calculates a cosine similarity between a skill requested by the customer and a skill possessed by the operator. The generative AI processing unit incorporates a numerical value indicating the current stress level of the operator and a fatigue degree score based on a past assignment history into an objective function as a penalty term. The generative AI processing unit calculates an ID of an operator that maximizes this objective function. For example, for an inquiry requiring specialized knowledge in the medical field, the generative AI processing unit extracts an operator having a medical skill score of 0.9 or more and a current stress level score of 0.4 or less as a candidate. When a plurality of candidates exist, the generative AI processing unit compares numerical values indicating resolution times in past similar cases, and finally selects an operator having the shortest resolution time. By this multi-objective optimization algorithm, the present system simultaneously achieves processing efficiency of the entire system and load distribution of operators, rather than random assignment based merely on availability. By this calculation processing peculiar to a computer, the present system brings about technical effects of shortening a waiting time and equalizing response quality. The present system transmits the output ID of the optimal operator and a routing score to a session management module. The session management module dynamically establishes a communication path based on this ID, and shifts the processing to subsequent Step 5. The present system is applied to resource assignment use cases under complex constraint conditions, such as priority-based routing at the time of a large-scale failure in the communication field and assignment of a dedicated person in charge to a VIP customer in the retail field. The present system records an assignment result as a log, and utilizes it as relearning data for a future routing model.

Step 5: Automatic Generation of Response Policy and Response Text by Generative AI The generative AI processing unit integrally refers to information such as a past history and an attribute of a customer, an inquiry content, and a skill and a stress level of an operator, and automatically generates an optimal response policy, a response text, an additional proposal, precautions, an FAQ link, a related manual, and the like. For example, a specific instruction is generated such as "This customer has made similar inquiries three times in the past, and an apology and a discount coupon were provided for a delivery delay last time, so an additional apology and a detailed explanation of a delivery status are recommended this time". Specific examples of prompt texts to be read into the generative AI include "Customer ID 24680 has made returns twice in the past in the retail field. The inquiry this time is 'I want to return a product'. Refer to the past return history, and generate an optimal return procedure guide and precautions", "When a failure occurs in the communication field, it is necessary to perform a simultaneous notification to customers in a disaster-stricken area. Acquire the latest information from a disaster information system and generate an individual message", and the like. Specifically, the generative AI processing unit drives an autoregressive language generation model. The generative AI processing unit combines the customer profile tensor, the token array of the inquiry text, the extracted emotion label, and the skill information of the assigned operator to construct a context vector. The generative AI processing unit embeds this context vector into a prompt template to generate an input prompt to the model. In each layer of a transformer decoder, the generative AI processing unit calculates an appearance probability of a next token from past tokens using a masked self-attention mechanism. The generative AI processing unit applies a beam search algorithm to search for a token sequence having the highest product of probabilities, and generates a response text in a natural language. At the same time, the generative AI processing unit searches for a vector representation of a related document from an external FAQ database using an information retrieval-based generation method. The generative AI processing unit integrates the content of the searched document into a generation process to construct an accurate response policy based on facts. The generative AI processing unit generates a text character string of the response text, structured JSON data indicating a recommended response procedure, and a URL link group of related manuals as output data. For example, for an inquiry about a return procedure, the generative AI processing unit outputs structured data including a "return reception number", a "return address", and "precautions", and a text of an apology text that is close to the emotion of the customer. By this probabilistic generation process in a high-dimensional vector space, the present system synthesizes an optimal text by an unconventional method based on a statistical language model, rather than imitating a human thought process. Thereby, the present system exhibits a technical effect of eliminating a time for an operator to create a sentence from scratch and dramatically reducing latency of response generation. The present system transfers the generated output data to the terminal interface unit for display processing in subsequent Step 6. The present system is applied to use cases requiring accuracy and individualization, such as automatic generation of a complex contract explanation in the financial field and creation of a personalized medication instruction text in the medical field.

Step 6: Presentation of Proposal and Response Text to Operator Terminal and Execution of Response The response policy, the response text, the additional proposal, the precautions, the FAQ link, the related manual, and the like generated by the generative AI processing unit are presented to an operator terminal in real time, and an operator finely adjusts a response content by his/her own judgment as necessary while referring to the proposal of the AI, and responds to the customer by a chat, a voice, an email, or the like. For example, it is also possible to transmit the response text generated by the AI with one click, or to automatically respond by voice synthesis. Specifically, the terminal interface unit asynchronously receives the response text, the structured data, and the URL link group generated in Step 5 from the server. The terminal interface unit renders the received data on a designated widget on a graphical user interface. The terminal interface unit arranges the response text in an editable text box, and accepts a real-time correction by the operator. When detecting that the operator has pressed a one-click transmission button, the terminal interface unit packetizes a character string in the text box and transmits it to a customer terminal. When a voice synthesis function is enabled, the terminal interface unit activates a text-to-speech engine. The terminal interface unit converts the response text into a phoneme array, and generates a Mel spectrogram using a deep acoustic model. The terminal interface unit converts the Mel spectrogram into time-domain voice waveform data using a vocoder, and reproduces it via an audio output device. In this series of processing, the present system executes parallel calculation using a graphics processing unit, and suppresses delays in screen drawing and voice synthesis to the order of milliseconds. By this close cooperation between hardware and software, the present system brings about technical effects of reducing a physical operation load on the operator and preventing a human error. When the operator corrects the text, the present system extracts difference data thereof and records it in a log file. The present system utilizes this log data as feedback information in subsequent Step 7. The present system is applied to use cases integrating diverse communication channels, such as an automatic voice response of a routine failure guide in the communication field and a seamless handover between a chatbot and a human in the retail field. After the transmission is completed, the present system updates a session state and shifts to a next inquiry standby state.

Step 7: Feedback Collection and Accumulation After a customer response, diverse evaluation indexes such as a customer satisfaction score, a questionnaire result, feedback from an operator, an adoption rate of an AI proposal, a response speed, a complaint occurrence rate, and a re-inquiry rate are transmitted from the terminal interface unit to the feedback accumulation unit, and are accumulated and managed. For example, when a customer evaluates as "very satisfied" or when an operator feeds back that "the AI proposal was accurate", these pieces of information are recorded. Specifically, when detecting that a customer response session has ended, the terminal interface unit activates an evaluation data collection module. The terminal interface unit transmits a 5-level evaluation score input form to the customer terminal, and receives an input numerical value as a customer satisfaction score. The terminal interface unit acquires a binary value indicating whether or not the response text generated by the AI is adopted, and a character string representation of the corrected text on the operator terminal. The terminal interface unit measures an elapsed time from the start to the end of the session as numerical data in milliseconds, and records it as a response speed. The terminal interface unit formats these collected data into a structured JSON object linked with a session ID, a customer ID, and an operator ID. The terminal interface unit transmits this JSON object to the feedback accumulation unit via a secure communication channel. The feedback accumulation unit writes the received data into a time-series database. In writing processing, the feedback accumulation unit executes transaction control in order to guarantee data consistency. By this automated data collection mechanism, the present system eliminates data omission and inconsistency due to human manual input. By persisting a large amount of evaluation data in a structured format, the present system exhibits a technical effect of streamlining a relearning process of a subsequent machine learning model. The present system provides the accumulated data as an input data set for a self-learning algorithm in Step 8. The present system is applied to use cases requiring evidence preservation and quality management, such as a post-audit of a compliance violation in the financial field and continuous monitoring of response quality in the medical field. The present system automatically triggers a learning pipeline when a data accumulation amount exceeds a certain threshold value.

Step 8: Self-learning, self-correction, and environmental adaptation by generative AI. The generative AI processing unit analyzes an evaluation index, a new inquiry pattern, a change in the market environment, and the like obtained from the feedback accumulation unit, continuously executes self-learning, and optimizes a model parameter and a response generation algorithm. For example, when a satisfaction degree is low in a specific response pattern, a response text and a response procedure of the pattern are automatically corrected and improved, and a pattern with a high satisfaction degree is deployed to other operators. Specific examples of a prompt text to be read by the generative AI include "Analyze a customer satisfaction score and an adoption rate of an AI proposal for the past month, and correct a response text of a pattern with a low satisfaction degree", "Inquiries regarding a new service are rapidly increasing. Refer to an FAQ database and a past inquiry history, and automatically generate frequently asked questions and answers thereto", and the like. Specifically, the generative AI processing unit activates a self-learning pipeline triggered by a scheduled batch process or a specific data accumulation amount. The generative AI processing unit extracts a group of structured JSON objects for a certain past period from the feedback accumulation unit. The generative AI processing unit extracts data of a session in which the adoption rate of the AI proposal is below a threshold (for example, 0.5) or a session in which the customer satisfaction score is low from the extracted data. The generative AI processing unit constructs a pair of an input prompt in these failure cases and a correct text finally corrected and transmitted by the operator. The generative AI processing unit executes fine-tuning of a large language model using this pair data. The generative AI processing unit calculates a cross-entropy loss between the generated text and the correct text in a learning process. The generative AI processing unit minutely updates a weight parameter of a network using a backpropagation method. The generative AI processing unit applies a regularization method such as gradient clipping or dropout in order to prevent overfitting. After the learning is completed, the generative AI processing unit deploys the updated weight parameter on a memory as a new inference model. By this closed-loop machine learning process, the system realizes a non-conventional processing method in which the system itself autonomously improves performance without a human programmer manually rewriting a rule. By this self-correction function, the system dynamically adapts to an unknown inquiry pattern and a change in the market environment, and brings about a technical effect of preventing a long-term decrease in response accuracy. The system plays an extremely important role in a use case where environmental fluctuation is severe, such as responding to an unknown question at the time of a new product launch in the retail field and learning a new failure pattern in the communication field. The system executes an inference process of the next step 3 and subsequent steps using the updated model.

### SPECIFIC USE CASE

For example, in the communication field, when a customer makes an inquiry regarding an Internet connection failure via a chat channel, the terminal interface unit receives an inquiry content and transmits a customer ID and a contract number to the server. The customer information management unit immediately extracts a past failure inquiry history, a contract plan, a used terminal, a past satisfaction score, a failure occurrence area, a past complaint history, and the like of the corresponding customer. The operator information management unit extracts a skill set in the communication field, a failure response experience, a stress level, an operation status, a past customer evaluation, night response availability, and the like of all operators. The generative AI processing unit analyzes the received inquiry content in a natural language, and determines an emotion of the customer as "anger" or "confusion" from expressions such as "the Internet is not connected" and "I do not want to be made to say the same thing over and over again". The generative AI integrally refers to the past failure inquiry history and attribute of the customer, a current failure occurrence status, the skill and stress level of the operator, and the like, and automatically generates an optimal response policy and response text. For example, a specific instruction and response text are generated, such as "Currently, a failure is occurring in the XX area. The estimated restoration time is XX:XX. We apologize for the inconvenience. Since it took XX hours to restore during the previous failure, it is recommended to regularly guide the progress status this time." The response text generated by the AI, an explanation of the failure status, an FAQ link, a template for progress guidance, an apology text example, and the like are presented in real time on the operator terminal. The operator fine-tunes the response text as necessary while referring to the proposal of the AI, and provides guidance to the customer via chat. After the customer response, the customer satisfaction score and feedback from the operator are transmitted to the feedback accumulation unit, and the generative AI continuously executes self-learning using these pieces of information to optimize a failure response pattern and a response text. Specifically, the system comprises an external cooperation unit that works in conjunction with a monitoring system of a communication network. The terminal interface unit receives a chat message from the customer as an asynchronous text stream. The customer information management unit issues a query to a distributed database using the customer ID as a key, and generates a multidimensional customer profile tensor including the past failure inquiry history. The operator information management unit generates a state vector in which an expertise score in the communication field and the current number of response sessions of each operator are quantified. The generative AI processing unit inputs the received text stream to a natural language processing model, and generates an embedding vector representation of a word. The generative AI processing unit analyzes a context using a self-attention mechanism of a transformer architecture, and outputs a probability score of 0.92 for an "anger" class and a probability score of 0.85 for a "confusion" class from an emotion classification layer. The generative AI processing unit collates polygon data of the current failure occurrence area acquired from the external cooperation unit with coordinate data of a registered address of the customer by spatial calculation, and determines that the corresponding customer is under the influence of the failure. The generative AI processing unit integrates these input data groups to construct a context vector, and inputs the context vector to an autoregressive language model. The generative AI processing unit generates, as an output, a text character string including an apology text, an estimated restoration time, and a personalized progress guidance based on a past response history. In this series of processes, the system integrates information from a plurality of data sources in a high-dimensional space, and executes flexible text synthesis that is impossible with rule-based branching processing. Thereby, the system exhibits a technical effect of eliminating the time for the operator to transition through a plurality of system screens to collect information, and significantly shortening an average processing time. The system renders the generated text character string and a URL link of a related FAQ on a screen of the operator terminal in real time. The system uses the evaluation score collected after the end of the response for weighting a loss function, and updates a parameter of the next response generation model using a reinforcement learning algorithm. By this mechanism, the system is applied to a use case of preventing congestion of a call center when a large-scale communication failure occurs and minimizing customer dissatisfaction.

Specific examples of a prompt text to be read by the generative AI include "Customer ID 12345 has made failure inquiries three times in the past in the communication field. The inquiry content this time is 'the Internet is not connected'. Currently, a failure is occurring in the XX area, and the estimated restoration time is XX:XX. Generate an optimal apology text and progress guidance text based on a past failure response history and a customer attribute", "Operator A has abundant failure response experience in the communication field, but the latest number of responses is large and a stress level is high. The inquiry this time is related to a failure occurrence. Generate a concise and accurate explanation text in consideration of a load on the operator", and the like. Specifically, the generative AI processing unit executes a dynamic prompt engineering module. This module maps structured data extracted from a database to a prompt template in a text format interpretable by a natural language model. This module acquires the number of past inquiries of the customer as an integer value, acquires a name of the failure occurrence area as a character string, and converts the estimated restoration time from a timestamp format to a readable character string. This module inserts these variables into placeholders in the template to construct an input prompt character string. The generative AI processing unit converts the constructed input prompt character string into a token ID array of several hundred dimensions by a tokenizer. The generative AI processing unit supplies this token ID array to an input layer of a large language model. When the stress level of the operator is high, the generative AI processing unit adds metadata indicating a constraint condition of "generate a concise and accurate explanation text" in the prompt. Based on this metadata, the generative AI processing unit applies a loss function that penalizes a length of an output token in a decoder layer. Thereby, the generative AI processing unit suppresses a redundant expression and outputs a short text character string summarizing only main points. By this dynamic generation of the prompt and constrained decoding method, the system realizes a non-conventional processing method of forcing a computer to output an optimal output format according to a situation. By this process, the system brings about a technical effect of reducing a cognitive load on the operator and preventing overlooking of information and a transmission error. The system passes the output text character string to a subsequent display rendering process. The system functions extremely effectively in a high-stress use case where quick and accurate information transmission is required, such as not only a failure response in the communication field but also an inquiry response at the time of a sudden market change in the financial field. The system saves a history of the generated prompt and utilizes it as analysis data for future template optimization.

Also, in the medical field, when a patient desires to change a medical appointment, the terminal interface unit transmits an inquiry content and a patient registration card number to the server, and the customer information management unit extracts an appointment history, a medical history, allergy information, a past medical treatment content, a satisfaction score, and the like. The generative AI refers to the medical history and appointment history of the patient, and automatically generates an appropriate medical treatment guide and precautions using a prompt text such as "A patient with a medical history of diabetes desires to change an appointment. The current appointment is at XX:XX on XX/XX. Check availability, and guide a change of doctor if necessary." An appointment change guidance text, precautions, a proposal for a change of doctor, an FAQ link, and the like generated by the AI are presented on the operator terminal. The operator provides optimal guidance to the patient while referring to the proposal of the AI. Specifically, the system cooperates with a medical information system via a secure API. The terminal interface unit receives voice data including an appointment change request from the patient by streaming, and converts it into a text character string using a real-time voice recognition engine. The customer information management unit accesses an electronic medical record database using the patient registration card number as a key, and extracts a structured medical data record including the medical history, the allergy information, and a past prescription drug list. The generative AI processing unit inputs the extracted medical data record to a natural language processing model, and maps it to a concept vector using an ontology dictionary of medical terms. When detecting that "diabetes" is included in the medical history of the patient, the generative AI processing unit cooperates with a rule-based inference engine to set a constraint condition flag regarding dietary restrictions and timing of insulin administration. The generative AI processing unit integrates these constraint condition flags, a current appointment date and time, and calendar data indicating an available schedule of a doctor to generate a context vector. The generative AI processing unit inputs this context vector to a large language model, and generates, as an output, a list of alternative appointment date and time candidates, a text character string including precautions specific to a diabetic patient, and a reason for proposing a change of an attending doctor as necessary. In this process, the system solves an advanced scheduling problem considering a medical background of the patient on a multidimensional vector space, rather than a simple search for an available slot in a calendar. Thereby, the system exhibits a technical effect of reducing a risk of a medical malpractice and improving efficiency of an appointment change business while ensuring safety of the patient. The system displays the generated text character string and candidate list in a structured manner on a graphical user interface of the operator terminal. The system executes a transaction process of writing back a final appointment date and time selected by the operator to the electronic medical record database. The system is applied to a use case requiring medical expertise and complex adjustment, such as a remote medical consultation and schedule management of a regular medical examination for a patient with a chronic disease.

Furthermore, in the retail field, when a customer desires to return a product, the terminal interface unit transmits an inquiry content and a member number to the server, and the customer information management unit extracts a purchase history, a past return history, a complaint history, a satisfaction score, a use channel, and the like. The generative AI automatically generates a return procedure guidance text, precautions, an FAQ link, and a previous response content using a prompt text such as "Customer ID 24680 has returned products twice in the past in the retail field. The inquiry this time is 'I want to return a product'. Refer to a past return history, and generate an optimal return procedure guidance and precautions." A return guidance text and precautions generated by the AI are presented on the operator terminal, and the operator provides quick and accurate guidance to the customer. Specifically, the system synchronizes with an order management database of an e-commerce platform in real time. The terminal interface unit receives a chat message including a return request from the customer. The customer information management unit generates a multidimensional customer profile tensor including the past purchase history, the return history, and category information of the product using the member number as a key. The generative AI processing unit analyzes the input chat message with a natural language processing model, and outputs a probability distribution score for classifying a return reason (for example, "size mismatch", "initial defect", etc.). The generative AI processing unit detects from the customer profile tensor that the number of past returns exceeds a threshold (for example, twice). The generative AI processing unit integrates this detection result and the classified return reason into a context vector, and inputs the context vector to an autoregressive language model. The generative AI processing unit generates, as an output, a text character string of a specific return procedure based on a return policy, structured data of a return address, and precautions based on a past return tendency (for example, "do not cut a tag", etc.). In this process, the system executes a non-conventional processing method of analyzing a past behavior pattern of the customer on a vector space and dynamically synthesizing a guidance text optimized for an individual situation. Thereby, the system brings about a technical effect of eliminating the time for the operator to refer to a manual and check a return condition, and minimizing a waiting time of the customer. The system pop-up displays the generated guidance text and structured data on a screen of the operator terminal. After the operator transmits the guidance text, the system issues an API call that automatically updates a return reception status in the order management database. The system realizes extremely high business efficiency improvement in a use case in the retail field where a large amount of transactions and a quick response are required, such as frequent size exchange responses in the apparel industry and troubleshooting of an initial defect in a consumer electronics mass retailer. The system periodically exports statistical data of the return reason to a dashboard of a marketing department.

In this way, the system of the present invention comprehensively utilizes a history and attribute for each customer, an inquiry content, a skill and operation status of an operator, and the like in various industries such as the communication field, the medical field, the retail field, and the financial field, automatically generates an optimal response policy and response text using generative AI, and presents them to an operator terminal in real time, thereby simultaneously realizing customer satisfaction improvement, business efficiency improvement, and operator load reduction. Specific examples of a prompt text to be read by the generative AI include "Customer ID 13579 has made an inquiry about unauthorized use once in the past in the financial field. The inquiry this time is 'a card was used unauthorizedly'. Refer to a past response history and identity verification information, and generate an optimal identity verification procedure and compensation guidance text", "Inquiries regarding a new service are rapidly increasing. Refer to an FAQ database and a past inquiry history, and automatically generate frequently asked questions and answers thereto", and the like. Specifically, the system adopts an architecture in which a plurality of specialized large language models incorporating domain knowledge specialized for each industry are deployed in parallel. The system analyzes a vector representation of an input inquiry text with a clustering algorithm, and automatically classifies whether it belongs to a domain of communication, medical, retail, or finance. The system routes a process to a corresponding specialized model based on a classification result. When a model in the financial field is selected, the generative AI processing unit receives a past transaction history tensor of the customer and a current inquiry text as inputs. The generative AI processing unit extracts an embedding vector of a keyword "unauthorized use" from the text, and activates an anomaly detection algorithm. The generative AI processing unit generates, as an output, structured data indicating a procedure for suspending use of a credit card, a question list for identity verification, and a text character string of a compensation guidance text for reducing anxiety of the customer. The system also analyzes inquiry log data for a certain past period with a topic modeling algorithm in a batch process. When detecting that an appearance frequency of a specific keyword related to a new service is rapidly increasing, the system automatically generates a pair of a question and an answer related to the topic, and updates an index of the FAQ database. By this multi-domain compatible dynamic routing and autonomous knowledge base update mechanism, the system realizes a non-conventional processing method that simultaneously satisfies complex requirements of various industries with a single system. Thereby, the system exhibits a complex technical effect of improving a customer satisfaction degree and reducing a load on an operator in each industry while reducing an initial cost of system introduction. The system caches the generated prompt and response text on a memory, and further shortens a latency of a subsequent inference process for a similar inquiry. The system is applied to a large-scale use case requiring scalability and versatility, such as global customer support of a multinational corporation and an integrated contact center of a conglomerate corporation developing a plurality of businesses.

(Application Example 1) The flow of the specific processing in Application Example 1 will be described. Each part of the system described below is realized by the data processing device 12 and the smart device 14. Additionally, the data processing device 12 is referred to as a "server," and the smart device 14 is referred to as a "terminal."

### EMBODIMENT FOR CARRYING OUT THE PRESENT INVENTION

An embodiment of the present invention is a nursing care support system composed of a server and a plurality of terminals, and comprises a user information management unit, a staff information management unit, a generative AI processing unit, a family cooperation unit, a feedback accumulation unit, a security management unit, an external cooperation unit, and a terminal interface unit. The server bears core functions of the user information management unit, the staff information management unit, the generative AI processing unit, the feedback accumulation unit, the security management unit, and the external cooperation unit, and the terminal comprises a user interface operated by a nursing care staff member, a user, and a family member, and, if necessary, a lightweight AI inference module, a voice input device, a vital sensor cooperation function, and a notification function. Specifically, the nursing care support system adopts a distributed processing architecture constructed on a cloud computing environment. The server containerizes each management unit and processing unit as an independent microservice, and executes them on a container orchestration platform. Thereby, the server dynamically scales out a calculation resource according to a fluctuation in an access load. The terminal includes a tablet terminal arranged in a nursing care facility, a smartphone carried by a staff member, and an IoT device installed at a bedside of a user. The interface unit of the terminal comprises a directional microphone array as a voice input device, and executes digital signal processing for reducing environmental noise. As the vital sensor cooperation function, the terminal collects time-series numerical data such as a heart rate, a blood pressure, and a body temperature from a wearable device in real time using a low power consumption short-range wireless communication protocol. The terminal inputs the collected data to a local lightweight AI inference module, and executes a primary anomaly detection process using an edge computing technology. By this cooperative processing of an edge and a cloud, the system exhibits a technical effect of shortening a response delay to a highly urgent event to a millisecond order while saving a communication bandwidth to the server. When an anomaly is detected, the system draws a visual alert on a screen of a staff terminal using the notification function, and simultaneously drives a vibration motor to provide tactile feedback. By this hardware-level cooperation, the system realizes a non-conventional processing method of replacing a human monitoring business with constant monitoring by a computer and preventing an oversight. The system provides an extremely important foundation in a use case where it is necessary to ensure safety with limited personnel, such as a night monitoring business in a special nursing home for the elderly and remote monitoring in home nursing care. The system encrypts all the collected data and saves it in a secure storage area.

The user information management unit is realized on the server, and stores and manages a care history (e.g., bathing assistance, meal assistance, medication management, rehabilitation execution record, excretion assistance, night monitoring, fall history, emergency response history, bedsore care, oral care, outing support, hobby activity support, dementia care record), medical information (e.g., medical history, medication content, allergy information, attending physician information, vital data, test result, vaccination history, medical institution consultation history, medical treatment record), a lifestyle habit and preference (e.g., meal preference, wake-up/bedtime, hobby, family structure, religious consideration, bathing frequency, drinking/smoking habit, outing frequency), an emotion/physical condition change history (e.g., daily utterance and facial expression, sleep state, activity amount, complaint of pain and anxiety, mood change, smile frequency, rejection reaction, feeling of loneliness, motivation decrease), a family contact history (e.g., request from a family member, contact frequency, past report content, family meeting record, emergency contact, family nursing care participation history), and the like for each user on a long-term and multi-layered basis. For example, when a user utters "I have a headache today", a plurality of related data such as a past headache complaint, a medication history, vital data, a recent sleep state, a meal intake amount, a stress factor, and an atmospheric pressure change are immediately extracted and utilized for an appropriate response determination by AI. For example, when a user utters "I have no appetite recently", it is also possible to refer to a past meal intake amount, a weight change, a medication content, a bowel movement record, a blood glucose level transition, related medical information, and a request regarding a meal from a family member, and recommend contacting a dietitian or a doctor. For example, when a user utters "I cannot sleep at night", a past sleep record, a medication history, a daytime activity amount, a caffeine intake status, the number of night toilet visits, a noise level, a lighting environment, and a response history at the time of a past insomnia complaint are referred to, and "recommendation of consultation with a doctor", "report of a sleep status to a family member", "instruction to a staff member to strengthen night monitoring", and the like are automatically generated. Specifically, the user information management unit persists multi-layered information of a user as a network structure of nodes and edges using a graph database. The user information management unit defines each data point such as a care history, medical information, a lifestyle habit, and an emotion history as a node, and links their temporal and causal relationships as an edge. When receiving voice data of a user from a terminal, the user information management unit converts it into a text character string using a voice recognition engine. The user information management unit inputs this text character string to a natural language processing model, and extracts a semantic feature vector. The user information management unit inputs the extracted feature vector as a query to the graph database, and extracts a related past node group at high speed by a search algorithm. For example, in response to a text input of "I have a headache", the user information management unit extracts a text node of a past headache complaint, a latest blood pressure numerical data node, and a time-series data node of an atmospheric pressure change. The generative AI processing unit integrates data of the extracted node group to construct a multidimensional context tensor. The generative AI processing unit inputs this context tensor to a deep neural network, and outputs a probability score indicating a recommendation degree of each response action. The generative AI processing unit selects an action with the highest probability score (for example, "recommendation of consultation with a doctor"), and generates structured JSON data including an execution instruction thereof. By this data extraction using a graph structure and inference in a high-dimensional vector space, the system eliminates a mental process in which a human nursing care staff member makes a determination relying on memory or a paper record, and realizes decision-making based on objective and comprehensive data on a computer. Thereby, the system brings about a technical effect of preventing provision of incorrect care and reducing a health risk of a user. The system transmits the generated JSON data to a staff terminal for a subsequent notification process. The system functions extremely effectively in a use case in a nursing care site where complex factors are intertwined, such as wandering prediction of a dementia patient and early detection of an exacerbation sign of a chronic disease.

The staff information management unit centrally and multilaterally manages a skill set (e.g., bathing assistance, medication management, rehabilitation guidance, dementia care, medical care, emergency response, bedsore care, oral care, excretion care, recreation planning, family response, infection control measure), an assignment history (e.g., which user was assigned for what period, past response record, emergency response experience, family meeting participation history), a stress level (e.g., latest business volume, number of night shifts, feedback content, emotion analysis by AI, break acquisition status, business load index, heart rate variability data), shift information (e.g., day shift/night shift/holiday, sudden shift change history, requested holiday, overtime history), qualification information (e.g., certified care worker, nurse, dementia care specialist, completion of lifesaving course, completion of infection control training, recreation instructor), a past evaluation (e.g., evaluation from a user or a family member, evaluation from an administrator, response quality evaluation by AI), a business load (e.g., current number of assigned users, number of emergency cases being handled, load for each business type, number of sudden responses), an education history (e.g., attended training, OJT record, e-learning history, qualification acquisition progress), and the like for each nursing care staff member. For example, information such as staff member A is strong in dementia care, staff member B is capable of medical care, staff member C is a newcomer and has a high stress level, staff member D is dedicated to night shifts, and staff member E has expertise in infection control measures is grasped in real time, and utilized for business assignment, load adjustment, education plan formulation, and optimal personnel arrangement in an emergency. For example, in an emergency, a staff member capable of medical care can be preferentially assigned. For example, when a stress level of a staff member is high, an alert such as "recommendation of a break", "presentation of a business load reduction plan", and "recommendation of a mental health consultation" is automatically notified to an administrator terminal. Specifically, the staff information management unit manages attribute data of each staff member in a normalized table structure using a relational database. The staff information management unit expresses a skill set of each staff member as a multidimensional binary vector, and records an assignment history and a business load as a time-series numerical array. The staff information management unit continuously receives heart rate variability data from a wearable sensor of a staff terminal, and calculates a stress index numerical value indicating a balance between a sympathetic nerve and a parasympathetic nerve using a frequency analysis algorithm. The staff information management unit integrates these data, and updates a state vector representing a current state of each staff member in real time. When an emergency occurs,

the generative AI processing unit calculates a cosine similarity between a required skill vector and state vectors of all staff members. The generative AI processing unit extracts a staff member having a high similarity score and a current business load numerical value equal to or less than a threshold as an optimal candidate. The generative AI processing unit also calculates a moving average of the stress index numerical value of each staff member in a periodic batch process. When the moving average exceeds a prescribed safety threshold, the generative AI processing unit determines an abnormal state, and generates and transmits a text character string of a warning message and structured data including a recommended shift change plan to the administrator terminal. By this dynamic resource assignment and monitoring mechanism based on quantitative data, the system eliminates a conventional method depending on a subjective determination of an administrator. Thereby, the system exhibits a technical effect of preventing overwork of a staff member, reducing a turnover rate, and keeping care quality of the entire facility constant. The system holds the calculated state vector in a cache on a memory, and minimizes a latency of a subsequent task assignment process. The system is applied to a use case requiring dynamic resource management, such as complex shift creation in a large-scale nursing care facility and a sudden change in personnel arrangement accompanying zoning when an infectious disease occurs.

The generative AI processing unit is implemented on the server using generative AI as an essential element. The generative AI is configured by combining a plurality of AI technologies such as a natural language processing model, a large language model, an emotion recognition AI, a predictive modeling AI, a clustering AI, a vital data analysis AI, an image analysis AI, and a voice recognition AI. The generative AI multilaterally analyzes an utterance from a user, a diary record, vital data, a request from a family member, image data (e.g., a photograph of a bedsore, a photograph of a meal), voice data (e.g., an utterance content, a cough or a breathing sound), sensor information (e.g., a fall sensor, a bed leaving sensor, a door opening/closing sensor), and the like transmitted from the terminal, and recognizes a change in emotion and physical condition, an abnormal sign, a disturbance in a life rhythm, an environmental change, a change in a request from the family member, and the like with high accuracy. For example, when an utterance "my chest hurts a little today" is recorded, it is determined as "pain", and a plurality of care actions such as "contact a medical staff member and recommend a vital check", "automatically send a status report to the family member", and "propose a rest instruction and observation enhancement to the staff member" are automatically generated by comprehensively referring to a medical history, medication information, vital data, a response history at the time of a past chest pain complaint, a latest activity amount, a meal content, a stress factor, a temperature/atmospheric pressure change, and the like. For example, when an utterance "thank you, that was helpful" is made, it is recognized as "gratitude", and a positive report such as "today, the user expressed words of gratitude to the staff member" is automatically sent to the family member, and is also utilized for staff motivation improvement and as evaluation data. For example, when an utterance such as "anxious" or "scared" is recorded, "a contact to a psychological care staff member and a proposal of a reassuring greeting" is automatically generated, and a specific instruction such as "the user is feeling anxious, so please greet them gently and contact the psychological care staff member" is displayed on a staff terminal. For example, when image data of a bedsore is transmitted, the image analysis AI automatically determines a progression degree of the bedsore, and automatically generates "a recommendation of a report to a doctor", "a dressing change instruction", "a progress report to the family member", and the like. For example, when the fall sensor is activated, the AI analyzes a latest action history and an environmental factor, and immediately executes "a fall cause analysis", "a recurrence prevention measure proposal", "an automatic report to the family member, the doctor, and an administrator", and the like. Specifically, the generative AI processing unit adopts a multimodal transformer architecture that integrally processes text, voice, image, and sensor time-series data. The generative AI processing unit converts input voice waveform data into a spectrogram image tensor by Fourier transform, and extracts an acoustic feature vector using a convolutional neural network. At the same time, the generative AI processing unit inputs image data such as a bedsore into a deep image recognition model, and outputs a continuous value score from 0 to 1 indicating the progression degree of a lesion and a feature map tensor. The generative AI processing unit receives a binary signal from the bed leaving sensor or the fall sensor as a time-series event stream, and calculates a hidden state vector of an action pattern using a recurrent neural network. The generative AI processing unit fuses the feature vectors obtained from these different modalities into a single high-dimensional context vector using a cross-attention mechanism. The generative AI processing unit inputs this context vector into a decoder of an autoregressive language model, and generates an instruction text of a specific care action, a report text for the family member, and a specialized summary text for the medical staff member in parallel. For example, when receiving an activation signal of the fall sensor and a latest restless utterance text as inputs, the generative AI processing unit outputs a fall probability score of 0.98, immediately generates a command packet of "a rush instruction to the staff member", and transmits it via a network. The system realizes a non-conventional processing method of identifying a complex abnormal sign undetectable by a single sensor with high accuracy by this multimodal data fusion and non-linear calculation in a high-dimensional space. Thereby, the system brings about a technical effect of complementing a limit of human patrol monitoring and preventing an accident from becoming severe. The system transfers the generated text and command packet to a subsequent notification module and the family cooperation unit. The system plays an extremely important role in a use case of nursing care/medical cooperation requiring advanced situation recognition and immediate response, such as automation of night-time monitoring business and image diagnosis support by a specialist from a remote location.

The family cooperation unit multilaterally manages a contact address, a desired notification method (e.g., an email, an application notification, a telephone, a chat), a past contact history, a request content, feedback from a family member, a family meeting record, a nursing care participation history of the family member, a health state and a nursing care burden status of the family member, and the like for each family member, and automatically transmits a report text generated by the AI, an emergency contact, a daily care summary, a state change of the user, advice to the family member, a nursing care burden reduction measure, educational content for the family member, and the like to the family member. For example, when an emergency such as a physical condition change or a fall of the user occurs, a status report is immediately made to the family member. For example, "this week's physical condition/emotion change summary", "a meal intake transition", "a sleep status", "rehabilitation progress", "words of gratitude to the family member", and the like can be automatically generated on a weekly basis and transmitted to the family member. For example, if there is a request from the family member "want to know a recent physical condition change", a physical condition/emotion change summary for the past one week is automatically generated and transmitted to the family member. For example, when the nursing care burden of the family member is high, the AI automatically proposes "a nursing care leave acquisition recommendation", "a regional support service guide", "a stress care information provision for the family member", and the like. Specifically, the family cooperation unit asynchronously exchanges data with an external communication network using a messaging queue system. The family cooperation unit stores a notification setting profile for each family member as a JSON format document in a NoSQL database. The generative AI processing unit aggregates a vital data time-series array, numerical data of a meal intake, and history data of an emotion label of the user in a daily or weekly batch process. The generative AI processing unit inputs the aggregated data into a natural language generation model, and generates a summary text character string converted into a plain expression for the family member. At the same time, the generative AI processing unit analyzes a past request text from the family member using the natural language processing model, and calculates a weighting vector of a topic with a high degree of interest (for example, "meal", "rehabilitation", etc.). The generative AI processing unit dynamically optimizes information arrangement and an emphasized expression in the summary text based on this weighting vector. The family cooperation unit packages the generated summary text, image data of a smiling face of the user, and the like as a multipart format email payload or a push notification payload. The family cooperation unit transmits the packaged payload to an API endpoint specified in the notification setting profile using an HTTPS protocol. The system eliminates time for the nursing care staff member to manually fill in a contact book by completely automating the process from this data aggregation to text generation and distribution. Thereby, the system exhibits a technical effect of improving a communication frequency and quality with the family member while significantly reducing a business load on the staff member. When receiving a reply message from the family member, the system analyzes the text data, adds it to the database as a new request, and reflects it in the next generation process. The system is applied to a use case of smoothing information sharing among various stakeholders, such as a regular status report to a family member living far away and an immediate escalation in an emergency.

The feedback accumulation unit accumulates and manages various evaluation indexes such as feedback from the family member and the staff member, a physical condition/emotion change history of the user, a care execution result, an emergency response history, business load data, an adoption rate of an AI proposal, a response speed, a complaint occurrence rate, a re-response rate, a family satisfaction degree, a staff satisfaction degree, an administrator evaluation, and an external audit result, and the generative AI processing unit utilizes these data for self-learning, model optimization, care procedure improvement, education program optimization, business process improvement, risk management enhancement, and service quality improvement. For example, if there is a request from the family member such as "a recent report is easy to understand" or "want more detailed information", the AI automatically adjusts a report content and frequency. If there is feedback from the staff member such as "the AI proposal does not fit the site" or "the proposal was accurate", the AI automatically corrects a response generation algorithm and enhances site adaptability. For example, when the adoption rate of the AI proposal is low, the AI automatically performs a cause analysis and improves a proposal content, timing, and an expression method. For example, when the re-response rate is high, the AI analyzes a past response history and automatically generates a recurrence prevention measure. Specifically, the feedback accumulation unit integrally stores structured data and unstructured data using a distributed large-scale data warehouse. The terminal interface unit collects an evaluation score (for example, an integer value from 1 to 5) for the AI proposal input by the staff member and text data of a corrected care record, and transmits them to the feedback accumulation unit together with a time stamp. The generative AI processing unit periodically executes a reinforcement learning algorithm using the accumulated data set. The generative AI processing unit calculates a positive reward signal when the care action proposed by the AI is adopted and the vital data of the user thereafter is stabilized. The generative AI processing unit calculates a negative reward signal when the proposal is rejected or when a re-response occurs. The generative AI processing unit updates a weight parameter of a neural network by a policy gradient method using these reward signals. For example, when an adoption rate of a proposal of "provision of a warm drink" for an insomnia complaint in a specific time zone is low, the generative AI processing unit adjusts an output probability distribution for the context vector, and increases a probability score of another proposal such as "adjustment of an environmental sound" from the next time onward. The system executes a non-conventional processing method of realizing automatic acquisition of tacit knowledge at the site and environmental adaptation, which is impossible with a static rule-based system, by this self-optimization mechanism based on the reward. Thereby, the system brings about a technical effect that proposal accuracy improves as an operation period of the system becomes longer, and a quality of care is continuously improved. The system saves the updated model parameter in a version control system, and hot-deploys it to an inference server. The system exhibits an extremely high effect in a use case where continuous data accumulation creates value, such as initial operation optimization in a newly opened nursing care facility and learning of a physical condition change pattern of a user accompanying a seasonal variation. The system visualizes and provides a summary of a learning result on a dashboard of the administrator.

The security management unit multilaterally encrypts confidential data such as user information, a care history, medical information, family information, and staff information, and prevents unauthorized access and information leakage. For example, a communication path is protected using a post-quantum cryptography technology, access to personal information is restricted by finely setting an access authority, and a login history and an operation history are recorded as an audit log. It is possible to adopt a configuration in which only minimum necessary information is transmitted to the terminal side, and only a response policy and necessary history information are displayed in a form in which an individual cannot be identified. For example, privacy protection is thoroughly implemented such that a user name is anonymized and displayed on the staff terminal, and other user information is not displayed at all on a family terminal. Specifically, the security management unit utilizes a dedicated encryption processor operating in a distributed computing environment. The encryption processor applies an advanced encryption algorithm before converting input text data and image data into a high-dimensional numerical tensor. The system implements a post-quantum cryptography algorithm based on lattice cryptography. The security management unit allocates a dynamically generated 256-bit encryption key to each data record. The system securely stores the encryption key in a hardware security module. The security management unit receives an access request from the terminal. The security management unit verifies an authentication token included in the access request. The system executes a decryption process only when determining that the authentication token is valid. The security management unit expands the decrypted data in a secure area on a memory. The system completely erases the data on the memory immediately after data processing is completed. The security management unit records the audit log in a distributed ledger using a blockchain technology. The system makes falsification of the audit log mathematically impossible. The security management unit inputs data to be transmitted to the terminal into an anonymization processing module. The anonymization processing module extracts personal identification information in a text using a natural language processing model. The anonymization processing module replaces the extracted personal identification information with a dummy token. The system transmits only the anonymized text data via a network interface. The security management unit also applies a face recognition model to image data. The face recognition model outputs bounding box coordinates of a face region from an image tensor. The system applies a Gaussian blur process to the bounding box region. The system generates image data whose privacy is protected. These processes by the security management unit bring about a technical effect of reducing an information leakage risk to the utmost limit. The system is extremely useful in a use case requiring strict privacy protection, such as a medical institution and a nursing care facility. Unlike conventional simple password authentication and uniform encryption processing, the system realizes dynamic and multilayered security control according to a data content and an access authority. The system provides the highest level of security while optimizing consumption of a calculation resource.

The external cooperation unit multilaterally cooperates with an external medical database, an emotion recognition engine, a voice recognition engine, a psychological care support AI, a vital sensor device, a family contact system, a disaster information system, a community comprehensive support center, an administrative service, a nursing care insurance system, an external audit system, and the like, and acquires and utilizes necessary information in real time. For example, in the case of voice input, it is converted into text by the voice recognition engine, an emotion is determined by the emotion recognition engine, a latest treatment guideline and drug information are acquired from the medical database, real-time body temperature/blood pressure/pulse data are acquired from the vital sensor device, and they are reflected in a care proposal and a risk evaluation by the AI. For example, when a disaster occurs, disaster area information is acquired from the disaster information system, and a safety confirmation and an evacuation guide to the user and the family member are automatically generated. For example, by cooperating with the external audit system, a legal compliance status and a service quality are automatically evaluated, and an improvement proposal is presented to the administrator. Specifically, the external cooperation unit comprises a gateway module that integrally manages a plurality of application programming interfaces. The external cooperation unit transmits and receives a data packet to and from an external system using an asynchronous communication protocol. The system inputs the received data of various formats into a normalization processing module. The normalization processing module converts JSON format or XML format data into a unified multidimensional tensor format. When receiving voice data, the external cooperation unit converts the voice data into a mel-frequency cepstrum coefficient feature vector. The system inputs the feature vector into a convolutional neural network for voice recognition. The neural network outputs a probability distribution of a text token from a voice feature. The system extracts a text token sequence with the highest probability. The external cooperation unit inputs the extracted text data into a transformer model for emotion recognition. The transformer model analyzes a context of a text by a self-attention mechanism. The transformer model outputs a reliability score for an emotion category such as joy, anger, and sadness. The system specifies an emotion category whose reliability score exceeds a predetermined threshold. The external cooperation unit receives time-series numerical array data from the vital sensor device. The system inputs the numerical array data into a long short-term memory network. The long short-term memory network learns a fluctuation pattern of time-series data. The long short-term memory network outputs a prediction score of a future vital value and an abnormality occurrence probability. When the abnormality occurrence probability exceeds a threshold, the system immediately generates an alert signal. The external cooperation unit dynamically generates and transmits an SQL query to the external medical database. The system acquires the latest treatment guideline and contraindication information of a drug as structured data. The system integrates the acquired structured data into a knowledge graph. The system executes an inference process using the knowledge graph. These processes by the external cooperation unit bring about a technical effect of fusing data inside the system and latest external information in real time. The system is extremely useful in a use case such as a quick evacuation guidance at the time of a disaster and a care proposal based on latest medical knowledge. Unlike conventional data synchronization by batch processing, the system reflects external data in the system with a delay in milliseconds using a stream processing technology. The system dramatically improves real-time performance and accuracy of data processing.

The terminal interface unit operates on various terminals (a tablet, a smartphone, a voice input terminal, a wearable terminal, a PC, a dedicated notification terminal) used by the staff member, the user, and the family member, and provides various functions such as display of an AI proposal, editing of a response text, input of a care record, acquisition of vital data, transmission of image/voice data, confirmation of a report to the family member, input of feedback, browsing of an FAQ and a manual, taking of educational content, a one-touch report in an emergency, business progress management, and an alert notification. For example, a response text generated by the AI can be transmitted with one click on a chat screen, a response proposal can be displayed in real time by the AI during a voice call, and an FAQ and a manual can be automatically pop-up displayed. For example, by cooperating with a vital sensor, AI analysis and alert issuance are automatically performed when an abnormal value is detected. For example, the family member can confirm a latest status of the user with a smartphone, and can immediately receive a weekly summary and an emergency report generated by the AI. Specifically, the terminal interface unit establishes bidirectional communication between a front-end application and a back-end server. The terminal interface unit maintains a persistent connection using a WebSocket protocol. The system immediately distributes an inference result and alert information generated on the server side to the terminal as a push notification. The terminal interface unit comprises a rendering engine that dynamically optimizes a layout of a user interface according to a screen size and a resolution of the terminal. The terminal interface unit detects a touch operation and a voice input of a user via an event listener. The system inputs the input voice data into a local lightweight acoustic model. The acoustic model converts a voice waveform into a text stream in real time. The system transmits the converted text stream to the generative AI processing unit on the server side. The terminal interface unit displays a candidate of a response text received from the server on an overlay layer on a screen. The system determines the response text triggered by a click event when the user selects the response text. The terminal interface unit acquires three-dimensional motion vector data from an acceleration sensor and a gyro sensor built in the wearable terminal. The system divides the motion vector data by a certain time window, and generates a feature matrix. The system inputs the feature matrix into an inference module on an edge device. The inference module outputs a probability score of an abnormal operation such as a fall using a support vector machine algorithm. When the probability score exceeds a threshold, the system transmits an emergency report packet to the server. These processes by the terminal interface unit bring about a technical effect of reducing an operation load on the user and enabling intuitive and quick information input/output. The system is extremely useful in a use case such as a hands-free operation at a nursing care site and real-time status sharing with a family member in a remote location. Unlike a conventional interface based on a static screen transition, the system dynamically presents an inference result of the AI according to a context. The system dramatically improves interaction efficiency between a human and a computer.

As described above, the embodiment of the present invention realizes core functions of the user information management unit, the staff information management unit, the generative AI processing unit, the family cooperation unit, the feedback accumulation unit, the security management unit, and the external cooperation unit on the server side, and arranges a staff/user/family interface, a lightweight AI inference module as necessary, a vital sensor cooperation function, a voice input function, an image transmission function, and a notification function on the terminal side, thereby multilaterally grasping a physical condition/emotion change, a care history, a family request, a staff status, an environmental change, and external risk information for each user in real time, automatically generating and presenting an optimal care action, a report, staff support, family cooperation, risk management, education support, and business improvement, and realizing an advanced nursing care support system that continuously executes self-learning, self-correction, environmental adaptation, and quality improvement. The generative AI plays an indispensable role in all processes such as inquiry analysis, emotion recognition, response generation, self-learning, self-correction, environmental adaptation, family cooperation, staff education, trend analysis, care procedure automatic generation, simultaneous notification in an emergency, medical guideline automatic update, risk evaluation, external cooperation, and legal compliance support, and enables highly accurate and flexible operation of a nursing care site and multifaceted value creation that could not be realized by a conventional rule-based system. Specifically, the system adopts a microservice architecture constructed on a cloud computing environment. The system deploys each management unit and processing unit as an independent container. The system dynamically scales a calculation resource of each module using a container orchestration tool. The system allocates a parallel calculation cluster using a graphics processing unit to the generative AI processing unit. The system speeds up a matrix multiplication calculation in an inference process of a large language model. The system implements a neural network whose model size is compressed by quantization and pruning technologies as the lightweight AI inference module arranged on the terminal side. The system constructs a hybrid inference pipeline combining primary inference on an edge side and secondary inference on a cloud side. The system transmits only a feature vector extracted on the edge side to the cloud side. The system significantly reduces consumption of a network bandwidth. The system executes a reinforcement learning algorithm using history data saved in the feedback accumulation unit. The system defines a history of adoption/rejection of a user for a proposal of a care action as a reward signal. The system continuously updates a parameter of the generative AI using a policy gradient method. The system autonomously improves accuracy of a proposal over time. These processes by the system bring about a technical effect of minimizing a processing delay of the entire system and ensuring scalability and availability. The system is extremely useful in a use case such as a large-scale nursing care facility group and a wide-area community comprehensive care network. Unlike a conventional static rule-based system, the system dynamically adapts to an environmental change by a data-driven approach. The system provides an optimal solution to a complex problem at a nursing care site from a viewpoint of computer science.

### System Configuration

The system according to the present embodiment comprises a user information management unit, a staff information management unit, a generative AI processing unit, a family cooperation unit, a feedback accumulation unit, a security management unit, an external cooperation unit, and a terminal interface unit. The user information management unit multilaterally and long-termly stores and manages a care history, medical information, a lifestyle habit and a preference, an emotion/physical condition change history, a family contact history, and the like for each user, accumulates in detail a care history such as bathing assistance, meal assistance, medication management, a rehabilitation execution record, excretion assistance, night-time monitoring, a fall history, an emergency response history, bedsore care, oral care, outing support, hobby activity support, and a dementia care record, integrally manages medical information such as a medical history, a medication content, allergy information, attending physician information, vital data, a test result, a vaccination history, a medical institution consultation history, and a medical treatment record, records a lifestyle habit and a preference such as a meal preference, a wake-up/bedtime, a hobby, a family structure, a religious consideration, a bathing frequency, a drinking/smoking habit, and an outing frequency, manages an emotion/physical condition change history such as a daily utterance and facial expression, a sleep state, an activity amount, a complaint of pain and anxiety, a mood change, a smile frequency, a rejection reaction, a feeling of loneliness, and a motivation decline in chronological order, and comprehensively records a family contact history such as a request from a family member, a contact frequency, a past report content, a family meeting record, an emergency contact address, and a nursing care participation history of the family member. For example, when the user utters "my head hurts today", a plurality of related data such as a past headache complaint, a medication history, vital data, a recent sleep state, a meal intake, a stress factor, and an atmospheric pressure change are immediately extracted and provided to the generative AI processing unit. Specifically, the user information management unit constructs a hybrid data store combining a distributed relational database and a NoSQL database. The user information management unit stores a vital numerical value and a medication history, which are structured data, in a table of the relational database. The user information management unit stores an utterance text and a free description of a care record, which are unstructured data, in a document-oriented NoSQL database. The system assigns a time stamp and a user identifier to each data record. The system extracts a named entity from a free description text using a natural language processing model. The system vectorizes the extracted named entity, and indexes it in a vector database as coordinates on a high-dimensional vector space. The user information management unit receives text data "my head hurts today" from the terminal. The system converts the text data into a query vector. The system executes a cosine similarity calculation on the vector database. The system searches a past care history vector having a high similarity to the query vector at high speed. The system combines the searched past history data, a time-series array of vital data for the latest 24 hours, and numerical data of an atmospheric pressure acquired from an environmental sensor. The system formats the combined data as a multidimensional context tensor. The system transfers the context tensor to the generative AI processing unit. These processes by the user information management unit bring about a technical effect of efficiently accumulating an enormous amount of data of various formats and searching and extracting necessary information in milliseconds. The system is extremely useful in a use case such as provision of personalized care optimized for an individual user and quick information collection at the time of a sudden physical condition change. Unlike a conventional manual paper record and a simple electronic medical record search, the system realizes an advanced information search based on semantic similarity as an internal process of a computer. The system simultaneously achieves efficiency improvement of data management and accuracy improvement of information extraction.

The staff information management unit multilaterally and centrally manages a skill set, an assignment history, a stress level, shift information, qualification information, a past evaluation, a business load, an education history, and the like for each nursing care staff member, records in detail a skill set such as bathing assistance, medication management, rehabilitation guidance, dementia care, medical care, an emergency response, bedsore care, oral care, excretion care, recreation planning, family response, and an infectious disease countermeasure, manages an assignment history such as which user was assigned for what period, a past response record, an emergency response experience, and a family meeting participation history, calculates a stress level from a latest business amount, the number of night shifts, a feedback content, an emotion analysis by AI, a break acquisition status, a business load index, heart rate variability data, and the like, manages shift information such as a day shift/night shift/holiday, a sudden shift change history, a requested holiday, and an overtime history, records qualification information such as a certified care worker, a nurse, a dementia care specialist, completion of a lifesaving course, completion of an infectious disease countermeasure training, and a recreation instructor, accumulates a past evaluation such as an evaluation from a user and a family member, an evaluation from an administrator, and a response quality evaluation by AI, manages a business load such as the current number of assigned users, the number of emergency cases being handled, a load for each business type, and the number of sudden response cases, and records in detail an education history such as a taken training, an OJT record, an e-learning history, and qualification acquisition progress. For example, information such as staff member A is strong in dementia care, staff member B is capable of medical care, staff member C is a newcomer and has a high stress level, staff member D is dedicated to night shifts, and staff member E has specialized knowledge of an infectious disease countermeasure is grasped in real time, and is utilized for business assignment, load adjustment, education plan formulation, and optimal personnel arrangement in an emergency. Specifically, the staff information management unit generates a multidimensional profile vector integrating attribute information and dynamic state information of each staff member. The system converts a skill set and qualification information into a binary vector by one-hot encoding. The system inputs heart rate variability data and activity amount data acquired from a wearable device into a time-series analysis module. The time-series analysis module analyzes a frequency component of heart rate variability using fast Fourier transform. The system digitizes an index indicating an activity balance between a sympathetic nerve and a parasympathetic nerve. The system inputs the index, latest business amount data, the number of night shifts, and an emotion polarity score of past feedback into a multiple regression analysis model. The multiple regression analysis model outputs a stress level score as a continuous value from 0 to 100. The system dynamically reflects the calculated stress level score in the profile vector. The staff information management unit monitors shift information and the current number of assigned users in real time. The system executes an optimization algorithm when a business assignment request occurs. The system calculates a Euclidean distance between a requirement vector of a requested task and a profile vector of each staff member. The system extracts a staff member whose distance is minimum and whose stress level score is less than a predetermined threshold as an optimal candidate. The system transmits an identifier of the extracted staff member and a task content to a scheduling module. These processes by the staff information management unit bring about a technical effect of quantitatively evaluating an ability and a physical and mental state of a staff member and automating optimal resource allocation. The system is extremely useful in a use case such as complex shift creation in a large-scale facility and quick personnel arrangement in an emergency. Unlike conventional personnel arrangement depending on experience and intuition of an administrator, the system realizes scientific management based on objective data and a mathematical optimization method. The system contributes to prevention of staff turnover and maximization of business efficiency.

The generative AI processing unit is implemented on a server using generative AI as an essential element, and is configured by combining a plurality of AI technologies such as a natural language processing model, a large language model, an emotion recognition AI, a predictive modeling AI, a clustering AI, a vital data analysis AI, an image analysis AI, and a voice recognition AI. The generative AI processing unit multilaterally analyzes an utterance from a user, a diary record, vital data, a request from a family member, image data, voice data, sensor information, and the like transmitted from a terminal, recognizes a change in emotion and physical condition, an abnormal sign, a disturbance in life rhythm, an environmental change, a change in the request from the family member, and the like with high accuracy, determines "pain" when an utterance "my chest hurts a little today" is recorded, for example, and automatically generates a plurality of care actions such as "contact a medical staff member and recommend a vital check", "automatically send a status report to the family member", and "propose a rest instruction and observation enhancement to a staff member" by comprehensively referring to a medical history, medication information, vital data, a past response history when complaining of chest pain, a latest activity amount, a meal content, a stress factor, a temperature/atmospheric pressure change, and the like. For example, when an utterance "thank you, that helped" is made, it is recognized as "gratitude", a positive report such as "today, the user expressed words of gratitude to the staff member" is automatically sent to the family member, and it is also utilized for staff motivation improvement and as evaluation data. For example, when an utterance such as "anxious" or "scared" is recorded, "a contact to a psychological care staff member and a proposal of a reassuring greeting" is automatically generated, and a specific instruction such as "because the user is feeling anxious, please greet them gently and contact the psychological care staff member" is displayed on a staff terminal. For example, when image data of a bedsore is transmitted, the image analysis AI automatically determines a progression degree of the bedsore, and automatically generates "a recommendation of a report to a doctor", "a dressing change instruction", "a progress report to the family member", and the like. For example, when a fall sensor is activated, the AI analyzes a latest action history and an environmental factor, and immediately executes "a fall cause analysis", "a recurrence prevention measure proposal", "an automatic report to the family member, the doctor, and an administrator", and the like. Specific examples of a prompt text to be read by the generative AI include "User ID U001 has a medical history of high blood pressure and is taking an antihypertensive drug. Today's utterance is 'my chest hurts a little today'. Refer to a past care history and medical information, and generate a necessary care action and a report text to the family member", "User ID U002 recently uttered 'anxious'. Refer to a past emotion change history and a care record, and generate a contact to the psychological care staff member and a reassuring greeting example", "Staff ID S001 has a high stress level. Refer to a past business record and feedback, and generate an alert text to the administrator and a business load reduction plan", "Analyze bedsore image data, and generate a progression degree determination and a response proposal", and "Analyze an action history and an environmental factor when the fall sensor is activated, and generate a fall cause analysis and a recurrence prevention measure". Specifically, the generative AI processing unit adopts an ensemble learning architecture integrating a plurality of neural network models. The system converts input text data into an array of subword tokens using a tokenizer. The system inputs the token array into a large language model having billions of parameters. The large language model calculates a long- range dependency relationship between tokens using a self-attention mechanism of a transformer architecture. When receiving image data, the system resizes and normalizes the image, and converts it into a three-dimensional image tensor. The system inputs the image tensor into a convolutional neural network. The convolutional neural network extracts a feature map of the image through a plurality of convolutional layers and pooling layers. When the image tensor of the bedsore is input, the system outputs pixel-level mask data of an affected area using a segmentation model. The system inputs the mask data and the feature map into a fully connected layer, and outputs a probability distribution of stage classification indicating the progression degree of the bedsore. The system specifies a stage label with the highest probability. The system inputs the specified stage label, a time-series prediction score of the vital data, and an emotion label obtained from text analysis into an integration module. The integration module combines these multimodal data and embeds them into a placeholder of a prompt template. The system re-inputs the constructed prompt character string into the large language model. The large language model autoregressively predicts a next token, and outputs a specific care action instruction text and a report text for the family member as a text stream. The system inputs the output text stream into a parser, and converts it into structured data in an executable command format. The system transfers the structured data to a subsequent notification module and database update module. These processes by the generative AI processing unit bring about a technical effect of integrally interpreting diverse input modalities and autonomously generating an optimal action plan according to a situation. The system is extremely useful in use cases such as judgment support for medical care and business load reduction for staff members. Unlike a conventional single rule-based determination, the system executes advanced inference combining complex pattern recognition in a high-dimensional space and context understanding. The system completes data processing with a speed and comprehensiveness that surpass a human cognitive process while imitating it.

The family cooperation unit multilaterally manages a contact address, a desired notification method, a past contact history, a request content, feedback from a family member, a family meeting record, a care participation history of the family member, a health condition and a care burden status of the family member, and the like for each family member, and automatically transmits a report text generated by the AI, an emergency contact, a daily care summary, a state change of the user, advice to the family member, a care burden reduction measure, educational content for the family member, and the like to the family member. For example, when an emergency such as a physical condition change or a fall of the user occurs, a status report is immediately made to the family member. For example, "this week's physical condition/emotion change summary", "meal intake transition", "sleep status", "rehabilitation progress", "words of gratitude to the family member", and the like can be automatically generated on a weekly basis and transmitted to the family member. For example, if there is a request from the family member such as "I want to know recent physical condition changes", a physical condition/emotion change summary for the past week is automatically generated and transmitted to the family member. For example, when the care burden of the family member is high, the AI automatically proposes "a care leave acquisition recommendation", "a regional support service guide", "stress care information provision for the family member", and the like. Specifically, the family cooperation unit manages a dedicated database table storing profile information and communication settings of the family member. The family cooperation unit receives the structured data output from the generative AI processing unit. The system evaluates an importance score of a message included in the structured data. When the importance score is an emergency message exceeding a predetermined threshold, the system routes the message to an immediate transmission queue. The system transmits the message to a mobile terminal of the family member with a delay in milliseconds using a short message service or a push notification protocol. When the importance score is a periodic report message equal to or less than the threshold, the system stores the message in a batch processing queue. The system inputs the accumulated data into an aggregation module according to a specified schedule. The aggregation module calculates an average value, a variance, and a slope of a trend line of the vital data for the past week. The system inputs the calculated statistics and time-series transition data of emotion analysis into a natural language generation model. The natural language generation model converts the statistical data into a summary text that is easy for a human to understand. The system dynamically generates a report in an HTML format by combining the summary text and image data generated by a graph drawing library. The system transmits the generated report to the family member via an email protocol. The family cooperation unit collects an access log from a family terminal and open rate data of the message. The system inputs the data into a machine learning model, and predicts an optimal notification timing and information granularity for each family member. The system automatically updates a notification setting parameter based on a prediction result. These processes by the family cooperation unit bring about a technical effect of realizing selection of an optimal communication path according to the importance of information and personalized information provision based on data. The system is extremely useful in use cases such as anxiety reduction of the family member and facilitation of communication between a facility and the family member. Unlike conventional uniform fixed-phrase transmission, the system automatically generates rich content in line with an individual situation by combining dynamic data aggregation and natural language generation technology. The system achieves both optimization of communication resources and improvement of user experience.

The feedback accumulation unit accumulates and manages diverse evaluation indexes such as feedback from the family member and the staff member, a physical condition/emotion change history of the user, a care execution result, an emergency response history, business load data, an adoption rate of an AI proposal, a response speed, a complaint occurrence rate, a re-response rate, a family satisfaction degree, a staff satisfaction degree, an administrator evaluation, and an external audit result, and the generative AI processing unit utilizes these data for self-learning, model optimization, care procedure improvement, educational program optimization, business process improvement, risk management enhancement, and service quality improvement. For example, if there is a request from the family member such as "recent reports are easy to understand" or "I want more detailed information", the AI automatically adjusts a report content and frequency. If there is feedback from the staff member such as "the AI proposal does not fit the site" or "the proposal was accurate", the AI automatically corrects a response generation algorithm and enhances site adaptability. For example, when the adoption rate of the AI proposal is low, the AI automatically performs a cause analysis, and improves a proposal content, a timing, and an expression method. For example, when the re-response rate is high, the AI analyzes a past response history, and automatically generates a recurrence prevention measure. Specifically, the feedback accumulation unit functions as a data lake constructed on a distributed file system. The feedback accumulation unit collects an operation log such as a screen scroll amount, a stay time, and a click history, which are implicit feedback data, in addition to an explicit evaluation score and a free description text transmitted from the terminal. The system inputs the collected raw data into a data cleansing module. The data cleansing module executes removal of noise data and complementation processing of a missing value. The system inputs the cleansed data into a feature engineering pipeline. The pipeline calculates an emotion polarity score from the feedback text, and extracts adoption/non-adoption of the AI proposal as a binary label. The system constructs a pair of these feature amounts and labels as a learning dataset. The system periodically executes a fine-tuning process for a neural network model of the generative AI processing unit using the learning dataset. The system updates a weight parameter of the model using a backpropagation method. The system calculates a cross-entropy error or a mean square error as a loss function, and minimizes a loss by a gradient descent method. The system introduces a framework of reinforcement learning, and defines the adoption rate of the AI proposal as a reward function. The system optimizes a response generation policy so as to obtain a higher reward using a proximal policy optimization algorithm. The system evaluates performance of the updated model with a verification dataset. The system seamlessly rolls out the model in a production environment only when performance improvement is confirmed. These processes by the feedback accumulation unit bring about a technical effect of continuously and autonomously improving inference accuracy of the system. The system is extremely useful in use cases such as construction of a self-evolving system that adapts to site needs as an operation period becomes longer. Unlike conventional manual rule update and parameter adjustment, the system automates a data-driven machine learning pipeline. The system prevents obsolescence of the model and always maintains optimal performance.

The security management unit multilaterally encrypts confidential data such as user information, a care history, medical information, family information, and staff information, and prevents unauthorized access and information leakage. For example, a communication path is protected using post-quantum cryptography technology, access to personal information is restricted by finely setting an access authority, and a login history and an operation history are recorded as an audit log. It is possible to adopt a configuration in which only minimum necessary information is transmitted to a terminal side, and only a response policy and necessary history information are displayed in a form in which an individual cannot be identified. For example, privacy protection is thoroughly implemented, such as displaying a user name anonymously on the staff terminal and not displaying other user information at all on the family terminal. Specifically, the security management unit implements an authentication and authorization control mechanism based on a zero trust architecture. The system requires strict identity verification for all requests even if it is an access from inside a network boundary. The security management unit issues a unique digital certificate to each terminal and user using a public key infrastructure. The system establishes an end-to-end encrypted communication channel using a latest version of a transport layer security protocol. The system applies transparent data encryption using an advanced encryption standard algorithm to data stored in a database. The security management unit adopts an attribute-based access control model. The system inputs an attribute vector such as a job title, an affiliated department, current position information, and an access time of the user into an evaluation engine. The evaluation engine dynamically determines whether or not to permit access using a logical operation. The system applies a data masking processing module to a data payload to be transmitted to the terminal. The data masking processing module detects a pattern such as a telephone number or a social security number in text data using regular expression matching. The system replaces the detected character string with an irreversible character such as an asterisk. For image data, the system executes an anonymization process of replacing a face region with a synthesized fictitious face image using a generative adversarial network. The security management unit records all access attempts and data operation events in a tamper detection log having a hash chain structure. These processes by the security management unit bring about a technical effect of dramatically improving system resistance against an internal crime and an external cyber attack. The system is extremely useful in use cases where it is necessary to satisfy strict compliance requirements such as a medical information protection law. Unlike a conventional boundary defense type security model, the system realizes data-centric multi-layer defense as an internal process of a computer. The system ensures the highest level of confidentiality and integrity without impairing convenience.

The external cooperation unit multilaterally cooperates with an external medical database, an emotion recognition engine, a voice recognition engine, a psychological care support AI, a vital sensor device, a family contact system, a disaster information system, a community comprehensive support center, an administrative service, a nursing care insurance system, an external audit system, and the like, and acquires and utilizes necessary information in real time. For example, in the case of voice input, it is converted into text by the voice recognition engine, an emotion is determined by the emotion recognition engine, a latest treatment guideline and drug information are acquired from the medical database, real-time body temperature, blood pressure, and pulse data are acquired from the vital sensor device, and they are reflected in a care proposal and a risk evaluation by the AI. For example, when a disaster occurs, disaster-stricken area information is acquired from the disaster information system, and a safety confirmation and an evacuation guide to the user and the family member are automatically generated. For example, by cooperating with the external audit system, a legal compliance status and service quality are automatically evaluated, and an improvement proposal is presented to the administrator. Specifically, the external cooperation unit adopts a service mesh architecture that mediates communication between microservices. The external cooperation unit executes an asynchronous remote procedure call to an external application programming interface using a RESTful protocol or a gRPC protocol. The system implements a circuit breaker pattern and an exponential backoff algorithm in order to cope with a response delay or a temporary failure from an external system. The system continuously transmits PCM format voice stream data in chunk units to the external voice recognition engine. The system receives a pair of a text token and a time stamp returned from the voice recognition engine. The system transfers the text data to the external emotion recognition engine. The emotion recognition engine outputs an emotion polarity of the text as a multidimensional vector. The external cooperation unit receives a sensor data packet from the vital sensor device via a Bluetooth Low Energy protocol. The system decodes a payload in the packet, and extracts a numerical value of body temperature or blood pressure as floating-point data. The system writes the extracted numerical value into a time-series database. The external cooperation unit receives a JSON payload of an emergency alert from the disaster information system via a Webhook. The system calculates a Haversine distance between latitude/longitude coordinates in the payload and coordinate data of a facility registered in the system. When the calculated distance is within a predetermined radius, the system determines that a disaster risk is high. The system queues a generation task of the evacuation guide to the generative AI processing unit using the determination result as a trigger. These processes by the external cooperation unit bring about a technical effect of eliminating a data silo between distributed heterogeneous systems and constructing an integrated data processing pipeline. The system is extremely useful in use cases such as rapid decision-making support in an emergency and automatic incorporation of latest medical knowledge. Unlike conventional manual data transcription and batch cooperation, the system realizes real-time inter-system cooperation by an event-driven architecture. The system maximizes freshness and accuracy of data.

The terminal interface unit operates on diverse terminals used by the staff member, the user, and the family member, and provides diverse functions such as display of an AI proposal, editing of a response text, input of a care record, acquisition of vital data, transmission of image/voice data, confirmation of a report to the family member, feedback input, browsing of an FAQ and a manual, taking of educational content, one-touch reporting in an emergency, business progress management, and an alert notification. For example, a response text generated by the AI on a chat screen can be transmitted with one click, a response proposal can be displayed in real time by the AI during a voice call, and an FAQ and a manual can be automatically pop-up displayed. For example, by cooperating with the vital sensor, AI analysis and alert issuance are automatically performed when an abnormal value is detected. For example, the family member can confirm a latest status of the user with a smartphone, and can immediately receive a weekly summary and an emergency report generated by the AI. Specifically, the terminal interface unit provides a dynamic user interface constructed using a single-page application framework. The terminal interface unit minimizes screen redrawing processing and optimizes rendering performance using a virtual DOM technology. The system receives inference result data in a JSON format push-distributed from the server. The system stores the received data in a local state management store. The terminal interface unit detects an update of the state management store, and asynchronously updates only a related UI component. In a voice call function, the system establishes a peer-to-peer media stream using a WebRTC protocol. The system separates a voice track from the media stream, and extracts voice waveform data using a WebAudioAPI operating in a background thread. The system transmits the extracted voice waveform data to the server at regular intervals. The system superimposes and displays a real-time response proposal text returned from the server on a floating window on a call screen. The terminal interface unit accesses a camera module of the terminal and acquires image data. Before transmitting the image data, the system executes image resizing and JPEG compression processing using a GPU on the terminal side. The system realizes high-speed data transfer while suppressing consumption of a network bandwidth. The terminal interface unit temporarily buffers time-series data acquired from the vital sensor in a memory on the terminal. The system applies a moving average filter to the buffered data to remove noise. When the filtered data exceeds a threshold, the system controls a vibration motor and an LED indicator of the terminal to generate a physical alert. These processes by the terminal interface unit bring about a technical effect of minimizing an influence of a network delay and providing a seamless and highly responsive operation experience to the user. The system is extremely useful in use cases such as rapid information input at a busy nursing care site and reliable notification reception in an emergency. Unlike a conventional thin client type interface, the system realizes a rich client architecture that actively utilizes a computational resource on an edge side. The system distributes a load on the server and improves processing efficiency of the entire system.

As described above, the system according to the present embodiment has the user information management unit, the staff information management unit, the generative AI processing unit, the family cooperation unit, the feedback accumulation unit, the security management unit, the external cooperation unit, and the terminal interface unit, and realizes an advanced nursing care support system in which each unit cooperates to multilaterally grasp a physical condition/emotion change, a care history, a family request, a staff status, an environmental change, and external risk information for each user in real time, automatically generates and presents an optimal care action, a report, staff support, family cooperation, risk management, educational support, and business improvement, and continuously executes self-learning, self-correction, environmental adaptation, and quality improvement. The generative AI plays an indispensable role in all processes such as inquiry analysis, emotion recognition, response generation, self-learning, self-correction, environmental adaptation, family cooperation, staff education, trend analysis, care procedure automatic generation, simultaneous notification in an emergency, medical guideline automatic update, risk evaluation, external cooperation, and legal compliance support, and enables highly accurate and flexible operation of a nursing care site and multifaceted value creation that could not be realized by a conventional rule-based system. Specifically, the system adopts an architecture that loosely couples and cooperates between respective functional modules via an event-driven message broker. The system asynchronously distributes a state change event generated in a certain module to all other interested modules using a publish-subscribe model. The system realizes high throughput for processing tens of thousands of transactions per second without delay by this event streaming infrastructure. The system positions the generative AI processing unit as a central inference engine of the system. The system aggregates multidimensional context vectors collected from each management unit into an input layer of the generative AI processing unit. The system probabilistically generates an optimal action sequence for a complex situation through an autoregressive decoding process of the large language model. The system inputs the generated action sequence into an evaluation function, and performs scoring from a viewpoint of safety and legal compliance. When a score does not satisfy a standard, the system runs a self-correction loop that dynamically corrects a prompt and executes re-inference. The system executes a continuous learning pipeline combining offline batch learning and online sequential learning using log data accumulated in the feedback accumulation unit. The system adaptively updates a weight parameter of a model for a new unknown situation or environmental change. These processes by the system bring about a technical effect that the entire system functions not merely as a data input/output device but as an intelligent agent that autonomously thinks and evolves. The system is extremely useful in a use case of simultaneously achieving business automation and care quality standardization in a nursing care industry where a labor shortage is becoming serious. Unlike a conventional system depending on a predefined static conditional branch, the system fundamentally differs and realizes advanced information processing based on probabilistic inference in a high-dimensional space and dynamic parameter update. The system expands an application range of computer technology itself and contributes to solving a complex real-world problem.

### IMPLEMENTATION STEPS

Step 1: Registration and Update of User/Family/Staff Information

The user information management unit multilaterally and long-termly stores and manages a care history, medical information, a lifestyle habit and a preference, an emotion/physical condition change history, a family contact history, and the like for each user, the staff information management unit centrally manages a skill set, an assignment history, a stress level, shift information, qualification information, a past evaluation, a business load, an education history, and the like for each nursing care staff member, the family cooperation unit manages a contact address, a desired notification method, a request content, feedback, a family meeting record, and the like for each family member, and these pieces of information are registered and updated at any time through the terminal interface unit. For example, all information is reflected in real time when the user declares a new allergy, when the staff member acquires a new qualification, when the family member changes a notification method, and the like. Specifically, the system receives an HTTP POST request or PUT request transmitted from the terminal interface unit. The system parses registration data in a JSON format included in a payload of the request. The system executes a schema verification module of input data, and checks a data type, a lack of an essential item, and a format error of a character string. The system transfers data that has passed verification to a database engine of each management unit. The system starts transaction processing in a relational database. The system atomically executes insert processing or update processing for a plurality of tables while guaranteeing ACID properties. When new allergy information is input, the system inputs the text data into a natural language processing model. The natural language processing model refers to a medical ontology dictionary, and extracts a standardized identification code of an allergy-causing substance. The system saves the extracted identification code as a foreign key of a medical information table. When qualification information of the staff member is updated, the system recalculates a profile vector of the staff member. The system overwrites and saves the updated profile vector in a cache area of an in-memory database. When the notification method of the family member is changed, the system dynamically rewrites a flag of a communication routing table. The system publishes a change notification event to a message broker immediately after database update processing is completed. These processes by the system bring about a technical effect of maintaining data consistency and freshness in the entire distributed system in milliseconds. The system is extremely useful in a highly concurrent use case where a plurality of staff members update information simultaneously. Unlike conventional manual batch synchronization and file sharing, the system realizes real-time state synchronization as an internal process of a computer by an event-driven architecture. The system mathematically eliminates data conflict and inconsistency.

Step 2: Input of Daily Care Record, Utterance, Vital, Image, Voice, and Sensor Information

Through the terminal interface unit, the staff member and the user input and transmit diverse information such as a daily care record (e.g., bathing assistance, medication management, meal intake, excretion status, rehabilitation content), an utterance content (e.g., "my head hurts today", "thank you"), vital data (e.g., body temperature, blood pressure, pulse, blood oxygen), image data (e.g., a photograph of a bedsore site, a photograph of a meal), voice data (e.g., an utterance, a cough, a breathing sound), and sensor information (e.g., a fall sensor, a bed leaving sensor, a door opening/closing sensor). For example, the staff member inputs a care record with a tablet, the user records an utterance with a voice input terminal, and the vital sensor automatically transmits data. Specifically, the system activates a dedicated data collection pipeline that processes diverse input modalities in the terminal interface unit. The system receives a care record in a text format input from a tablet terminal, and normalizes a character code to UTF-8. The system converts an analog voice signal acquired from a microphone array of the voice input terminal into digital voice waveform data with a sampling rate of 16 kHz using an analog-to-digital converter. The system applies a noise canceling algorithm to the voice waveform data to attenuate background noise. The system continuously receives a floating-point numerical array with a time stamp from the vital sensor via a serial communication interface. The system expands RGB image data acquired from a camera module on a memory as a tensor of pixel values. The system applies an affine transformation to the image tensor to correct an inclination and a size of an image to a standard format. The system detects an interrupt signal of a binary state transmitted from the bed leaving sensor or the door opening/closing sensor with an edge gateway device. The system encapsulates these heterogeneous format data into an integrated data packet having a common metadata header. The system transfers the integrated data packet to a reception buffer on a server side using a secure communication protocol. These processes by the system bring about a technical effect of efficiently collecting unstructured data and structured data in a unified format. The system is extremely useful in use cases such as automation of multimodal information collection at a nursing care site and integrated management of a sensor network. Unlike conventional manual data transcription and individual system input, the system seamlessly links signal processing at a hardware level and data integration at a software level. The system minimizes a data input load and prevents information omission.

Step 3: Multilateral analysis, emotion recognition, and abnormal sign detection by generative AI. The generative AI processing unit multilaterally analyzes an utterance, a care record, vital data, image/voice/sensor information, a request from a family member, and the like transmitted from the terminal, and recognizes a change in emotion and physical condition of the user, an abnormal sign, a disturbance of a life rhythm, an environmental change, a change in the request from the family member, and the like with high accuracy. For example, when an utterance "my chest hurts a little today" is recorded, it is determined as "pain", and a plurality of care actions such as "contact a medical staff member and recommend a vital check", "automatically transmit a status report to the family member", and "propose a rest instruction and observation enhancement to the staff member" are automatically generated by comprehensively referring to a medical history, medication information, vital data, a response history at the time of a past chest pain complaint, a latest activity amount, a meal content, a stress factor, a temperature/atmospheric pressure change, and the like. Specific examples of a prompt text to be read by the generative AI include "User ID U001 has a medical history of high blood pressure and is taking an antihypertensive drug. Today's utterance is 'my chest hurts a little today'. Refer to a past care history and medical information, and generate a necessary care action and a report text to the family member", "User ID U002 recently uttered 'anxiety'. Refer to a past emotion change history and a care record, and generate a contact to a psychological care staff member and an example of a reassuring greeting", "Analyze bedsore image data, and generate a progression degree determination and a response proposal", and "Analyze an action history and an environmental factor when a fall sensor is activated, and generate a fall cause analysis and a recurrence prevention measure". Specifically, the generative AI processing unit inputs the received integrated data packet to a multimodal analysis pipeline. The system inputs text data to a bidirectional encoder representation model, and outputs a 768-dimensional text feature vector considering a context. The system inputs an image tensor to a pre-trained residual neural network, and outputs a 2048-dimensional image feature vector. The system inputs a time-series array of vital data to a one-dimensional convolutional neural network, and outputs a time-series feature vector capturing a temporal variation pattern. The system inputs these feature vectors to a concatenation layer, and generates a single integrated context vector. The system inputs the integrated context vector to an autoencoder model for abnormality detection. The autoencoder model compresses the input vector into a low-dimensional space, and then reconstructs it to the original dimension. The system calculates a reconstruction error between the input vector and the reconstructed vector. When the reconstruction error exceeds a predetermined threshold, the system determines that an unknown abnormal sign exists. The system inputs the text feature vector to a fully connected layer for emotion classification, applies a softmax function, and outputs a probability distribution of an emotion class such as "pain", "anxiety", and "joy". The system extracts the emotion class with the highest probability as a label. The system inputs the extracted emotion label, the abnormality determination result, and the past history data retrieved from the database to a prompt generation module. The prompt generation module converts these data into a structured prompt character string in a JSON format. The system inputs the prompt character string to a large language model on a scale of billions of parameters. The large language model calculates a dependency relationship of an input token sequence using a self-attention mechanism, and autoregressively generates an instruction text of an optimal care action. These processes by the generative AI processing unit bring about a technical effect of integrating heterogeneous data in a high-dimensional space and determining a situation with accuracy and speed exceeding human cognitive ability. The system is extremely useful in a use case such as early detection of a complex symptom and advanced decision-making support for an inexperienced staff member. Unlike conventional simple threshold determination or rule-based conditional branching, the system extracts a correlation between complex data using non-linear transformation of a deep learning model. The system realizes advanced data-driven inference as an internal process of a computer.

Step 4: Automatic generation and terminal presentation of optimal care action, report, and instruction. Based on an analysis result, the generative AI processing unit automatically generates an optimal care action (for example, a contact to a medical staff member, a vital check, a rest instruction, a contact to a psychological care staff member, a consultation with a dietitian, an automatic report to a family member, an example of a greeting to a staff member, a bedsore care procedure, a fall recurrence prevention measure, an infection control enhancement, a rehabilitation plan review, a night monitoring enhancement, an outing support proposal, a hobby activity recommendation, a family-oriented educational content generation, etc.), and presents it to a staff terminal or a family terminal in real time. For example, "There is a chest pain complaint today. Please contact a medical staff member and perform a vital check" is displayed on the staff terminal, and a report such as "A medical staff member is responding because of a chest pain complaint today" is automatically transmitted to the family terminal. Specifically, the system inputs a text stream output from the large language model to a natural language understanding module. The natural language understanding module extracts an intention of an action, a target person, and an execution deadline from the text. The system converts the extracted information into a structured task object. The system inputs the task object to a task scheduling engine. The task scheduling engine calculates an urgency score and an importance score of each task. The system inserts a task whose urgency score exceeds a threshold into a priority queue. The system extracts the task from the priority queue, and specifies a terminal identifier of a target staff member. The system transmits task data to the specified terminal identifier using a push notification protocol. The system parses the received task data in a front-end application of the staff terminal. The system changes a background color of a UI component on a screen to red and plays an audio file of a warning sound according to the urgency of the task. When generating a report task object for the family member, the system inputs the object to a message format conversion module. The module executes a dictionary lookup process of replacing a technical term with a plain expression. The system transmits the converted text data to the terminal of the family member via an SMS gateway or an e-mail server. The system receives a status code of transmission completion, and updates a transmission history table of a database. These processes by the system bring about a technical effect of distributing the generated inference result to a related party as an immediately executable action. The system is extremely useful in a use case such as quick information sharing in an emergency and prevention of task omission. Unlike a conventional manual contact network or oral instruction, the system autonomously performs routing and prioritization of information. The system shortens a communication delay to a millisecond unit, and dramatically improves certainty of a business process.

Step 5: Response execution and feedback input by staff member and family member. The staff member and the family member perform an actual response with reference to the care action and the report content presented by the AI, and input a response result, additional information, and feedback (for example, "the AI proposal was accurate", "it did not fit the site", "the family report is easy to understand", "I want more detailed information", etc.) from the terminal interface unit. For example, the staff member records "vital check performed" and "reported to doctor", and the family member inputs "satisfied with report content" and "want to know sleep status additionally". Specifically, the system renders a dynamic input form on the terminal interface unit. The system provides a check box component that manages an execution status for the presented care action. The system detects a touch event when a user taps the check box. Triggered by the event, the system generates a status update payload including a task completion time and a user identifier. The system transmits the payload to the server using an asynchronous communication protocol. The system provides a five-level star rating component and a free-description text area component for feedback input. The system inputs text data input by the user to a client-side validation function in real time. The system detects and blocks an invalid character or a script injection attempt. The system serializes the sanitized text data and the evaluation score into a JSON object. The system transmits the JSON object to a feedback accumulation unit on the server side. The system also allows feedback by voice input. The system inputs a voice stream acquired from a microphone of the terminal to a voice recognition model on an edge side to convert it into text. The system transmits the text-converted feedback data to the server. These processes by the system bring about a technical effect of efficiently collecting explicit evaluation data from the user in a structured format. The system is extremely useful in a use case such as a usefulness evaluation of the system and learning data collection for a next-generation model. Unlike a conventional questionnaire survey conducted at a later date, the system realizes a mechanism of acquiring feedback while maintaining a context immediately after task execution as an internal process of a computer. The system ensures freshness and accuracy of data, and enables seamless data supply to a machine learning pipeline.

Step 6: Accumulation of feedback and history data, and AI self-learning and optimization. The feedback accumulation unit accumulates various evaluation indexes such as feedback from the family member and the staff member, a physical condition/emotion change history of the user, a care execution result, an emergency response history, business load data, an adoption rate of the AI proposal, a response speed, a complaint occurrence rate, a re-response rate, a family satisfaction degree, a staff satisfaction degree, an administrator evaluation, and an external audit result, and the generative AI processing unit utilizes these data for self-learning, model optimization, care procedure improvement, educational program optimization, business process improvement, risk management enhancement, and service quality improvement. For example, when the adoption rate of the AI proposal is low, the AI automatically performs a cause analysis, and improves a proposal content, a timing, and an expression method. Specifically, the system loads the collected feedback data and various log data into a fact table of a distributed data warehouse. The system periodically executes an extract, transform, and load processing pipeline. The system extracts a feature vector from raw data, and constructs a dataset for machine learning. The system constructs a supervised learning model using the adoption rate of the AI proposal as an objective variable and the input context vector as an explanatory variable. The system calculates an importance of a feature contributing to a decrease in the adoption rate using a gradient boosting decision tree algorithm. The system statistically analyzes a root cause of the proposal being rejected by specifying a feature with high importance. Based on this analysis result, the system automatically starts a fine-tuning process for the large language model of the generative AI processing unit. The system uses a pair of a prompt and an output of an adopted proposal as positive example data, and uses a pair of a rejected proposal as negative example data. The system applies a reinforcement learning from human feedback method. The system trains a reward model, and updates a parameter of the large language model by a proximal policy optimization algorithm using the reward model. The system evaluates inference accuracy of the updated model using a held-out test dataset. The system automatically replaces a model container in a production environment by a rolling update method only when an evaluation index such as a BLEU score or a ROUGE score exceeds a prior baseline. These processes by the system bring about a technical effect of continuously improving inference performance of the system without human intervention. The system is extremely useful in a use case such as construction of a self-evolving system that dynamically adapts to an environmental change or a change in user preference. Unlike conventional static software, the system completes a data-driven self-optimization loop as an internal process of a computer. The system prevents obsolescence of the system and maximizes value in long-term operation.

Step 7: Execution of external cooperation, security management, and legal compliance. An external cooperation unit multilaterally cooperates with a medical database, an emotion recognition engine, a voice recognition engine, a psychological care support AI, a vital sensor device, a family contact system, a disaster information system, a community comprehensive support center, an administrative service, a nursing care insurance system, an external audit system, and the like, and acquires and utilizes necessary information in real time, and a security management unit multilaterally encrypts confidential data such as user information, a care history, medical information, family information, and staff information, prevents unauthorized access and information leakage, and thoroughly enforces access authority management, audit log recording, privacy protection, and legal compliance. Specifically, the system operates an API gateway in the external cooperation unit. The API gateway proxies all outbound communication and inbound communication to an external system. The system analyzes header information of a communication packet, and verifies validity of an access token based on an OAuth 2.0 protocol. The system routes a request to a back-end microservice only when the token is valid. The system issues a GraphQL query to an external medical database, and selectively acquires only a necessary data field. The system temporarily stores the acquired data in an in-memory cache, and speeds up a subsequent inference process. The system applies transparent data encryption to all database transactions in the security management unit. The system encrypts a data block on a storage at a physical level using an AES-256 algorithm. The system executes life cycle management of an encryption key by a dedicated hardware security module. The system applies a role-based access control module to an access request of a user. The system compares an authority level of the user with a security label of the requested resource, and determines access availability by a bit operation. The system records all system calls, API requests, and database queries as an audit log together with a time stamp and a user identifier. The system archives the audit log in a secure object storage having a Write Once Read Many attribute. The system periodically anchors a hash value of the audit log to a blockchain network, and makes subsequent falsification mathematically impossible. These processes by the system bring about a technical effect of achieving both safe data exchange with an external system and strict protection of internal data. The system is extremely useful in a use case for satisfying a strict compliance requirement such as the HIPAA law in a medical information system. Unlike a conventional retrofitted security measure, the system incorporates a security and audit mechanism into the foundation of an architecture design of the system. The system reduces an information leakage risk to the utmost limit, and ensures reliability of the system.

### SPECIFIC USE CASE

For example, in a nursing care facility, when a user utters "my chest hurts a little today" after a morning vital check, the terminal interface unit transmits vital data such as a body temperature, a blood pressure, and a pulse to the server simultaneously with this utterance content. The user information management unit immediately extracts related data such as a history of high blood pressure or heart disease as a medical history of the user, taking of an antihypertensive drug as a medication content, a past chest pain complaint history, a latest sleep state, a meal intake amount, a stress factor, and an atmospheric pressure change. The staff information management unit extracts a medical care skill, a current business load, a stress level, a latest shift status, and the like of a staff member in charge of the user. The generative AI processing unit integrally analyzes these information, recognizes an emotion as "pain" from the utterance content, and automatically generates a plurality of care actions such as "contact a medical staff member and perform a vital check again", "automatically transmit a status report to the family member", and "propose a rest instruction and observation enhancement to the staff member in charge" by comprehensively referring to the medical history, the vital data, the response history at the time of the past chest pain complaint, and the like. "The user is complaining of chest pain. Please contact a medical staff member and perform a vital check again. Keep the user at rest, and immediately report if there is an abnormality" is displayed on the staff terminal, and a report such as "A medical staff member is responding because of a chest pain complaint today. We will report the progress at any time" is automatically transmitted to the family terminal. Specifically, the system converts an analog voice signal of the user into digital text data using a voice recognition module. The system synchronizes the converted text data with vital data acquired from various sensors. The system structures the vital data as a multidimensional time-series numerical vector. The system issues a database query to the user information management unit. The system extracts the medical history and the medication history of the user as a natural language text. The system acquires a skill level and a current number of tasks of the staff member in charge from the staff information management unit as numerical data. The system integrates these heterogeneous data, and inputs them to the generative AI processing unit. The generative AI processing unit comprises a large language model based on a transformer architecture. The system tokenizes the input data, and converts it into a high-dimensional embedding vector. The system generates, for example, a 512-dimensional input tensor. The system executes normalization of vital data and interpolation of a missing value as preprocessing of the input data. As a specific example of the input data, the system supplies text data "my chest hurts a little today", a numerical vector of a systolic blood pressure of 150 and a heart rate of 90, a medical history flag which is categorical data, and the like to the model. The model calculates a hidden correlation between each input element using a self-attention mechanism. The model generates a probability distribution of emotion classification and structured data of a recommended care action as an output. As a specific example of the output data, the model outputs a pain probability of 0.95 which is an emotion score, a level 4 which is an urgency score, and a generated text character string. The system compares the output urgency score with a preset threshold. When the score exceeds the threshold, the system immediately executes an interrupt process. The system transfers the generated text character string to a display module of the staff terminal. The system simultaneously calls an external communication application programming interface. The system transmits a push notification to the family terminal. By these processes, the system realizes objective and quick triage without waiting for human judgment. As a result, the system exhibits a technical effect of preventing a delay in medical intervention and dramatically improving safety of the user. The system is extremely useful in a medical and welfare field such as a nursing care facility and a hospital.

Further, when the user utters "I cannot sleep at night recently", the user information management unit extracts a past sleep record, a medication history, a daytime activity amount, a caffeine intake status, a night toilet frequency, a noise level, a lighting environment, and a response history at the time of a past insomnia complaint, and the generative AI processing unit automatically generates "recommend a consultation with a doctor", "report a sleep status to the family member", "instruct the staff member to enhance night monitoring and adjust an environment", and the like. "The user is complaining of insomnia. Please enhance night monitoring and adjust a lighting and noise environment" is displayed on the staff terminal, and "It seems that sleep at night is shallow recently. We are planning to consult a doctor" is automatically reported to the family terminal. Specifically, the system inputs an utterance text of the user to a natural language processing engine. The system classifies an intention of the utterance as an insomnia complaint. The system extracts time-series data including a sleep time and an awakening frequency for the past one month from the user information management unit. The system acquires a noise level and illuminance data acquired from an environmental sensor as a time-series array. The system inputs these time-series data to a recurrent neural network or a long short-term memory network. The system extracts a feature vector indicating a temporal dependency relationship from the time-series data. The system concatenates the extracted feature vector and an embedding vector of the utterance text. The system inputs the concatenated vector to a multilayer perceptron of the generative AI processing unit. The system executes moving averaging of time-series data and removal of an outlier as preprocessing of the input data. As a specific example of the input data, the system supplies numerical values such as an average sleep time of 4 hours for the past 7 days, a night awakening frequency of 3 times, and an average indoor illuminance of 50 lux to the model. The model repeatedly applies non-linear transformation to the input vector. The model generates a classification label for estimating a main cause of insomnia and a text token sequence indicating a countermeasure as an output. As a specific example of the output data, the model outputs an environmental factor probability of 0.8, an environment adjustment instruction which is a recommended action code, and a generated report text. The system parses the output recommended action code. Based on a parsing result, the system transmits a control signal instructing dimming of lighting and adjustment of air conditioning to an environment control module in the facility. The system renders the generated report text on a user interface of the staff terminal and the family terminal. By these processes, the system automatically executes data-driven preventive care, not limited to mere recording of an event. As a result, the system exhibits a technical effect of significantly reducing a cognitive load required for grasping a situation of the staff member and equalizing quality of care. The system is applicable to a field such as an elderly nursing care facility and a home nursing care support service.

Furthermore, in a scene of bedsore care, when the staff member transmits a photograph of a bedsore site from the terminal, the generative AI processing unit automatically determines a progression degree of the bedsore using an image analysis AI, and automatically generates "recommend a report to a doctor", "instruct a dressing exchange", "report a progress to the family member", and the like. "The progression degree of the bedsore is on an upward trend. Please report to a doctor and perform a dressing exchange" is displayed on the staff terminal, and "A doctor is checking the progress of the bedsore site" is automatically reported to the family terminal. Specifically, the system receives two-dimensional color image data acquired from a camera module of the terminal. The system converts the image data into a three-dimensional tensor format. The system adopts a convolutional neural network as the image analysis AI. The system executes a resizing process and normalization of a pixel value on an input image. The system applies rotation and inversion of an image as a data augmentation method, and improves generalization performance of the model. As a specific example of the input data, the system supplies a red-green-blue image tensor of 3 channels with a resolution of 256 by 256 pixels to the model. The model extracts a local and global spatial feature from the image through a plurality of convolutional layers and pooling layers. The model classifies severity of the bedsore using the extracted feature. The model generates a probability distribution corresponding to each progression degree stage and a segmentation mask indicating a lesion site as an output. As a specific example of the output data, the model outputs a probability of stage 3 of 0.85, an area ratio of necrotic tissue of 20%, and boundary coordinate data of the lesion. The system selects a maximum value of the output probability distribution, and determines a current progression degree. The system compares the determined progression degree with a past determination result. When determining that the progression degree is deteriorating, the system dynamically constructs and inputs a prompt urging an emergency response to a text generation model. The system push-distributes an instruction text output from the text generation model to the staff terminal. By these processes, the system eliminates subjective evaluation by human visual inspection. As a result, the system realizes objective and highly accurate medical condition evaluation based on a pixel-by-pixel calculation in a high-dimensional space, and exhibits a technical effect of not missing a timing of an appropriate treatment. The system is extremely effective in a use case such as telemedicine and visiting nursing.

Further, when a fall sensor is activated, the generative AI processing unit analyzes a latest action history and an environmental factor, and immediately executes "fall cause analysis", "recurrence prevention measure proposal", "automatic report to family member, doctor, and administrator", and the like. "A fall has occurred. Please perform a site check and a state observation of the user, and consider a recurrence prevention measure" is displayed on the staff terminal, and "A fall occurred today, but there is no major injury. We are considering a future recurrence prevention measure" is automatically reported to the family terminal. Specifically, the system receives a high-frequency time-series signal from a three-axis acceleration sensor or a gyro sensor installed in the facility. The system detects a rapid change in the sensor signal, and generates a hardware interrupt. The system cuts out sensor data in a certain period immediately before occurrence of the interrupt as a multidimensional time-series tensor. The system simultaneously acquires three-dimensional point cloud data acquired from a depth camera and a status of a moisture detection sensor on a floor surface as an environmental factor vector. The system integrates these multimodal data, and inputs them to an abnormality detection model of the generative AI processing unit. The system executes filtering of sensor noise and downsampling of point cloud data as preprocessing of the input data. As a specific example of the input data, the system supplies an acceleration vector for 10 seconds sampled at 100 hertz, a truth value of a floor surface wet flag, and latest walking speed data of the user to the model. The model specifies an abnormal pattern of a motion leading up to a fall using a spatiotemporal attention mechanism. The model generates a classification score indicating a root cause of the fall and a structured text describing a recurrence prevention measure as an output. As a specific example of the output data, the model outputs a slip fall probability of 0.9, a floor surface cleaning instruction which is a recommended environment improvement measure, and a draft of an automatically generated incident report. Based on the output classification score, the system executes an application programming interface call to an emergency call system. The system stores the generated report in a database, and immediately distributes it to a terminal of a related party. By these processes, the system automates not only speeding up of a post-response but also planning of a logical recurrence prevention measure based on data. As a result, the system exhibits a technical effect of improving a safety management level of the entire facility and mathematically reducing a future accident risk. The system is applied in an environment such as an elderly facility and a rehabilitation hospital.

Specific examples of a prompt text to be read by the generative AI include "User ID U001 has a medical history of high blood pressure and is taking an antihypertensive drug. Today's utterance is 'My chest hurts a little today'. Refer to a past care history and medical information, and generate a necessary care action and a report text to a family member", "User ID U002 recently uttered 'I cannot sleep at night'. Refer to a past sleep record, a medication history, an amount of activity during the day, and an environmental factor, and generate a consultation with a doctor, a report to a family member, and an environmental adjustment instruction to a staff member", "Analyze bedsore image data, and generate a progress degree determination and a response proposal", and "Analyze an action history and an environmental factor when a fall sensor is activated, and generate a fall cause analysis and a recurrence prevention measure". Specifically, the present system comprises a dynamic prompt generation module. The present system executes a process of embedding structured data extracted from a database into a natural language template. The present system formats the prompt text not as a mere character string but by using specific tagging or a markup language so that a model can accurately interpret a context. The present system inputs the formatted prompt text to a tokenizer. The present system converts the character string into an integer index sequence, and further maps it to an embedding representation on a continuous vector space. The present system executes removal of an unnecessary stop word and adjustment of weighting for an important phrase as preprocessing of input data. The present system supplies a token vector of several thousand dimensions including a system prompt, a user prompt, and context data to the model as a specific example of the input data. The present system generates an attention mask, and improves calculation efficiency by skipping calculation for a padded token. The present model sequentially calculates a probability distribution of a word appearing next based on the input prompt vector. The present model outputs a token sequence of generated text and a log likelihood indicating a generation probability of each token as an output. The present model outputs a bulleted list of care actions, a report text described in a polite style for a family member, and a reliability score of the output as specific examples of output data. The present system reversely converts the output token sequence into a human-readable character string using a decoder. The present system executes a validation process using a regular expression on the output text. When an essential item is missing, the present system runs a feedback loop requesting the model to regenerate. By these processes, the present system suppresses a hallucination peculiar to a large language model. As a result, the present system ensures stability and accuracy of the output, and exerts a technical effect of realizing reliable information generation even in a critical area of medical care and nursing care. The present system is widely utilized in fields such as an automatic response system and a business support assistant.

In this way, the system of the present invention collects and analyzes various data such as an utterance from a user, a vital, an image, and sensor information in real time, and the generative AI automatically generates an optimal care action, report, and instruction, and immediately presents and transmits them to a staff terminal and a family terminal, thereby dramatically improving safety, efficiency, family cooperation, and service quality in a nursing care site. Specifically, the present system adopts a distributed computing architecture for integrally processing multimodal data. The present system inputs heterogeneous data such as text, a numerical value, an image, and a time-series signal to respective dedicated encoder networks. The present system projects a feature vector output from each encoder onto a common latent space. The present system combines the projected vectors and executes an integrated inference. The present system executes an inference process of a deep learning model with a high calculation load on a parallel calculation cluster using an image processing device. The present system executes lightweight preprocessing and threshold determination on an edge device side. The present system saves a communication band of the entire system and minimizes end-to-end latency by cooperative processing of a cloud and an edge. The present system comprises a continuous learning pipeline. The present system accumulates a history of a staff member correcting or approving a proposal of the AI on a terminal as ground truth data. The present system periodically fine-tunes a weight parameter of the model using the accumulated data. The present system updates the parameter in a direction of minimizing a loss function using a backpropagation method. By these processes, the present system enables highly accurate inference adapted to an operation rule peculiar to a facility and an individual characteristic of a user as an operation period becomes longer. As a result, the present system completely replaces a conventional business process depending on human experience and intuition with data-driven and self-evolving computer processing. The present system achieves both efficient use of calculation resources and improvement of processing speed, and exerts a technical effect of improving performance of computer technology itself. The present system functions as a core information infrastructure in a smart hospital and a next-generation nursing care facility.

The specific processing unit 290 sends the results of specific processing obtained in Example 1 or Application Example 1 described above to the smart device 14. In the smart device 14, the control unit 46A causes the output device 40 to output the results of specific processing. The microphone 38B acquires voice indicating user input in response to the results of specific processing. The control unit 46A sends the voice data indicating user input acquired by the microphone 38B to the data processing device 12. In the data processing device 12, the specific processing unit 290 acquires the voice data.

The data generation model 58 is a so-called generative AI (Artificial Intelligence).

An example of the data generation model 58 is a generative AI such as ChatGPT (registered trademark) (Internet search <URL: https://openai.com/blog/chatgpt>).

The data generation model 58 is obtained by performing deep learning on a neural network. The data generation model 58 receives prompts containing instructions and inference data such as voice data indicating voice, text data indicating text, and image data indicating images (e.g., still image data or video data). The data generation model 58 performs inference according to the instructions indicated by the prompt on the input inference data and outputs the inference results in one or more data formats such as voice data, text data, or image data. The data generation model 58 includes, for example, text generation AI, image generation AI, and multimodal generation AI. Here, inference refers to, for example, analysis, classification, prediction, and/or summarization. The specific processing unit 290 performs the specific processing described above using the data generation model 58. The data generation model 58 may be a fine-tuned model that outputs inference results from prompts without instructions, and in this case, the data generation model 58 can output inference results from prompts without instructions. The data processing device 12 and the like may include multiple types of data generation models 58, and the data generation model 58 may include AI other than generative AI. AI other than generative AI may include, for example, linear regression, logistic regression, decision trees, random forests, support vector machines (SVM), k-means clustering, convolutional neural networks (CNN), recurrent neural networks (RNN), generative adversarial networks (GAN), or naive Bayes, among others, and can perform various processing but are not limited to such examples. Additionally, AI may be an AI agent. Furthermore, when processing is performed by AI in each part described above, the processing may be performed partially or entirely by AI but is not limited to such examples. Additionally, processing implemented by AI including generative AI may be replaced with rule-based processing, and rule-based processing may be replaced with processing implemented by AI including generative AI.

Moreover, the processing by the data processing system 10 described above is executed by the specific processing unit 290 of the data processing device 12 or the control unit 46A of the smart device 14, but it may be executed by both the specific processing unit 290 of the data processing device 12 and the control unit 46A of the smart device 14. Additionally, the specific processing unit 290 of the data processing device 12 acquires or collects necessary information for processing from the smart device 14 or external devices, and the smart device 14 acquires or collects necessary information for processing from the data processing device 12 or external devices.

In the above embodiments, an example form where specific processing is performed by the data processing device 12 was described, but the technology disclosed herein is not limited to this, and specific processing may be performed by the smart device 14.

### SECOND EMBODIMENT

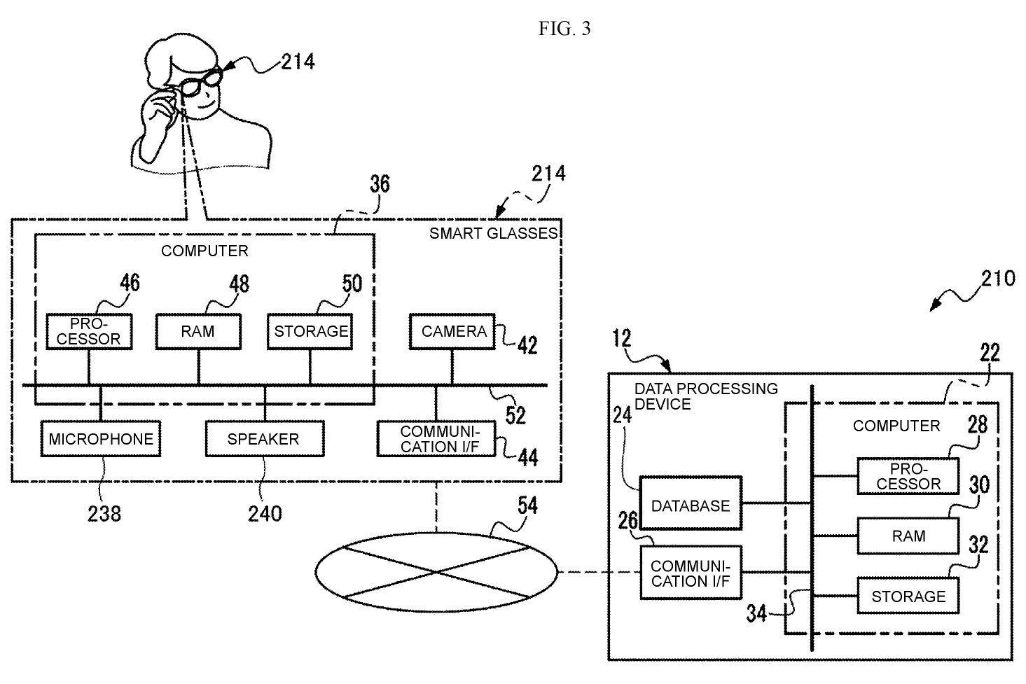

FIG. 3 shows an example configuration of a data processing system 210 according to the second embodiment.

As shown in FIG. 3, the data processing system 210 comprises a data processing device 12 and smart glasses 214. An example of the data processing device 12 is a server.

The data processing device 12 comprises a computer 22, a database 24, and a communication I/F 26. The computer 22 is an example of a "computer" related to the technology disclosed herein. The computer 22 comprises a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN (Wide Area Network) and/or a LAN (Local Area Network), among others.

The smart glasses 214 comprise a computer 36, a microphone 238, a speaker 240, a camera 42, and a communication I/F 44. The computer 36 comprises a processor 46, RAM 48, and storage 50. The processor 46, RAM 48, and storage 50 are connected to a bus 52. The microphone 238, speaker 240, camera 42, and communication I/F 44 are also connected to the bus 52.

The microphone 238 accepts voice uttered by the user 20, accepting instructions, among others, from the user 20. The microphone 238 captures the voice emitted by the user 20, converts the captured voice into voice data, and outputs it to the processor 46. The speaker 240 outputs sound according to instructions from the processor 46.

The camera 42 is a small digital camera equipped with optical systems such as lenses, apertures, and shutters, as well as imaging elements such as CMOS (Complementary Metal-Oxide-Semiconductor) image sensors or CCD (Charge Coupled Device) image sensors, and captures the surroundings of the user 20 (e.g., an imaging range defined by an angle of view equivalent to the typical field of view of a healthy person).

The communication I/F 44 is connected to the network 54. The communication I/F 44 and 26 manage the exchange of various information between the processor 46 and the processor 28 via the network 54. The exchange of various information between the processor 46 and the processor 28 using the communication I/F 44 and 26 is conducted securely.

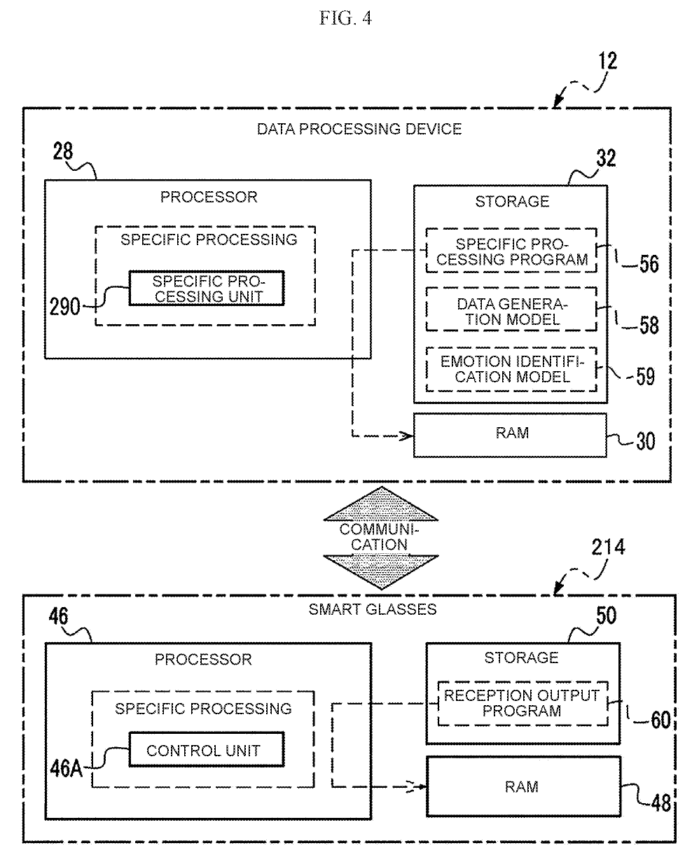

FIG. 4 shows an example of the main functions of the data processing device 12 and smart glasses 214. As shown in FIG. 4, specific processing is performed in the data processing device 12 by the processor 28. The storage 32 stores a specific processing program 56.

The specific processing program 56 is an example of a "program" related to the technology disclosed herein. The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290. The specific processing unit 290 can estimate the user's emotions using the emotion identification model 59 and perform specific processing using the user's emotions. The emotion estimation function (emotion identification function) using the emotion identification model 59 includes estimating and predicting the user's emotions, and various estimations and predictions related to the user's emotions are performed, but it is not limited to such examples. Furthermore, emotion estimation and prediction may include, for example, emotion analysis.

In the smart glasses 214, reception output processing is performed by the processor 46. The storage 50 stores a reception output program 60. The processor 46 reads the reception output program 60 from the storage 50 and executes it on the RAM 48. The reception output processing is realized by the processor 46 operating as a control unit 46A according to the reception output program 60 executed on the RAM 48. The smart glasses 214 may also have similar data generation models and emotion identification models as the data generation model 58 and emotion identification model 59, and perform the same processing as the specific processing unit 290 using these models.

Next, specific processing by the specific processing unit 290 of the data processing device 12 will be described. Each part of the system described below is realized by the data processing device 12 and the smart glasses 214. In the following description, the data processing device 12 is referred to as a "server," and the smart glasses 214 are referred to as a "terminal."

### Example 1

Since the flow of the specific processing is the same as that in Example 1 described in the first embodiment, the description thereof is omitted.

(Application Example 1) Since the flow of the specific processing is the same as that in Application Example 1 described in the first embodiment, the description thereof is omitted.

The specific processing unit 290 sends the results of specific processing obtained in Example 1 or Application Example 1 described above to the smart glasses 214. In the smart glasses 214, the control unit 46A causes the speaker 240 to output the results of specific processing. The microphone 238 acquires voice indicating user input in response to the results of specific processing. The control unit 46A sends the voice data indicating user input acquired by the microphone 238 to the data processing device 12. In the data processing device 12, the specific processing unit 290 acquires the voice data.

Moreover, the processing by the data processing system 10 described above is executed by the specific processing unit 290 of the data processing device 12 or the control unit 46A of the smart glasses 214, but it may be executed by both the specific processing unit 290 of the data processing device 12 and the control unit 46A of the smart glasses 214. Additionally, the specific processing unit 290 of the data processing device 12 acquires or collects necessary information for processing from the smart glasses 214 or external devices, and the smart glasses 214 acquires or collects necessary information for processing from the data processing device 12 or external devices.

In the above embodiments, an example form where specific processing is performed by the data processing device 12 was described, but the technology disclosed herein is not limited to this, and specific processing may be performed by the smart glasses 214.

### THIRD EMBODIMENT

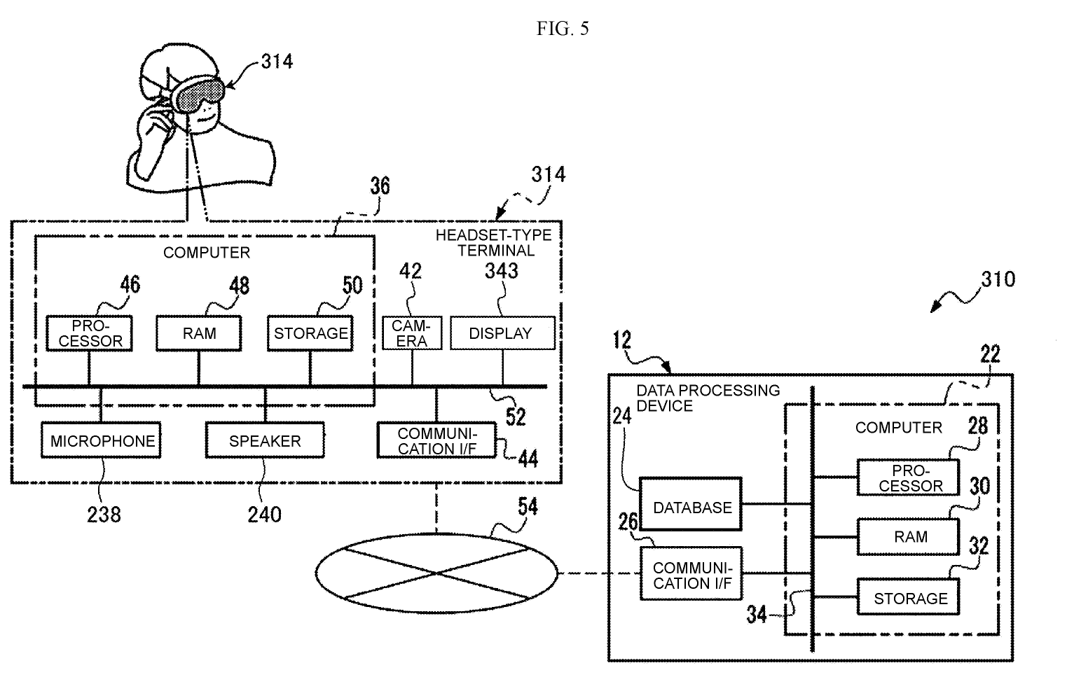

FIG. 5 shows an example configuration of a data processing system 310 according to the third embodiment.

As shown in FIG. 5, the data processing system 310 comprises a data processing device 12 and a headset-type terminal 314. An example of the data processing device 12 is a server.

The data processing device 12 comprises a computer 22, a database 24, and a communication I/F 26. The computer 22 is an example of a "computer" related to the technology disclosed herein. The computer 22 comprises a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN (Wide Area Network) and/or a LAN (Local Area Network), among others.

The headset-type terminal 314 comprises a computer 36, a microphone 238, a speaker 240, a camera 42, a communication I/F 44, and a display 343. The computer 36 comprises a processor 46, RAM 48, and storage 50. The processor 46, RAM 48, and storage 50 are connected to a bus 52. The microphone 238, speaker 240, camera 42, display 343, and communication I/F 44 are also connected to the bus 52.

The microphone 238 accepts voice uttered by the user 20, accepting instructions, among others, from the user 20. The microphone 238 captures the voice emitted by the user 20, converts the captured voice into voice data, and outputs it to the processor 46. The speaker 240 outputs sound according to instructions from the processor 46.

The camera 42 is a small digital camera equipped with optical systems such as lenses, apertures, and shutters, as well as imaging elements such as CMOS (Complementary Metal-Oxide-Semiconductor) image sensors or CCD (Charge Coupled Device) image sensors, and captures the surroundings of the user 20 (e.g., an imaging range defined by an angle of view equivalent to the typical field of view of a healthy person).

The communication I/F 44 is connected to the network 54. The communication I/F 44 and 26 manage the exchange of various information between the processor 46 and the processor 28 via the network 54. The exchange of various information between the processor 46 and the processor 28 using the communication I/F 44 and 26 is conducted securely.

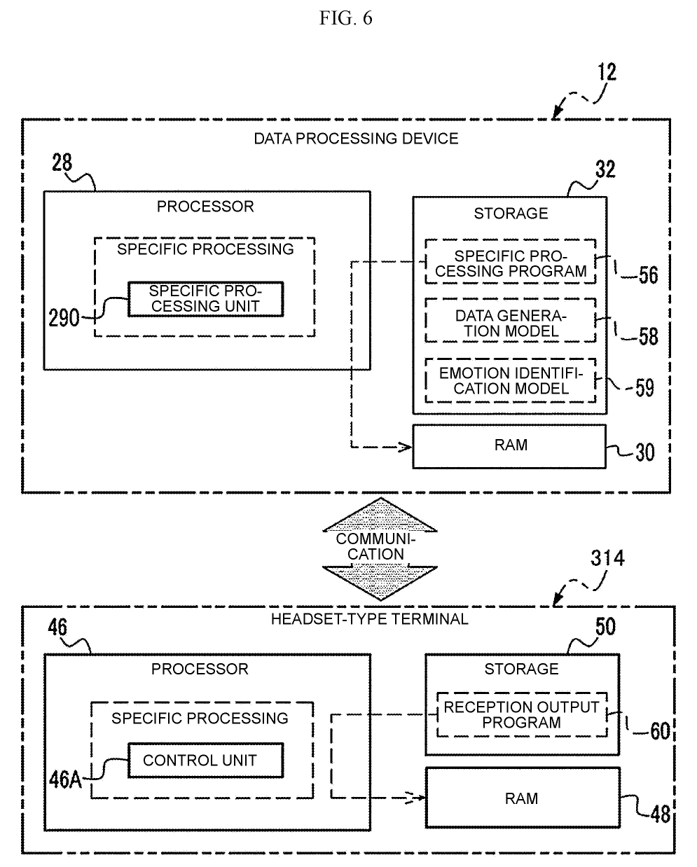

FIG. 6 shows an example of the main functions of the data processing device 12 and the headset-type terminal 314. As shown in FIG. 6, specific processing is performed in the data processing device 12 by the processor 28. The storage 32 stores a specific processing program 56.

The specific processing program 56 is an example of a "program" related to the technology disclosed herein. The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290.

In the headset-type terminal 314, reception output processing is performed by the processor 46.

The storage 50 stores a reception output program 60. The processor 46 reads the reception output program 60 from the storage 50 and executes it on the RAM 48. The reception output processing is realized by the processor 46 operating as a control unit 46A according to the reception output program 60 executed on the RAM 48.

Next, specific processing by the specific processing unit 290 of the data processing device 12 will be described. Each part of the system described below is realized by the data processing device 12 and the headset-type terminal 314. In the following description, the data processing device 12 is referred to as a "server," and the headset-type terminal 314 is referred to as a "terminal."

(Example 1) Since the flow of the specific processing is the same as that in Example 1 described in the first embodiment, the description thereof is omitted.

(Application Example 1) Since the flow of the specific processing is the same as that in Application Example 1 described in the first embodiment, the description thereof is omitted.

The specific processing unit 290 sends the results of specific processing obtained in Example 1 or Application Example 1 described above to the headset-type terminal 314. In the headset-type terminal 314, the control unit 46A causes the speaker 240 and the display 343 to output the results of specific processing. The microphone 238 acquires voice indicating user input in response to the results of specific processing. The control unit 46A sends the voice data indicating user input acquired by the microphone 238 to the data processing device 12. In the data processing device 12, the specific processing unit 290 acquires the voice data.

Moreover, the processing by the data processing system 10 described above is executed by the specific processing unit 290 of the data processing device 12 or the control unit 46A of the headset-type terminal 314, but it may be executed by both the specific processing unit 290 of the data processing device 12 and the control unit 46A of the headset-type terminal 314. Additionally, the specific processing unit 290 of the data processing device 12 acquires or collects necessary information for processing from the headset-type terminal 314 or external devices, and the headset-type terminal 314 acquires or collects necessary information for processing from the data processing device 12 or external devices.

In the above embodiments, an example form where specific processing is performed by the data processing device 12 was described, but the technology disclosed herein is not limited to this, and specific processing may be performed by the headset-type terminal 314.

### FOURTH EMBODIMENT

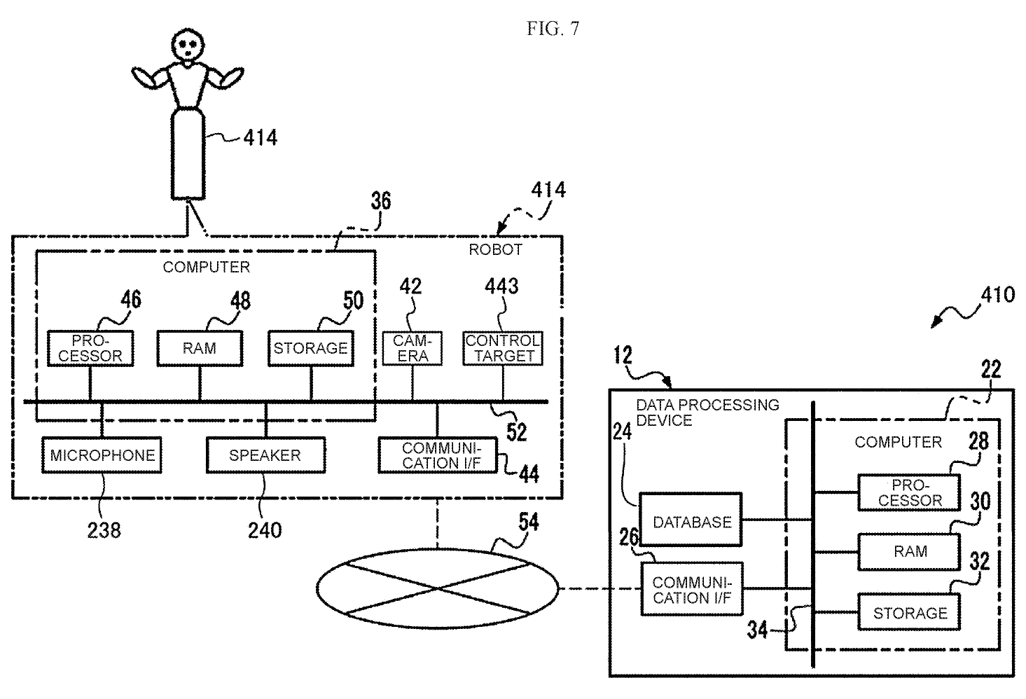

FIG. 7 shows an example configuration of a data processing system 410 according to the fourth embodiment.

As shown in FIG. 7, the data processing system 410 comprises a data processing device 12 and a robot 414. An example of the data processing device 12 is a server.

The data processing device 12 comprises a computer 22, a database 24, and a communication I/F 26. The computer 22 is an example of a "computer" related to the technology disclosed herein. The computer 22 comprises a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN (Wide Area Network) and/or a LAN (Local Area Network), among others.

The robot 414 comprises a computer 36, a microphone 238, a speaker 240, a camera 42, a communication I/F 44, and a control target 443. The computer 36 comprises a processor 46, RAM 48, and storage 50. The processor 46, RAM 48, and storage 50 are connected to a bus 52. The microphone 238, speaker 240, camera 42, control target 443, and communication I/F 44 are also connected to the bus 52.

The microphone 238 accepts voice uttered by the user 20, accepting instructions, among others, from the user 20. The microphone 238 captures the voice emitted by the user 20, converts the captured voice into voice data, and outputs it to the processor 46. The speaker 240 outputs sound according to instructions from the processor 46.

The camera 42 is a small digital camera equipped with optical systems such as lenses, apertures, and shutters, as well as imaging elements such as CMOS (Complementary Metal-Oxide-Semiconductor) image sensors or CCD (Charge Coupled Device) image sensors, and captures the surroundings of the user 20 (e.g., an imaging range defined by an angle of view equivalent to the typical field of view of a healthy person).

The communication I/F 44 is connected to the network 54. The communication I/F 44 and 26 manage the exchange of various information between the processor 46 and the processor 28 via the network 54. The exchange of various information between the processor 46 and the processor 28 using the communication I/F 44 and 26 is conducted securely.

The control target 443 includes a display device, LEDs for the eyes, and motors for driving arms, hands, and feet, among others. The posture and gestures of the robot 414 are controlled by controlling the motors for the arms, hands, and feet, among others. Some emotions of the robot 414 can be expressed by controlling these motors. Additionally, the expression of the robot 414 can be expressed by controlling the lighting state of the LEDs for the eyes of the robot 414.

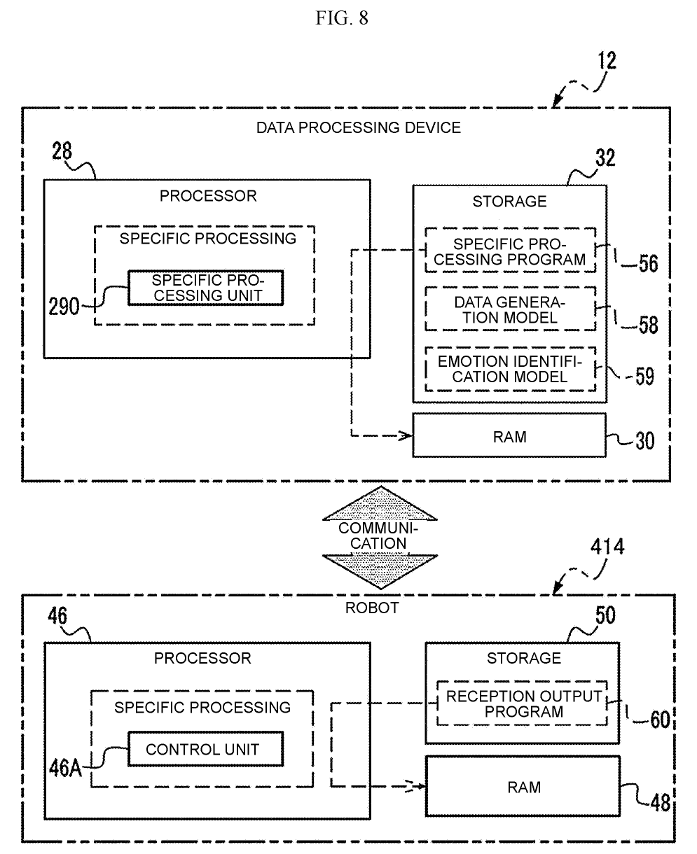

FIG. 8 shows an example of the main functions of the data processing device 12 and the robot 414. As shown in FIG. 8, specific processing is performed in the data processing device 12 by the processor 28. The storage 32 stores a specific processing program 56.

The specific processing program 56 is an example of a "program" related to the technology disclosed herein. The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290.

In the robot 414, reception output processing is performed by the processor 46. The storage 50 stores a reception output program 60. The processor 46 reads the reception output program 60 from the storage 50 and executes it on the RAM 48. The reception output processing is realized by the processor 46 operating as a control unit 46A according to the reception output program 60 executed on the RAM 48.

Next, specific processing by the specific processing unit 290 of the data processing device 12 will be described. Each part of the system described below is realized by the data processing device 12 and the robot 414. In the following description, the data processing device 12 is referred to as a "server," and the robot 414 is referred to as a "terminal."

(Example 1) Since the flow of the specific processing is the same as that in Example 1 described in the first embodiment, the description thereof is omitted.

(Application Example 1) Since the flow of the specific processing is the same as that in Application Example 1 described in the first embodiment, the description thereof is omitted.

The specific processing unit 290 sends the results of specific processing obtained in Example 1 or Application Example 1 described above to the robot 414. In the robot 414, the control unit 46A causes the speaker 240 and the control target 443 to output the results of specific processing. The microphone 238 acquires voice indicating user input in response to the results of specific processing. The control unit 46A sends the voice data indicating user input acquired by the microphone 238 to the data processing device 12. In the data processing device 12, the specific processing unit 290 acquires the voice data.

Moreover, the processing by the data processing system 10 described above is executed by the specific processing unit 290 of the data processing device 12 or the control unit 46A of the robot 414, but it may be executed by both the specific processing unit 290 of the data processing device 12 and the control unit 46A of the robot 414. Additionally, the specific processing unit 290 of the data processing device 12 acquires or collects necessary information for processing from the robot 414 or external devices, and the robot 414 acquires or collects necessary information for processing from the data processing device 12 or external devices.

In the above embodiments, an example form where specific processing is performed by the data processing device 12 was described, but the technology disclosed herein is not limited to this, and specific processing may be performed by the robot 414.

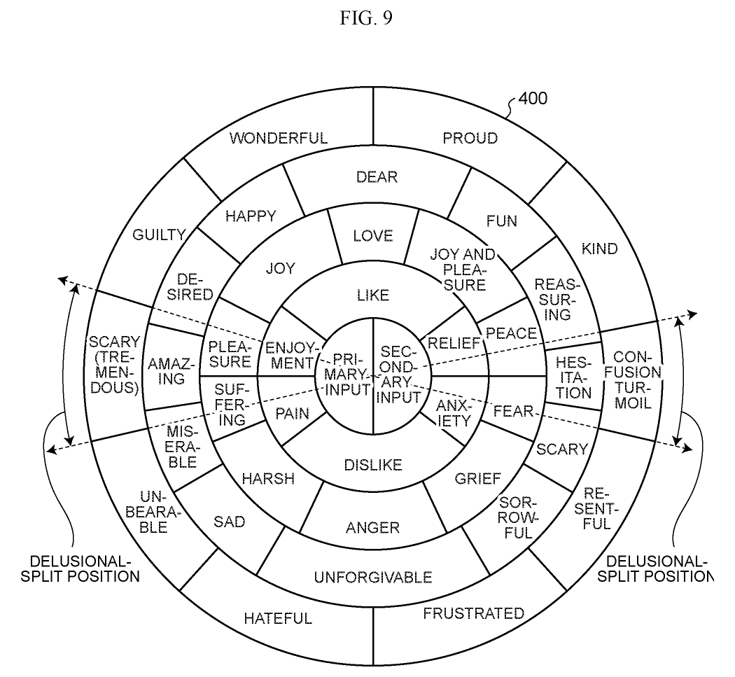

Note that the emotion identification model 59 as an emotion engine may determine the user's emotions according to a specific mapping. Specifically, the emotion identification model 59 may determine the user's emotions according to an emotion map, which is a specific mapping (see FIG. 9). Similarly, the emotion identification model 59 may determine the robot's emotions, and the specific processing unit 290 may perform specific processing using the robot's emotions.

FIG. 9 is a diagram showing an emotion map 400 where multiple emotions are mapped. In the emotion map 400, emotions are arranged concentrically radiating from the center. The closer to the center of the concentric circles, the more primitive the state of emotions is arranged. On the outer side of the concentric circles, emotions representing states and behaviors arising from mood are arranged. Emotions encompass concepts including emotional and mental states. On the left side of the concentric circles, emotions generally generated from reactions occurring in the brain are arranged. On the right side of the concentric circles, emotions generally induced by situational judgment are arranged. On the top and bottom of the concentric circles, emotions generated from reactions occurring in the brain and induced by situational judgment are arranged. Additionally, on the upper side of the concentric circles, "pleasant" emotions are arranged, and on the lower side, "unpleasant" emotions are arranged. In this way, in the emotion map 400, multiple emotions are mapped based on the structure from which emotions arise, and emotions that tend to occur simultaneously are mapped nearby.

These emotions are distributed in the 3 o'clock direction of the emotion map 400, and they usually move back and forth around reassurance and anxiety. In the right half of the emotion map 400, situational recognition takes precedence over internal sensations, giving a calm impression.

The inner side of the emotion map 400 represents the mind, and the outer side represents behavior, so the further out on the emotion map 400, the more visible (expressed in behavior) emotions become.

Here, human emotions are based on various balances like posture and blood sugar levels, and when these balances move away from the ideal, they indicate discomfort, and when they approach the ideal, they indicate comfort. In robots, cars, motorcycles, etc., emotions can be created based on various balances like posture and battery level, indicating discomfort when these balances move away from the ideal and comfort when they approach the ideal. The emotion map may be generated based on Dr. Mitsuyoshi's emotion map (Research on speech emotion recognition and brain physiological signal analysis systems related to emotions, Tokushima University, Doctoral dissertation: https://ci.nii.ac.jp/naid/500000375379). In the left half of the emotion map, emotions belonging to the domain called "reactions," where sensations take precedence, are aligned. Additionally, in the right half of the emotion map, emotions belonging to the domain called "situations," where situational recognition takes precedence, are aligned.

In the emotion map, two emotions that promote learning are defined. One is a negative emotion around "repentance" or "reflection" on the situation side. In other words, when a negative emotion arises in the robot, like "I never want to feel this way again" or "I don't want to be scolded again." The other is an emotion around "desire" on the reaction side, which is positive. In other words, it is a positive feeling like "I want more" or "I want to know more."

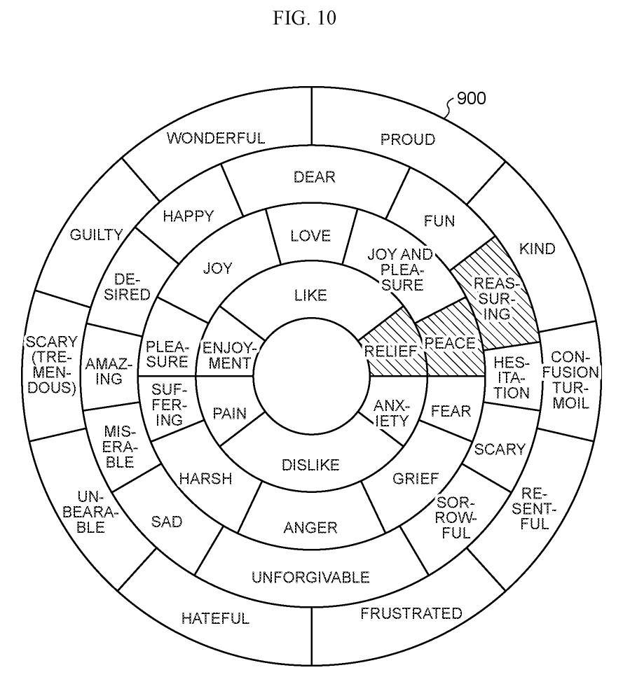

The emotion identification model 59 inputs user input into a pre-learned neural network, acquires emotion values indicating each emotion shown in the emotion map 400, and determines the user's emotions. This neural network is pre-learned based on multiple training data consisting of user input and combinations of emotion values indicating each emotion shown in the emotion map 400. Additionally, this neural network is learned so that emotions placed near each other in the emotion map 900 shown in FIG. 10 have similar values. FIG. 10 shows an example where multiple emotions like "reassured," "calm," and "confident" have similar emotion values.

In the above, the system according to the present disclosure has been described mainly on the functions of the data processing device 12, but the system according to the present disclosure is not necessarily mounted on a server. The system according to the present disclosure may be implemented as a general information processing system. The present disclosure may be implemented, for example, as a software program running on a personal computer, or an application running on a smartphone or the like. The method according to the present disclosure may be provided to the user in the form of SaaS (Software as a Service).

In the above embodiments, an example form where specific processing is performed by a single computer 22 was described, but the technology disclosed herein is not limited to this, and distributed processing for specific processing by multiple computers including the computer 22 may be performed. For example, the data generation model 58 may be provided in an external device of the data processing device 12, and the external device may generate data corresponding to the input data.

In the above embodiments, an example form where the specific processing program 56 is stored in the storage 32 was described, but the technology disclosed herein is not limited to this. For example, the specific processing program 56 may be stored in portable non-transitory storage media readable by a computer, such as a USB (Universal Serial Bus) memory. The specific processing program 56 stored in non-transitory storage media is installed in the computer 22 of the data processing device 12. The processor 28 executes specific processing according to the specific processing program 56.

Additionally, the specific processing program 56 may be stored in a storage device, such as a server connected to the data processing device 12 via the network 54, and downloaded and installed on the computer 22 in response to requests from the data processing device 12.

Furthermore, it is not necessary to store all of the specific processing program 56 in storage devices such as servers connected to the data processing device 12 via the network 54 or all in the storage 32, and a part of the specific processing program 56 may be stored.

Various processors, as shown next, can be used as hardware resources for executing specific processing. As processors, general-purpose processors that function as hardware resources for executing specific processing by executing software, i.e., programs, such as a CPU, can be mentioned. Additionally, as processors, dedicated electrical circuits with circuit configurations specially designed to execute specific processing, such as FPGA (Field-Programmable Gate Array), PLD (Programmable Logic Device), or ASIC (Application Specific Integrated Circuit), can be mentioned.

Each processor has a built-in or connected memory, and each processor executes specific processing using the memory.

Hardware resources for executing specific processing may be composed of one of these various processors or a combination of two or more processors of the same or different types (e.g., a combination of multiple FPGAs or a combination of a CPU and FPGA). Additionally, hardware resources for executing specific processing may be a single processor.

As an example of composing with a single processor, firstly, there is a form where one or more CPUs and software are combined to constitute a single processor, which functions as hardware resources for executing specific processing. Secondly, there is a form using a processor, such as SoC (System-on-a-chip), that realizes the function of an entire system including multiple hardware resources for executing specific processing with a single IC chip. In this way, specific processing is realized using one or more of the various processors as hardware resources.

Furthermore, as a hardware structure of these various processors, more specifically, electrical circuits combined with circuit elements such as semiconductor elements can be used. Additionally, the specific processing described above is merely one example. Therefore, it goes without saying that unnecessary steps may be deleted, new steps may be added, or the order of processing may be changed within the scope not departing from the gist.

The descriptions and drawings shown above are detailed explanations of parts related to the technology disclosed herein and are merely examples of the technology disclosed herein. For example, the explanations regarding configurations, functions, actions, and effects above are explanations regarding examples of configurations, functions, actions, and effects of parts related to the technology disclosed herein. Therefore, it goes without saying that within the scope not departing from the gist of the technology disclosed herein, unnecessary parts may be deleted, new elements may be added, or replacements may be made to the descriptions and drawings shown above. Additionally, to avoid complexity and facilitate understanding of parts related to the technology disclosed herein, explanations concerning technical common knowledge and the like that do not require special explanation for enabling the implementation of the technology disclosed herein are omitted in the descriptions and drawings shown above.

All documents, patent applications, and technical standards described in this specification are incorporated by reference to the same extent as if each document, patent application, and technical standard were specifically and individually stated to be incorporated by reference in this specification.

Note that the following supplementary notes are further disclosed regarding the above description.

### Supplementary Note 1

A nursing care support system using generative AI, comprising: a user information management unit; a staff information management unit; and a generative AI processing unit, wherein the user information management unit is configured to store and manage a care history, medical information, a lifestyle habit, a preference, an emotion/physical condition change history, a family contact history, and the like for each user on a long-term basis, and to collect and extract various information such as an utterance from the user, a diary record, vital data, and a request from a family member in real time; the staff information management unit is configured to centrally manage information such as a skill set, an assignment history, a stress level, shift information, qualification information, a past evaluation, a business load, and an education history for each nursing care staff member, and to perform dynamic business assignment and load adjustment according to an operation status, an aptitude, and a stress state of the staff member; and the generative AI processing unit is configured to analyze an utterance and a record content from the user in a natural language using the generative AI, recognize a change in emotion and physical condition with high accuracy, automatically generate an optimal care action, an emergency response, an automatic report to the family member, a specific instruction and a psychological care proposal to the staff member, and the like in real time while integrally referring to various information such as the medical information and the care history of the user, the skill and the stress level of the staff member, and the request from the family member, further continuously execute self-learning using feedback from the family member and the staff member acquired after a response, autonomously optimize model accuracy and a response content, and simultaneously realize individually optimized care for each user, a quick response in an emergency, staff load reduction, and family cooperation enhancement.

### Supplementary Note 2

The nursing care support system using generative AI according to Supplementary Note 1, wherein when analyzing an utterance from the user, a diary record, vital data, a request from a family member, and the like, the generative AI processing unit is configured to cooperate with an external emotion recognition engine, a medical database, a psychological care support AI, a voice recognition engine, and the like, determine a change in emotion and physical condition of the user with high accuracy, generate a plurality of response policies such as a contact to a medical staff member, a recommendation of a vital check, a contact to a psychological care staff member, an automatic report to the family member, and a proposal of a specific greeting example and a care procedure to the staff member in real time based on a determination result, further generate an individually optimized response in line with a context by referring to a past care history and medical information of the user and the request from the family member, and present a specific response instruction and report to a staff terminal and a family terminal.

### Supplementary Note 3

The nursing care support system using generative AI according to Supplementary Note 1, wherein the generative AI processing unit is configured to accumulate feedback from the family member and the staff member acquired after the response, a physical condition/emotion change history of the user, a care execution result, an emergency response history, business load data, and the like, continuously and self-learningly optimize a parameter and a response generation algorithm of a generative AI model using these feedback data, a new care request, and an environmental change, autonomously generate a response policy for a new pattern using clustering or a pattern recognition technology when detecting a new nursing care pattern or a change in a medical situation, and automatically execute readjustment or relearning of the model parameter by a self-correction function when a problem occurs.

What is claimed is:

1. A system comprising:
circuitry configured to:
receive, via a communication interface coupled to a packet-switched network, inquiry data from a terminal device comprising natural language inquiry text and optional attribute data, and store the inquiry data in a storage device;
apply a natural language processing model to the inquiry text to generate a query embedding vector, a topic classification label, and an urgency indicator, and retrieve candidate response records from a knowledge base vector database by computing cosine similarity scores between the query embedding vector and stored knowledge base record embedding vectors;
apply a generative neural network model to the inquiry text and the retrieved candidate response records to generate a response text record, and compute a response confidence score indicating the reliability of the generated response text record;
apply a dynamic assignment model to the inquiry data, the topic classification label, and a skill set parameter record and workload parameter record associated with each available operator identifier to generate an assignment data record specifying an optimal operator identifier for inquiries having response confidence scores below an escalation threshold; and
transmit the response text record to the terminal device via the communication interface, or route the inquiry data and assignment data record to a designated operator terminal device when the response confidence score is below the escalation threshold.

2. The system according to claim 1, wherein the circuitry is configured to
receive audio waveform data from the terminal device via the communication interface, apply a speech recognition model to convert the audio waveform data to inquiry text, apply an emotion analysis model to the inquiry text and the audio waveform data to generate an emotion state indicator, and incorporate the emotion state indicator as an additional urgency signal in the inquiry data.

3. The system according to claim 2, wherein the circuitry is configured to
apply the dynamic assignment model to incorporate the emotion state indicator as a weighting factor in the assignment score computation, increase the urgency weighting for inquiries with high negative emotion state indicator values, and prioritize assignment to operator identifiers having the highest skill set compatibility scores for the inquiry topic classification label.

4. The system according to claim 1, wherein the circuitry is configured to
apply a multi-stage retrieval process to the knowledge base vector database by first selecting candidate records using approximate nearest neighbor indexing, then reranking selected candidates using a cross-encoder relevance model that jointly encodes the inquiry text and each candidate knowledge base record to compute a refined relevance score.

5. The system according to claim 1, wherein the circuitry is configured to
apply an automated response pipeline to inquiries having response confidence scores exceeding the escalation threshold by formatting the response text record for the delivery channel identifier associated with the terminal device, and transmitting the formatted response to the terminal device without operator involvement.

6. The system according to claim 5, wherein the circuitry is configured to
generate a response summary data record by applying the generative neural network model to the inquiry text and the response text record, store the response summary data record as a session log entry in the storage device, and update the knowledge base with new knowledge base record entries derived from validated high-confidence response text records.

7. The system according to claim 1, wherein the circuitry is configured to
apply a longitudinal pattern analysis model to accumulated session log entries in the storage device to identify inquiry topic frequency trends and emerging inquiry pattern clusters, generate a trend analysis report from the identified clusters, and transmit the trend analysis report to terminal devices associated with management user identifiers.

8. The system according to claim 7, wherein the circuitry is configured to
automatically generate new knowledge base record candidates from high-frequency inquiry pattern clusters by applying the generative neural network model to representative inquiry text and validated response text from the pattern cluster, and transmit the new knowledge base record candidates to a terminal device associated with an administrative user identifier for review prior to indexing.

9. The system according to claim 1, wherein the circuitry is configured to
process tens of thousands of simultaneous inquiry connections using an asynchronous IO multiplexing event loop, distribute inquiry processing tasks to a plurality of processing nodes via a load balancer, and maintain per-connection session state using a shared memory data structure.

10. The system according to claim 1, wherein the circuitry is configured to
monitor operator workload parameter records in real time by tracking active assignment counts per operator identifier, apply the dynamic assignment model to redistribute pending assignments when an operator identifier's workload parameter exceeds a maximum workload threshold, and update assignment data records accordingly.

11. The system according to claim 1, wherein the circuitry is configured to
receive feedback data from the terminal device following response transmission comprising satisfaction rating values, apply the feedback data to update response quality scores associated with the corresponding knowledge base records, and use the updated quality scores as weighting factors in the cosine similarity score computation.

12. The system according to claim 1, wherein the circuitry is configured to
retrieve longitudinal subject profile data associated with the terminal device user identifier from the storage device, incorporate the longitudinal subject profile data as additional context in the generative neural network model prompt, and personalize the response text record based on the longitudinal subject profile data.

13. The system according to claim 1, wherein the circuitry is configured to
apply a stress level monitoring model to operator performance metric records accumulated over a configurable time window, generate a workload rebalancing recommendation when an operator identifier's stress level indicator exceeds a stress threshold, and transmit the recommendation to a terminal device associated with a workforce management user identifier.

14. The system according to claim 1, wherein the circuitry is configured to
update the knowledge base vector database by applying the natural language processing model to generate embedding vectors for new knowledge base record candidates, indexing the new embedding vectors using approximate nearest neighbor indexing, and retiring outdated knowledge base records falling below a minimum freshness threshold.

15. The system according to claim 1, wherein the circuitry is configured to
encrypt all inquiry data transmissions using a transport layer security protocol, apply a token-based authentication check for all incoming inquiry requests, and enforce a data privacy policy restricting access to session log entries to authorized user identifiers.

16. The system according to claim 1, wherein the circuitry is configured to
generate a performance analytics data record from session log entries comprising average response latency metrics, automated resolution rate metrics, and escalation rate metrics by topic classification label, and transmit the performance analytics data record to terminal devices associated with management user identifiers at configurable periodic intervals.

17. The system according to claim 1, wherein the inquiry data comprises natural language inquiry text submitted by a user, the knowledge base vector database stores reference records derived from historical inquiry resolution data, and the assignment data record specifies an operator identifier selected based on skill set compatibility and workload capacity.

18. A system comprising:
circuitry configured to:
receive, via a communication interface coupled to a packet-switched network, inquiry data from a terminal device, apply a natural language processing model to generate a query embedding vector and topic classification label, and retrieve candidate response records by cosine similarity from a knowledge base vector database;
apply a generative neural network model to generate a response text record and compute a response confidence score;
apply a dynamic assignment model incorporating skill set and workload parameters to generate assignment data records for low-confidence inquiries, and process simultaneous connections using asynchronous IO multiplexing; and
transmit response text records or route inquiry data to operator terminal devices based on confidence score thresholds.

19. The system according to claim 18, wherein the circuitry is configured to
apply a longitudinal pattern analysis model to session log entries to identify inquiry topic frequency trends, automatically generate knowledge base record candidates from high-frequency clusters, and monitor operator stress level indicators to generate workload rebalancing recommendations.

20. A method comprising:
receiving, via a communication interface coupled to a packet-switched network, inquiry data from a terminal device, and storing the inquiry data in a storage device;
applying a natural language processing model to generate a query embedding vector and topic classification label, and retrieving candidate response records by cosine similarity from a knowledge base vector database;
applying a generative neural network model to generate a response text record and compute a response confidence score;
applying a dynamic assignment model to generate an assignment data record for inquiries below an escalation threshold; and
transmitting the response text record or routing the inquiry data to an operator terminal device based on the response confidence score.
